(19) United States
(12) Patent Application Publication
(10) Pub. No.: US 2026/0122628 A1
(43) Pub. Date: Apr. 30, 2026

(54) MULTI-LAYER SIGNALING FOR AMBIENT POWER (AMP) DEVICES

(71) Applicant: QUALCOMM Incorporated, San Diego, CA (US)

(72) Inventors: Manideep DUNNA, San Jose, CA (US); Stephen Jay SHELLHAMMER, Ramona, CA (US); Bin TIAN, San Diego, CA (US); Jialing Li CHEN, San Diego, CA (US); Sameer VERMANI, San Diego, CA (US); Pooria PAKROOH, San Marcos, CA (US); Sanket Sanjay KALAMKAR, San Diego, CA (US); George CHERIAN, San Diego, CA (US); Alfred ASTERJADHI, San Diego, CA (US)

(21) Appl. No.: 19/316,933

(22) Filed: Sep. 2, 2025

Related U.S. Application Data
(63) Continuation-in-part of application No. 19/275,235, filed on Jul. 21, 2025.
(60) Provisional application No. 63/713,568, filed on Oct. 29, 2024.
(60) Provisional application No. 63/727,952, filed on Dec. 4, 2024.

(51) Int. Cl. H04W 72/044; H04W 72/20

(52) U.S. Cl. CPC H04W 72/0473; H04W 72/20

(57) ABSTRACT

This disclosure provides methods, components, devices and systems for multi-layer signaling for ambient power (AMP) devices. Some aspects enable early differentiation between non-backscatter AMP device types through signaling in AMP downlink physical layer protocol data units (PPDUs). For example, a wireless device receives a first portion of an AMP downlink PPDU indicating an intended STA type (such as an active transmitter or an AMP-enabled device) and selectively receives subsequent portions of the AMP downlink PPDU in accordance with whether the type of the wireless device matches the indicated type. In scenarios in which the types match, the wireless device continues receiving the PPDU. Otherwise, the wireless device ceases reception to conserve energy and processing resources. The first portion may include one or more fields that indicate the intended STA type, may indicate a medium access control (MAC) frame type that implicitly indicates the intended STA type, or both.

### CROSS REFERENCES

The present application for patent is a continuation-in-part of U.S. patent application Ser. No. 19/275,235 by DUNNA et al., entitled “MULTI-LAYER SIGNALING FOR AMBIENT POWER (AMP) DEVICES,” filed Jul. 21, 2025, which claims priority to and the benefit of U.S. Provisional Patent Application No. 63/713,568 by DUNNA et al., entitled “PHYSICAL PROTOCOL DATA UNIT (PPDU) FOR AMBIENT POWER (AMP) DEVICES,” filed Oct. 29, 2024, and U.S. Provisional Patent Application No. 63/727,952 by DUNNA et al., entitled “MULTI-LAYER SIGNALING FOR AMBIENT POWER (AMP) DEVICES,” filed Dec. 4, 2024, each of which is assigned to the assignee hereof, and each of which is expressly incorporated by reference in its entirety herein.

### TECHNICAL FIELD

This disclosure relates generally to wireless communication and, more specifically, to multi-layer signaling for ambient power (AMP) devices.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications at a wireless device. The method may include receiving a physical layer protocol data unit (PPDU) during a transmission opportunity (TxOP), the PPDU including at least one of at least one spoofing preamble portion, at least one downlink data portion, and at least one uplink data portion, where one or more fields in the at least one spoofing preamble portion, the at least one downlink data portion, or both, define the PPDU as an ambient power (AMP) device PPDU, and where the at least one spoofing preamble portion at least partially mimics a preamble portion of a non-AMP device PPDU and transmitting an uplink signal during the TxOP according to the one or more fields defining the PPDU as the AMP device PPDU.

Another innovative aspect of the subject matter described in this disclosure can be implemented at a wireless device for wireless communications. The wireless device may include a processing system that includes processor circuitry and memory circuitry that stores code. The processing system may be configured to cause the wireless device to receive a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and transmit an uplink signal during the TxOP according to the one or more fields defining the PPDU as the AMP device PPDU.

Another innovative aspect of the subject matter described in this disclosure can be implemented at a wireless device for wireless communications. The wireless device may include means for receiving a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and means for transmitting an uplink signal during the TxOP according to the one or more fields defining the PPDU as the AMP device PPDU.

Another innovative aspect of the subject matter described in this disclosure can be implemented at a non-transitory computer-readable medium storing code for wireless communications. The code may include instructions executable by one or more processors to receive a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and transmit an uplink signal during the TxOP according to the one or more fields defining the PPDU as the AMP device PPDU.

In some examples of the method, wireless devices, and non-transitory computer-readable medium described herein, the one or more fields of the at least one downlink data portion include a synchronization field that may be common to both AMP device PPDUs and non-AMP device PPDUs.

In some examples of the method, wireless devices, and non-transitory computer-readable medium described herein, the one or more fields of the at least one downlink data portion include a signal field that includes a field type indicator and a value of the field type indicator defines the PPDU as the AMP device PPDU.

In some examples of the method, wireless devices, and non-transitory computer-readable medium described herein, the at least one spoofing preamble portion includes one or more signal fields that may be set to values that define the PPDU as the AMP device PPDU.

Another innovative aspect of the subject matter described in this disclosure can be implemented in a method for wireless communications at a wireless device. The method may include transmitting a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and receiving an uplink signal during the TxOP according to the one or more fields defining the PPDU as the AMP device PPDU.

Another innovative aspect of the subject matter described in this disclosure can be implemented at a wireless device for wireless communications. The wireless device may include a processing system that includes processor circuitry and memory circuitry that stores code. The processing system may be configured to cause the wireless device to transmit a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and receive an uplink signal during the TxOP according to the one or more fields defining the PPDU as the AMP device PPDU.

Another innovative aspect of the subject matter described in this disclosure can be implemented at a wireless device for wireless communications. The wireless device may include means for transmitting a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and means for receiving an uplink signal during the TxOP according to the one or more fields defining the PPDU as the AMP device PPDU.

Another innovative aspect of the subject matter described in this disclosure can be implemented at a non-transitory computer-readable medium storing code for wireless communications. The code may include instructions executable by one or more processors to transmit a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU and receive an uplink signal during the TxOP according to the one or more fields defining the PPDU as the AMP device PPDU.

Another innovative aspect of the subject matter described in this disclosure can be implemented in a method for wireless communication at a first wireless device. The method may include transmitting a first excitation signal, transmitting an uplink transmission trigger, where the first excitation signal includes one or more power signals configured to passively power one or more second wireless devices associated with the uplink transmission trigger, monitoring for one or more uplink transmissions from the one or more second wireless devices in accordance with the first excitation signal and the uplink transmission trigger, and receiving the one or more uplink transmissions in accordance with monitoring for the one or more uplink transmissions.

Another innovative aspect of the subject matter described in this disclosure can be implemented at a first wireless device for wireless communications. The first wireless device may include a processing system that includes processor circuitry and memory circuitry that stores code. The processing system may be configured to cause the first wireless device to transmit a first excitation signal, transmit an uplink transmission trigger, where the first excitation signal includes one or more power signals configured to passively power one or more second wireless devices associated with the uplink transmission trigger, monitor for one or more uplink transmissions from the one or more second wireless devices in accordance with the first excitation signal and the uplink transmission trigger, and receive the one or more uplink transmissions in accordance with monitoring for the one or more uplink transmissions.

Another innovative aspect of the subject matter described in this disclosure can be implemented at a first wireless device for wireless communications. The first wireless device may include means for transmitting a first excitation signal, means for transmitting an uplink transmission trigger, where the first excitation signal includes one or more power signals configured to passively power one or more second wireless devices associated with the uplink transmission trigger, means for monitoring for one or more uplink transmissions from the one or more second wireless devices in accordance with the first excitation signal and the uplink transmission trigger, and means for receiving the one or more uplink transmissions in accordance with monitoring for the one or more uplink transmissions.

Another innovative aspect of the subject matter described in this disclosure can be implemented at a non-transitory computer-readable medium storing code for wireless communications. The code may include instructions executable by one or more processors to transmit a first excitation signal, transmit an uplink transmission trigger, where the first excitation signal includes one or more power signals configured to passively power one or more second wireless devices associated with the uplink transmission trigger, monitor for one or more uplink transmissions from the one or more second wireless devices in accordance with the first excitation signal and the uplink transmission trigger, and receive the one or more uplink transmissions in accordance with monitoring for the one or more uplink transmissions.

Some examples of the method, first wireless devices, and non-transitory computer-readable medium described herein may further include operations, features, means, or instructions for transmitting one or more PPDUs, the one or more PPDUs including a second excitation signal and a response portion, where the response portion may be associated with a receipt of the one or more uplink transmissions.

In some examples of the method, first wireless devices, and non-transitory computer-readable medium described herein, receiving the one or more uplink transmissions may include operations, features, means, or instructions for receiving two or more uplink transmissions in accordance with the uplink transmission trigger, where information in a first respective uplink transmission of the two or more uplink transmissions may be associated with information in a second respective uplink transmission of the two or more uplink transmissions.

Another innovative aspect of the subject matter described in this disclosure can be implemented in a method for wireless communication at a second wireless device. The method may include receiving a first excitation signal, receiving an uplink transmission trigger, where the first excitation signal includes one or more power signals configured to passively power the second wireless device associated with the uplink transmission trigger and performing one or more uplink transmissions in accordance with the first excitation signal and the uplink transmission trigger.

Another innovative aspect of the subject matter described in this disclosure can be implemented at a second wireless device for wireless communications. The second wireless device may include a processing system that includes processor circuitry and memory circuitry that stores code. The processing system may be configured to cause the second wireless device to receive a first excitation signal, receive an uplink transmission trigger, where the first excitation signal includes one or more power signals configured to passively power the second wireless device associated with the uplink transmission trigger and perform one or more uplink transmissions in accordance with the first excitation signal and the uplink transmission trigger.

Another innovative aspect of the subject matter described in this disclosure can be implemented at a second wireless device for wireless communications. The second wireless device may include means for receiving a first excitation signal, means for receiving an uplink transmission trigger, where the first excitation signal includes one or more power signals configured to passively power the second wireless device associated with the uplink transmission trigger and means for performing one or more uplink transmissions in accordance with the first excitation signal and the uplink transmission trigger.

Another innovative aspect of the subject matter described in this disclosure can be implemented at a non-transitory computer-readable medium storing code for wireless communications. The code may include instructions executable by one or more processors to receive a first excitation signal, receive an uplink transmission trigger, where the first excitation signal includes one or more power signals configured to passively power the second wireless device associated with the uplink transmission trigger and perform one or more uplink transmissions in accordance with the first excitation signal and the uplink transmission trigger.

In some examples of the method, second wireless devices, and non-transitory computer-readable medium described herein, receiving the first excitation signal and the uplink transmission trigger may include operations, features, means, or instructions for receiving a first set of one or more PPDUs that includes the uplink transmission trigger from a first wireless device and receiving a second set of one or more PPDUs that includes the first excitation signal from a third wireless device.

Another innovative aspect of the subject matter described in this disclosure can be implemented in a method for wireless communication at a station (STA). The method may include receiving a first portion of an AMP downlink PPDU that includes one or more excitation signals, the first portion indicating a type of STA to which the AMP downlink PPDU is intended, the type of STA being one of a first type of STA that is capable of receiving AMP downlink PPDUs and transmitting AMP uplink PPDUs or a second type of STA that is capable of receiving AMP downlink PPDUs and transmitting non-AMP uplink PPDUs. The method may include selectively receiving at least a second portion of the AMP downlink PPDU based on whether the STA is the type of STA to which the AMP downlink PPDU is intended.

Another innovative aspect of the subject matter described in this disclosure can be implemented in a STA for wireless communication. The STA may include a processing system that includes processor circuitry and memory circuitry that stores code. The processing system may be configured to cause the STA to receive a first portion of an AMP downlink PPDU that includes one or more excitation signals, the first portion indicating a type of STA to which the AMP downlink PPDU is intended, the type of STA being one of a first type of STA that is capable of receiving AMP downlink PPDUs and transmitting AMP uplink PPDUs or a second type of STA that is capable of receiving AMP downlink PPDUs and transmitting non-AMP uplink PPDUs. The processing system may be configured to cause the STA to selectively receive at least a second portion of the AMP downlink PPDU based on whether the STA is the type of STA to which the AMP downlink PPDU is intended.

Another innovative aspect of the subject matter described in this disclosure can be implemented in a STA for wireless communication. The STA may include means for receiving a first portion of an AMP downlink PPDU that includes one or more excitation signals, the first portion indicating a type of STA to which the AMP downlink PPDU is intended, the type of STA being one of a first type of STA that is capable of receiving AMP downlink PPDUs and transmitting AMP uplink PPDUs or a second type of STA that is capable of receiving AMP downlink PPDUs and transmitting non-AMP uplink PPDUs. The STA may include means for selectively receiving at least a second portion of the AMP downlink PPDU based on whether the STA is the type of STA to which the AMP downlink PPDU is intended.

Another innovative aspect of the subject matter described in this disclosure can be implemented in a non-transitory computer-readable medium storing code for wireless communication. The code may include instructions executable by one or more processors to receive a first portion of an AMP downlink PPDU that includes one or more excitation signals, the first portion indicating a type of STA to which the AMP downlink PPDU is intended, the type of STA being one of a first type of STA that is capable of receiving AMP downlink PPDUs and transmitting AMP uplink PPDUs or a second type of STA that is capable of receiving AMP downlink PPDUs and transmitting non-AMP uplink PPDUs. The code may include instructions to selectively receive at least a second portion of the AMP downlink PPDU based on whether the STA is the type of STA to which the AMP downlink PPDU is intended.

In some examples of the method, STAs, and non-transitory computer-readable medium described herein, selectively receiving at least the second portion of the AMP downlink PPDU may include refraining from receiving the second portion of the AMP downlink PPDU when the STA is not the type of STA to which the AMP downlink PPDU is intended or receiving at least the second portion of the AMP downlink PPDU when the STA is the type of STA to which the AMP downlink PPDU is intended.

In some examples of the method, STAs, and non-transitory computer-readable medium described herein, the first portion indicates a frame type of one or more medium access control (MAC) frames included in the AMP downlink PPDU, where the frame type indicates the type of STA to which the AMP downlink PPDU is intended.

In some examples of the method, STAs, and non-transitory computer-readable medium described herein, the first portion includes an AMP synchronization field that indicates the type of STA to which the AMP downlink PPDU is intended. In some examples of the method, STAs, and non-transitory computer-readable medium described herein, the AMP downlink PPDU includes an AMP synchronization field, an AMP signaling field, and an AMP data field, and receiving the first portion may include receiving at least the AMP signaling field, where the AMP signaling field is after the AMP synchronization field and before the AMP data field in the AMP downlink PPDU, and where the AMP signaling field includes information indicating the type of STA to which the AMP downlink PPDU is intended.

In some examples of the method, STAs, and non-transitory computer-readable medium described herein, receiving the first portion may include receiving a MAC frame, the MAC frame including information indicating the type of STA to which the AMP downlink PPDU is intended. In some examples of the method, STAs, and non-transitory computer-readable medium described herein, the MAC frame is an initial MAC frame included in the AMP downlink PPDU.

In some examples of the method, STAs, and non-transitory computer-readable medium described herein, the AMP synchronization field includes a first segment that indicates a data rate associated with the AMP data field and a second segment that indicates the type of STA to which the AMP downlink PPDU is intended. In some examples of the method, STAs, and non-transitory computer-readable medium described herein, the second segment indicates that the AMP downlink PPDU is intended for the first type of STA using a first binary chip sequence or indicates that the AMP downlink PPDU is intended for the second type of STA using a second binary chip sequence.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example physical layer protocol data unit (PPDU) usable for communications between a wireless AP and one or more wireless stations (STAs).

FIG. 3 shows a frequency diagram depicting an example distributed tone mapping.

FIG. 4 shows a pictorial diagram of another example wireless communication network.

FIG. 5 shows an example of a PPDU configuration that supports multi-layer signaling for ambient power (AMP) devices.

FIG. 6 shows an example of a PPDU configuration that supports multi-layer signaling for AMP devices.

FIG. 7 shows an example of a PPDU configuration that supports multi-layer signaling for AMP devices.

FIG. 8 shows an example of a decision threshold configuration that supports multi-layer signaling for AMP devices.

FIG. 9A-9C show examples of a downlink signal (SIG) field configuration that supports multi-layer signaling for AMP devices.

FIG. 10 shows an example of a PPDU configuration that supports multi-layer signaling for AMP devices.

FIG. 11 shows an example of a spoofing preamble configuration that supports multi-layer signaling for AMP devices.

FIGS. 12A and 12B show examples of PPDU configurations that support multi-layer signaling for AMP devices.

FIGS. 13, 14A and 14B show examples of signaling diagrams that support multi-layer signaling for AMP devices.

FIG. 15 shows a diagram of an example system including a device that supports multi-layer signaling for AMP devices.

FIG. 16 shows a diagram of an example system including a device that supports multi-layer signaling for AMP devices.

FIGS. 17-21 show flowcharts illustrating example processes performable by or at a wireless device that supports multi-layer signaling for AMP devices.

Like reference numbers and designations in the various drawings indicate like elements.

### DETAILED DESCRIPTION

The following description is directed to some particular examples for the purpose of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group, or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support a deployment of ambient power (AMP) devices, which may include devices that power one or more components with ambient radio frequency (RF) energy “harvested” via one or more antennas of the devices. An AMP device may rely exclusively on ambient RF energy or may use ambient RF energy to supplement one or more other energy sources (such as a battery). By way of example, in a Wi-Fi network, an AMP device may be a station (STA) that supports ambient RF energy harvesting. In some Wi-Fi networks, techniques for STAs to be able to determine whether a physical layer protocol data unit (PPDU) is directed to an AMP device or a non-AMP device may be desirable. For example, different types of PPDUs may be transmitted to different types of STAs, such that it may be beneficial for a non-AMP device to identify whether a PPDU is directed to an AMP device (to inform an early packet drop decision, for example). Some legacy devices, however, may be unable to process some advanced 802.11 version signaling protocols and formats, and vice versa in some instances. For example, some advanced 802.11 versions may lack a mechanism for legacy devices to recognize AMP device-directed signaling, which may result in a legacy device being unable to determine whether a PPDU is directed to an AMP device or a non-AMP device. Further, in some deployment scenarios, an access point (AP) may trigger uplink transmissions by an AMP device. For example, an AP may transmit a trigger frame soliciting an AMP device to perform an uplink transmission to the AP. In some situations, however, the AMP device may not have sufficient energy (stored or otherwise harvested from the trigger frame) to successfully perform the solicited uplink transmission. In such situations, the AMP device may be unable to perform the solicited uplink transmission, which may result in a communication failure between the AP and the AMP device.

Various aspects relate generally to signaling techniques that support AMP devices within a Wi-Fi network. Some aspects more specifically relate to signaling techniques that may be used by AMP devices and non-AMP devices to identify or otherwise determine whether a PPDU being communicated from a reader is an AMP device PPDU or a non-AMP device PPDU. A reader (such as a user equipment (UE), a STA, an AP, or a network entity) may be a device that communicates with AMP or non-AMP devices. In some implementations, the reader may be a legacy AP or an AMP AP (an AP specialized in AMP operations, such as a legacy AP co-located with an energizing device). The reader may transmit excitation signals to enable an AMP device to communicate with the reader (along with a trigger or other downlink signaling) and, in some examples, may construct a PPDU to enable devices to determine whether the PPDU is an AMP device PPDU (such as a PPDU directed to one or more AMP devices) or a non-AMP device PPDU (such as a PPDU directed to one or more non-AMP devices). A wireless device that receives the PPDU may determine whether the PPDU is an AMP device PPDU or a non-AMP device PPDU by detecting various fields, parameters, or configurations of the PPDU that indicate whether the PPDU is an AMP device PPDU or a non-AMP device PPDU (such as via physical layer or PHY layer signaling). In some implementations, an AMP device PPDU may include at least one spoofing preamble portion to enable legacy devices to parse at least a portion of the PPDU. For example, the spoofing preamble portion may include one or more fields that mimic one or more fields of a non-AMP device PPDU. An AMP device PPDU may further include at least one downlink data portion or at least one uplink data portion, or both. In some aspects, one or more fields in a spoofing preamble portion or a downlink data portion, or both, may define a PPDU as an AMP device PPDU. An AMP device that receives the PPDU may transmit an uplink signal during a transmission opportunity (TxOP) within which the PPDU is received according to the one or more fields defining the PPDU as the AMP device PPDU.

In some aspects, an AMP device PPDU may include one or more excitation signals used by an AMP device to encode uplink information onto and reflect or refract back to the reader during an uplink data portion of the AMP device PPDU. In such aspects, the AMP device may transmit the uplink signal by reflecting or refracting the one or more excitation signals. For example, the AMP device may backscatter the excitation signal, after encoding uplink data, back to the reader as an uplink transmission during the uplink data portion of the AMP device PPDU. By way of further example, the AMP device may use a relatively small or limited internal power source or storage capability to generate and transmit the uplink signal to the reader during the uplink data portion of the AMP device PPDU. In some implementations, the AMP device may receive one or more additional excitation signals in association with receiving an uplink transmission trigger (such as a trigger frame or another frame, message, or indication that an uplink transmission is triggered or solicited). For example, the AMP device may receive (one or more PPDUs including) an uplink transmission trigger and one or more excitation signals, with the AMP device using energy harvested from the one or more excitation signals to perform one or more uplink transmissions solicited by the uplink transmission trigger (such as via medium access control (MAC) layer signaling). In some implementations, the uplink transmission trigger may include an indication of a medium access mechanism for the AMP device to use, a request for an energy harvesting capability of the AMP device, or a request for an energy harvesting status of the AMP device.

Particular aspects of the subject matter described in this disclosure can be implemented to realize one or more of the following potential advantages. In some implementations, by configuring the field(s) of the spoofing preamble portion, the downlink data portion, or both portions, the described techniques may be used to define a PPDU communicated during a TxOP as an AMP device PPDU or as a non-AMP device PPDU. In such implementations, one or more non-AMP devices may stop receive processing of the PPDU (such as in scenarios in which the PPDU is an AMP device PPDU) to conserve energy. Such a stoppage of receive processing may be associated with or otherwise understood as an early packet drop. Further, by transmitting one or more excitation signals in association with an uplink transmission trigger or other response signaling, an AMP device may harvest and store sufficient power to respond to communications from the reader. In accordance with harvesting and storing sufficient power to respond to communications from the reader, the AMP device may more reliably communicate with the reader (such as via multi-layer signaling including, for example, PHY layer and MAC layer signaling), which may support higher data rates, greater spectral efficiency, and greater system capacity, among other benefits.

In addition to the general challenge of differentiating between AMP device PPDUs and non-AMP device PPDUs, some wireless communication networks may experience additional complexity when communicating with different types of non-backscatter AMP capable devices. For example, non-backscatter devices may include active transmitter devices that harvest energy to generate their own uplink waveforms and may include AMP-enabled devices that use received AMP transmissions to wake up radios for wireless communication. Because these different device types may perform different operations in response to receiving AMP downlink PPDUs, they may use different MAC frame formats and signaling approaches. In some wireless communication systems, wireless devices may process entire MAC frames included in an AMP downlink PPDU to determine whether a transmission is intended for its specific device type, which may unnecessarily use energy and processing resources if the transmission is not intended for the receiving wireless device. Further, although some networks may support signaling mechanisms to differentiate between backscatter AMP capable devices and non-backscatter AMP devices, such networks may lack signaling mechanisms to differentiate between the different types of non-backscatter AMP capable devices, which may result in some non-backscatter AMP capable devices parsing a relatively large portion of a PPDU intended to a different (type of) non-backscatter AMP device. Thus, some networks may benefit from signaling, positioned (such as located or provided) relatively early in a PPDU, that indicates which type of non-backscatter AMP capable device is an intended recipient of the PPDU.

Accordingly, some additional aspects enable relatively early differentiation between different types of non-backscatter AMP capable devices through signaling approaches within AMP downlink PPDUs. For example, a wireless device may receive a first portion of an AMP downlink PPDU that indicates the type of STA to which the AMP downlink PPDU is intended, with the type being a first type of non-AP STA (such as an active transmitter device) or a second type of non-AP STA (such as an AMP-enabled device). The wireless device may selectively receive at least a second portion of the AMP downlink PPDU in accordance with whether the type of the wireless device corresponds to (such as matches or is the same as) the type of STA indicated in the first portion. In scenarios in which the type of the wireless device matches the indicated type, the wireless device may continue receiving (including processing, parsing, or decoding) the AMP downlink PPDU. In scenarios in which the type of the wireless device does not match the indicated type, the wireless device may cease receiving (including terminate, end, or stop) the AMP downlink PPDU, thereby conserving energy and processing resources. The first portion may include one or more fields of the AMP downlink PPDU (such as an AMP synchronization (AMP-Sync) field, an AMP signal (AMP-SIG) field, an AMP-data field, or any combination thereof) that indicate the type of STA to which the AMP downlink PPDU is intended. In some examples, the first portion may indicate a type of MAC frame included in the AMP-data field, which may implicitly indicate the type of STA to which the AMP downlink PPDU is intended.

Particular aspects of the subject matter described in this disclosure can be implemented to realize one or more of the following potential advantages. In some implementations, by configuring signaling within AMP downlink PPDUs to indicate the type of STA to which the transmission is intended, the described techniques may enable wireless devices to perform early differentiation between different types of non-backscatter AMP capable devices before decoding entire MAC frames or complete PPDUs. In such implementations, a wireless device may terminate receive processing early in scenarios in which a PPDU is not intended for their device type, thereby conserving energy and reducing processing overhead. Such early termination may provide relatively large performance gains for AMP devices given their reliance on harvested energy and relatively limited processing capabilities. Further, by providing signaling at one or multiple layers within the PPDU structure, including synchronization fields (such as the AMP-Sync field), signal fields (such as the AMP-SIG field), data field (such as the service field within the data field), or MAC frame portions (such as the MAC header of a first MAC frame, or a first MAC frame in an AMP-data field), networks may offer flexibility in implementation while ensuring reliable early differentiation. In accordance with enabling early differentiation and reducing unnecessary processing, AMP devices may operate more efficiently within wireless networks, which may support more-efficient energy management, reduced communication failures, and enhanced overall network performance, among other benefits.

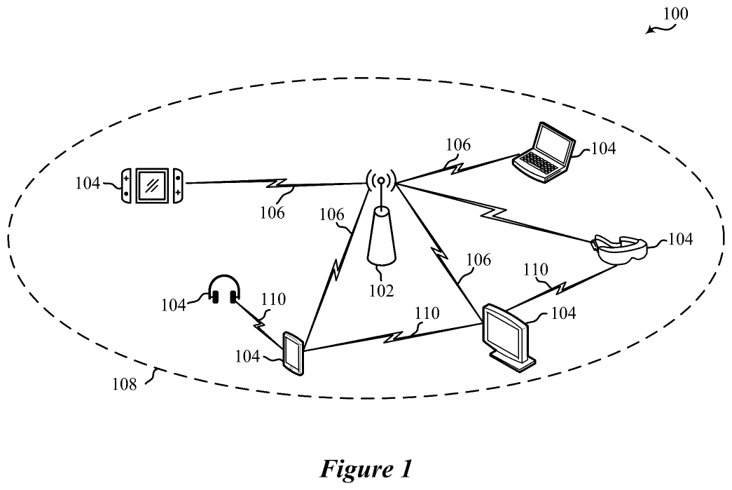

FIG. 1 shows a pictorial diagram of an example wireless communication network 100. According to some aspects, the wireless communication network 100 can be an example of a wireless local area network (WLAN) such as a Wi-Fi network. The wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. The beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. The wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. The AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. The APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ 52.6 GHZ), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. The AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

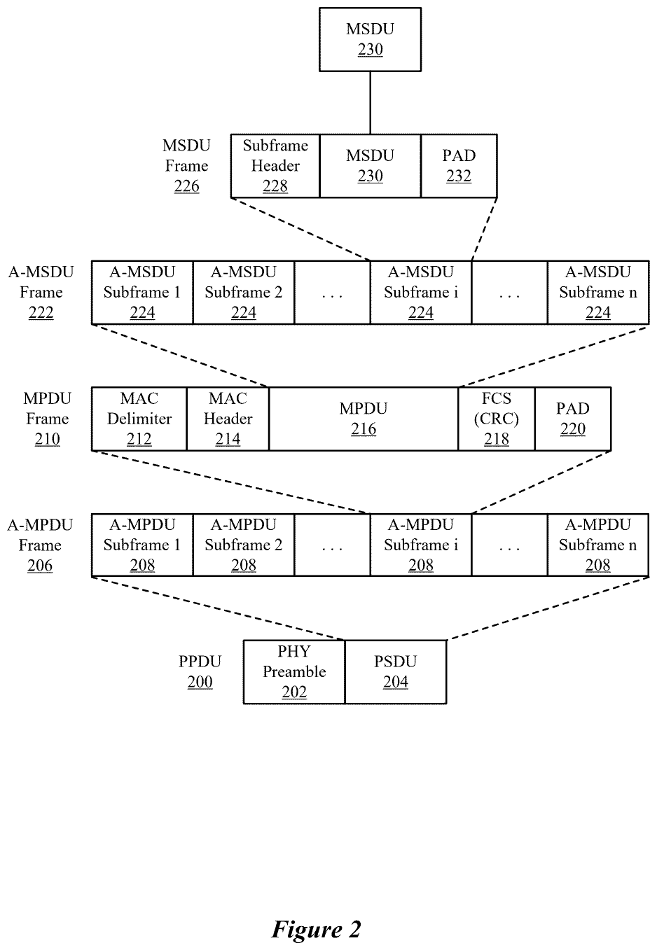

FIG. 2 shows a hierarchical format of an example PPDU usable for communications between a wireless AP and one or more wireless STAs. The AP and STAs may be examples of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 208 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field 218 may include a cyclic redundancy check (CRC)) and padding bits 220. The MPDU 216 may carry one or more MAC service data units (MSDUs) 230. The MPDU 216 may carry an aggregated MSDU (A-MSDU) 222 including multiple A-MSDU subframes 224. Each A-MSDU subframe 224 may be associated with an MSDU frame 226 and may contain a corresponding MSDU 230 preceded by a subframe header 228 and, in some implementations, followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body. The MAC header 214 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body. The MAC header 214 may include a combination of a source address, a transmitter address, a receiver address or a destination address. The MAC header 214 may further include a frame control field containing control information. The frame control field may specify a frame type, for example, a data frame, a control frame, or a management frame.

In some wireless communication systems, wireless communication between an AP 102 and an associated STA 104 can be secured. For example, cither an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by a signal (SIG) field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some implementations in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. To overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

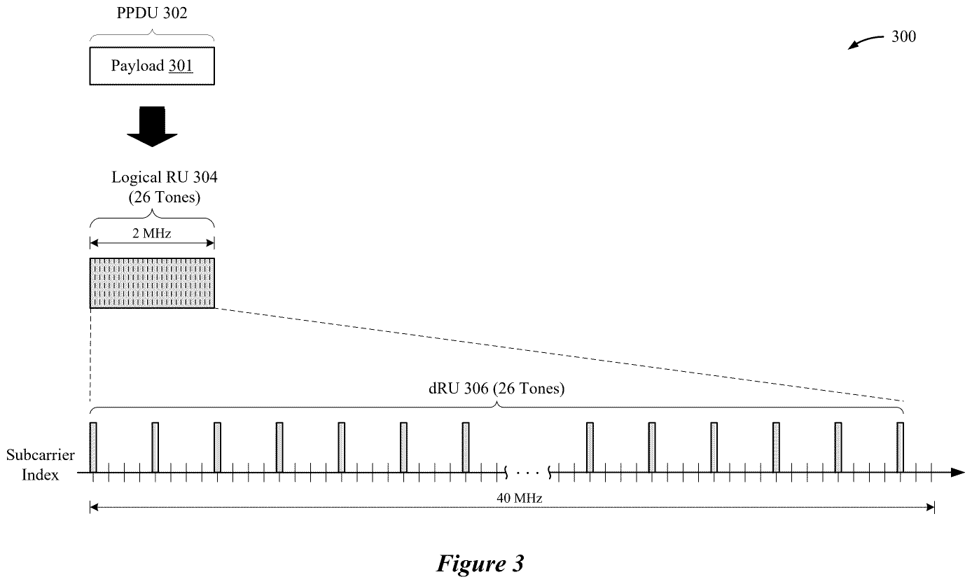

FIG. 3 shows a frequency diagram 300 depicting an example distributed tone mapping. More specifically, FIG. 3 shows an example mapping of how the tones of a payload 301 of a PPDU 302 are distributed for transmission over a spreading bandwidth of a wireless channel. In the illustrated example, the tones in a logical RU 304 (which may represent an rRU of non-distributed tones in accordance with a legacy tone plan) associated with payload 301 are mapped to a distributed RU (dRU) 306 in accordance with a distributed tone plan.

Aspects of the present disclosure recognize that by distributing the tones across a wider bandwidth, the per-tone transmit power of a logical RU 304 may be increased to provide greater flexibility in medium utilization for PSD-limited wireless channels. For example, when mapped to an rRU such as logical RU 304, the transmit power of the logical RU 304 may be severely limited based on the PSD of the wireless channel. The LPI power class limits the transmit power of APs 102 and STAs 104 to 5 dBm/MHz and −1 dBm/MHz, respectively, in the 6 GHz band. As such, the per-tone transmit power of the logical RU 304 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 302, without exceeding the PSD limits of the wireless channel. As shown in the example of FIG. 3, the STA 104 may map logical RU 304 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 3 effectively reduces the number of tones (of the logical RU 304) in each 1 MHz subchannel. For example, each of the 26 tones can be mapped to a different 1 MHz subchannel of the 40 MHz channel. As a result, each AP 102 or STA 104 implementing the distributed tone mapping of FIG. 3 can maximize its per-tone transmit power (which may maximize the overall transmit power of the logical RU 304).

In some implementations (not shown in FIG. 3), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 302 is transmitted on tones spanning an rRU, such as a logical RU 304 (according to a legacy tone plan), or a dRU 306 (according to a distributed tone plan). The IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. The trigger frame may indicate a logical RU or MRU allocated for transmission in the TB PDDU. In some implementations, the trigger frame may be further configured to carry tone distribution information indicating whether the logical RU (or MRU) maps to an rRU or a dRU.

In some implementations, a STA 104 may include a distributed tone mapper that maps the logical RU 304 to the dRU 306 in the frequency domain. The dRU 306 is converted to a time-domain signal (such as by an inverse fast Fourier transform (IFFT)) for transmission over a wireless channel. The AP 102 may receive the time-domain signal and reconstruct the dRU 306 (such as by a fast Fourier transform (FFT)). In some implementations, the AP 102 may include a distributed tone demapper that demaps the dRU 306 to the logical RU 304. In other words, the distributed tone demapper reverses the mapping performed by the distributed tone mapper at the STA 104. The AP 102 can recover the information carried (or modulated) on the logical RU 304 as a result of the demapping.

In the example of FIG. 3, the logical RU 304 is distributed evenly across the spreading bandwidth. While the example shown in FIG. 3 illustrates a spreading bandwidth of 40 MHz, spreading bandwidths also may include 80 MHz, 160 MHz, or 320 MHz. In some implementations, the logical RU 304 can be mapped to any suitable pattern of noncontiguous subcarrier indices. For example, in various implementations, the distance between any pair of adjacent modulated tones may be less than or greater than the distances depicted in FIG. 3.

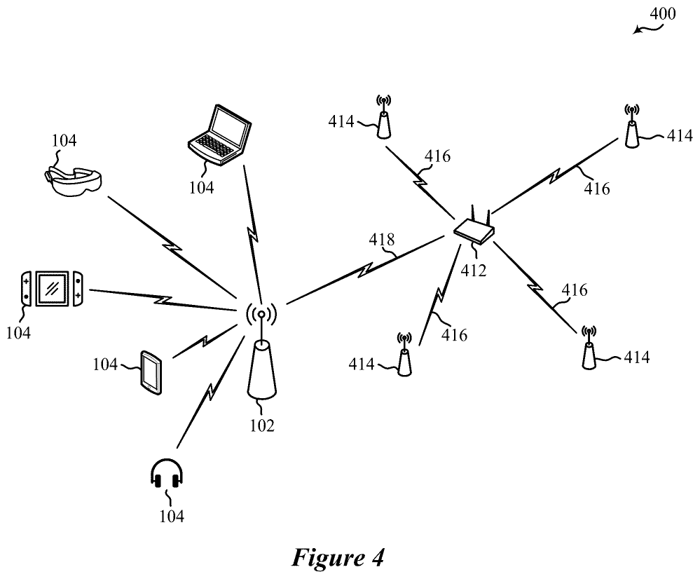

FIG. 4 shows a pictorial diagram of another example wireless communications system 400. According to some aspects, the wireless communications system 400 can be an example of a mesh network, an IoT network, or a sensor network in accordance with one or more of the IEEE 802.11 family of wireless communication protocol standards (including the 802.11ah amendment). The wireless communications system 400 may include multiple wireless communication devices 414, which in some implementations may include APs 102, STAs 104, or both. The wireless communication devices 414 may represent various devices such as display devices (such as TVs, computer monitors, navigation systems, among others), music or other audio or stereo devices, remote control devices (“remotes”), printers, kitchen or other household appliances, among other examples.

In some implementations, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (such as audio or video data), configuration information or other instructions to the wireless communication devices 414. The intermediate device 412 and the wireless communication devices 414 can communicate with one another via wireless communication links 416. In some implementations, the wireless communication links 416 include Bluetooth links or other PAN or short-range communication links.

In some implementations, the intermediate device 412 also may be configured for wireless communication with other networks such as with a WLAN or a wireless (such as cellular) wide area network (WWAN), which may, in turn, provide access to external networks including the Internet. The intermediate device 412 may associate and communicate, over a Wi-Fi link 418, with an AP 102 of a wireless communications system 400, which also may serve various STAs 104. In some implementations, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some implementations, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

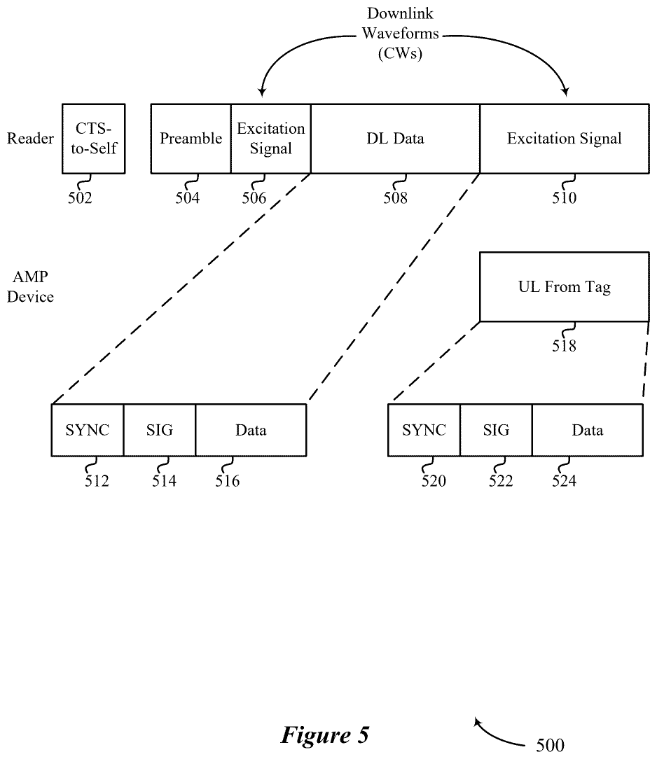

FIG. 5 shows an example of a PPDU configuration 500 that supports PPDU for AMP devices. PPDU configuration 500 may implement aspects of wireless communication network 100, aspects of PPDU 200, aspects of frequency diagram 300, or aspects of wireless communications system 400. Aspects of the PPDU configuration 500 may be implemented at or implemented by one or more wireless devices, which may be an example of the corresponding device(s) described herein. The wireless device may be an example of an AMP device (such as a UE or a STA) or a reader (such as a UE, a STA, an AP, or a network entity) communicating with AMP device(s).

The AMP device(s) may include various wireless device types such as A-IoT devices, radio frequency identification (RFID) devices (such as tags), or other energy-harvesting capable devices. In some implementations, the AMP device(s) may include passive devices, semi-passive devices, or active devices. Wireless communication systems may support such low-cost and low-complexity passive, semi-passive, or active devices, such as the AMP device. These devices may be affixed to individual items (such as boxes, crates, containers, worn on a user, or other scenarios) that are used to collect and send small amounts of data. For example, an AMP device may be attached to a sensor and provide sensor data, may be attached to a piece of inventory and used for tracking and inventory purposes or provide other basic functionality. These devices may, therefore, be generally associated with small-data uplink traffic.

A passive device may generally refer to a device that uses backscatter communications on a backwards link (BL). The backscatter communications may include the device harvesting the energy of a wireless signal (such as an excitation signal, such as a continuous wave (CW) signal) via a forward link (FL) and reflecting or refracting the wireless signal back to the source (such as the reader) after encoding the small amount of uplink data onto the reflected or refracted signal. The passive device also may be referred to as an RFID tag, a passive AMP device, or as a Type A device. The passive device may have little or no energy storage capability. The passive device may have no amplification capability (such as may solely rely on the energy harvested from the FL signal). Accordingly, the operating range of the passive device may be relatively short (such as 10-30 meters).

Semi-passive devices also may rely on backscatter communications for the BL and may have little or no amplification. The semi-passive device may have a small amount of energy storage that captures and stores energy from wireless signal(s). The semi-passive device may use some or all of its stored energy to provide a relatively small amount of amplification to the BL signal. This amplification may extend the operating range of the semi-passive device (such as by up to 60 meters). Semi-passive devices also may have a more complex operational capability relative to the passive devices, which may provide additional functionality. The semi-passive device also may be referred to as a semi-passive RFID tag, a semi-passive AMP device, or as a Type B device.

An active device may rely on backscatter communications for the BL or may have a transmit chain that is capable of generating and transmitting a wireless signal via the BL. The active device may have a medium amount of energy storage capability (such as a small battery) that can be used to power the transmit chain. This energy storage capability may further extend the operational range of the active device (such as up to 300 meters) and may enable a higher degree of complexity relative to the semi-passive devices. The active device also may be referred to as an active RFID tag, an active AMP device, as a Bluetooth device, or as a Type C device, among other such active devices. The AMP device described herein may be an example of any of the passive devices, semi-passive devices, or active devices.

Wireless communications with these devices may include a reader transmitting a signal (such as a CW or other excitation signal) via the FL and the AMP device responding with a signal via the BL (such as a backscattered signal or a generated signal). The reader in this context may refer to a STA or an AP. In some scenarios, the reader may refer to the AP that communicates directly with the AMP device via the FL and the BL. In other scenarios, the reader may refer to the STA that communicates with the AP via a cellular link (such as via a Uu interface) and also communicates with the AMP device via the FL and BL. The AP may control or otherwise manage the communications between the STA and the AMP device. In this scenario, the STA may act as a relay device or an assisting node between the AMP device and the AP.

In some scenarios, the reader may simply refer to the STA that acts as a stand-alone reader. The STA may be a device that controls or otherwise autonomously manages the FL and BL communications with the AMP device. The STA may communicate information associated with the AMP device to a central function (such as a network controller or function) via the AP. The STA may include function(s) or application(s) that manage the FL and BL communications with the AMP device and provides some or all of the tag information (or other information based on the tag information) to the central function. In other scenarios, the communications via the BL and the FL may be simply between the STA and the AMP device without involving the AP or other central function (such as an autonomous reader/tag configuration). In some implementations, the FL and BL communications may use cellular-based wireless signaling techniques (such as Uu interface signaling) or may use Wi-Fi-based wireless signaling techniques (such as 802.11 based signaling). The techniques described herein may support a close range backscattering scenario where an AMP tag may be read by a smartphone (such as a STA) using the Wi-Fi radio on the smartphone.

In the FL and within the context of a cellular communications interface, the reader may transmit or otherwise output a PHY transport block (TB) to the AMP device. In the FL and with the context of a Wi-Fi communications interface (such as using 802.11 standards), the reader may transmit or otherwise output information to the AMP device using a PPDU format (such as one or more PPDUs communicated during a clear-to-send (CTS)-to-self (CTS-to-self) frame). The PHY TB and the PPDU format may take various forms depending on the type of AMP device that the information is being communicated to. Either format may begin with a delimiter (such as an OFF period where no signal is transmitted) having a certain duration that denotes the start of frame (SOF)). The AMP device may detect the delimiter and, therefore, know that the PHY TB or PPDU is being received.

The PPDU configuration 500 illustrates an example where the AMP device PPDU is being communicated to an AMP device that uses backscatter-based communications and, therefore, uses an excitation signal (such as CW signals) to provide operating energy for the AMP device. However, it is to be understood that in some scenarios the AMP device may be a semi-passive or active device that does not rely on the reader for operating energy and, therefore, the AMP device PPDU may not include any excitation signals. Accordingly, the various techniques described herein are not limited to AMP devices using backscatter-based communications but may instead be equally applicable for AMP device that are capable of generating or storing their own operating energy and, therefore, the AMP device PPDU may not include excitation signal(s) in some implementations.

Generally, the AMP device PPDU may begin with the CTS-to-self 502 that signals to other wireless devices that the channel is being reserved for a period of time (such as the CTS-to-self frame). The CTS-to-self 502 may reserve the channel for a frame duration of up to 32 ms in case the reader to AMP device communications take more than one TxOP (which are generally limited to 5 ms). The CTS-to-self 502 may be preferred in a mixed environment with other 802.11 based devices that are incapable of understanding legacy preambles.

The CTS-to-self 502 may be followed by a preamble portion 504, an excitation signal 506, a downlink data portion 508, and an excitation signal 510. In this example, the preamble portion 504, the excitation signal 506, the downlink data portion 508, and the excitation signal 510 may form the AMP device PPDU within the CTS-to-self frame. The preamble portion 504 may include various signals or fields. The preamble portion 504 may include a legacy-long training field (L-LTF) and a legacy-short training field (L-STF) that defers transmissions from other devices once detected. The preamble portion 504 may include a legacy-signal field (L-SIG) that indicates the channel busy time or the packet duration (such as the TxOP duration). In some implementations, a version specific SIG may be used to let the unintended receiving devices know about the AMP transmission.

The excitation signals (such as the excitation signal 506 and the excitation signal 510) may be used for uplink data from the AMP device (such as may be used to energize the AMP device). That is, the excitation signals may be transmitted by the reader for the AMP tag in order to provide energy to the AMP device. The excitation signal 510 may be used by the AMP device to encode uplink information to perform an uplink transmission during the uplink data portion 518. That is, the AMP device may reflect or refract the excitation signal 510 back to the reader after encoding the small amount of uplink information or data onto the excitation signal 510 in order to perform uplink transmission corresponding to the uplink data portion 518. The downlink data portion 508 and the uplink data portion 518 may include the reader sending data to and receiving data from the AMP device that is organized into synchronization (SYNC), SIG, and the MAC payload sections (such as data). The downlink data portion 508 may include a SYNC 512, a SIG 514, and a data portion 516. The uplink data portion 518 may include a SYNC 520, a SIG 522, and a data portion 524.

Some AMP devices may have a start-up time (such as up to 1.5 ms) to energize the AMP device and to wake up all the subsystems (such as the memory and clock generators). For the start-up time duration, the AMP device may need to harvest energy continuously from the excitation signal before performing any data communication to/from the AMP device. For this reason, an excitation signal of 1.5 ms duration containing downlink waveform (direct sequence spread spectrum (DSSS), orthogonal frequence division multiplexing (OFDM) symbols, or other possible physical layer waveforms) are added after the legacy preamble.

In some aspects, the preamble portion 504 may include a spoofing preamble portion. That is, the spoofing preamble portion may mimic (at least to some degree) a preamble portion of the preamble in a non-AMP device PPDU (such as 802.11be and 802.11bn PPDU preamble portions). Accordingly, the AMP device (such as a wireless device) may receive or otherwise obtain (and the reader may transmit or otherwise output) a PPDU during a TxOP that includes at least one spoofing preamble portion (such as the preamble portion 504), at least one downlink data portion (such as the downlink data portion 508), and at least one uplink data portion (such as the uplink data portion 518). In this example, the AMP device PPDU also includes the excitation signal 506 and the excitation signal 510. That is, in this example the AMP device PPDU includes a first excitation signal portion (such as excitation signal 506) between a spoofing preamble portion (such as the preamble portion 504) and a downlink data portion (such as the downlink data portion 508), and a second excitation signal portion (such as the excitation signal 510) after the downlink data portion. In this context, the first excitation signal portion and the second excitation signal portion both include power signals (such as CW) configured to passively power the wireless device.

The second excitation signal may be used by the wireless device to encode uplink information and perform an uplink transmission during the at least one uplink data portion 518. The AMP device may transmit or otherwise output (and the reader may receive or otherwise obtain) an uplink signal during the TxOP according to field(s) that define the PPDU as an AMP device PPDU. That is, various field(s) or other aspects of the preamble portion 504 (such as the at least one spoofing preamble portion), the downlink data portion 508 (such as the at least one downlink data portion), or both portions may be set to values or use other parameters that define the PPDU as an AMP device PPDU rather than a non-AMP device PPDU. Various details and examples of such field(s) or other aspects that define the PPDU as the AMP device PPDU are described herein.

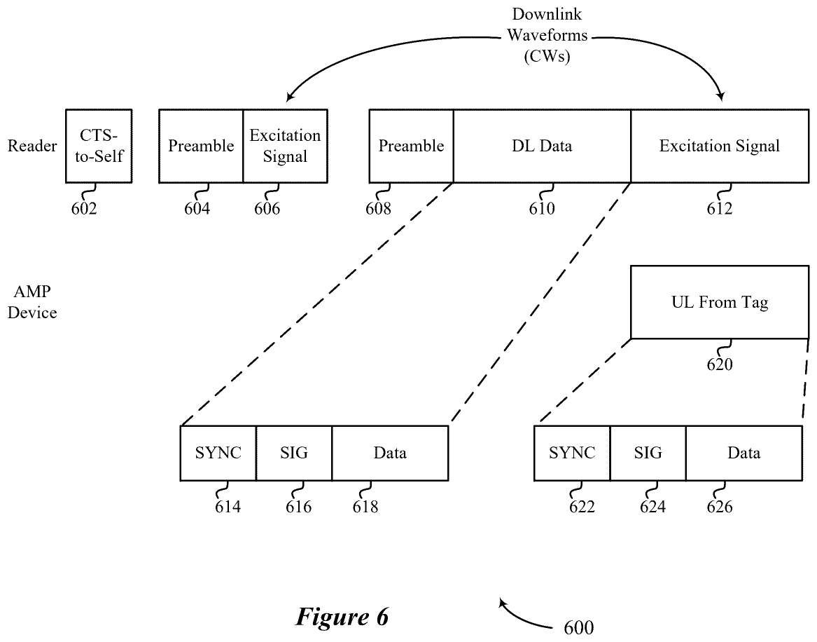

FIG. 6 shows an example of a PPDU configuration 600 that supports PPDU for AMP devices. The PPDU configuration 600 may implement aspects of wireless communication network 100, aspects of PPDU 200, aspects of frequency diagram 300, or aspects of wireless communications system 400. Aspects of the PPDU configuration 600 may be implemented at or implemented by wireless device(s), which may be an example of the corresponding devices described herein. The wireless device(s) may be an example of an AMP device (such as a UE or a STA) or a reader (such as a UE, a STA, an AP, or a network entity) communicating with the AMP device.

The PPDU configuration 600 illustrates an example where the AMP device PPDU is being communicated to an AMP device that uses backscatter-based communications and, therefore, uses excitation signals (such as CW signals) to provide operating energy for the AMP device. However, it is to be understood that in some scenarios the AMP device may be a semi-passive or active device that does not rely on the reader for operating energy and, therefore, the AMP device PPDU may not include any excitation signals. Accordingly, the various techniques described herein are not limited to AMP devices using backscatter-based communications but may instead be equally applicable for AMP devices that are capable of generating or storing their own operating energy and, therefore, the AMP device PPDU may not include excitation signal(s) in some implementations.

Generally, the PPDU may include a CTS-to-self 602 that signals to other wireless devices that the channel is being reserved for a period of time (such as for the CTS-to-self frame). The CTS-to-self 602 may reserve the channel for up to 32 ms in case the reader to AMP device communications take more than one TxOP. The CTS-to-self 602 may be preferred in a mixed environment with other 802-11 based devices that are incapable of understanding legacy preambles. The CTS-to-self 602 may be followed by a preamble portion 604 and an excitation signal 606. In this example, the initial excitation signal (such as the excitation signal 606) may be sent in a separate transmission prior to the AMP PPDU to reduce the overhead and accommodate a longer communication duration between the AMP device and the reader. That is, the preamble portion 604 and the excitation signal 606 may form a first PPDU that is used to provide initial operating power or energy to the AMP device.

The AMP device PPDU may include a second PPDU (such as the AMP device PPDU) that includes a preamble portion 608, a downlink data portion 610, and an excitation signal 612. The preamble portion 608 may include various signals or fields. The preamble portion 608 may include an L-LTF and an L-STF that defers transmissions from other devices once detected. The preamble portion 608 may include an L-SIG that indicates the channel busy time or the packet duration (such as the TxOP duration). In some implementations, a version specific SIG may be used to let the unintended receiving devices know about the AMP transmission.

The excitation signals (such as the excitation signal 606 and the excitation signal 612) may be used for uplink data from the AMP device (such as may be used to energize the AMP device) or may be used for providing initial operational energy. That is, the excitation signals may be transmitted by the reader for the AMP device in order to provide energy to the AMP device. The excitation signal 612 may be used by the AMP device to encode uplink information to perform an uplink transmission during the uplink data portion 620. That is, the AMP device may reflect or refract the excitation signal 612 back to the reader after encoding the small amount of uplink information or data onto the excitation signal 612 in order to perform an uplink transmission corresponding to the uplink data portion 620. The excitation signal 612 may be used whenever the AMP device is to communicate uplink data (such as the uplink data from the AMP device coincides with the excitation signal, such as at least partially overlaps in the time domain).

The downlink data portion 610 and an uplink data portion 620 may include the reader sending data to and receiving data from the AMP device that is organized into SYNC, SIG, and the MAC payload sections (such as data). The downlink data portion 610 may include a SYNC 614, a SIG 616, and a data portion 618. The uplink data portion 620 may include a SYNC 622, a SIG 624, and a data portion 626.

Some AMP devices may have a start-up time (such as up to 1.5 ms) to energize the AMP device and to wake up all the subsystems (such as the memory and clock generators). For that Ims duration, the AMP device may need to harvest energy continuously from the excitation signal before performing any data communication to/from the AMP device. For this reason, an excitation signal of 1.5 ms duration containing downlink waveform (such as DSSS, OFDM symbols, or other possible physical layer waveforms) are added after the legacy preamble.

In some aspects, the preamble portion 604, the preamble portion 608, or both preamble portions may include a spoofing preamble portion. That is, the spoofing preamble portion may mimic (at least to some degree) a preamble portion of the preamble in a non-AMP device PPDU (such as 802.11be and 802.11bn PPDU preamble portions). Accordingly, the AMP device (such as a wireless device) may receive or otherwise obtain (and the reader may transmit or otherwise output) a PPDU during a TxOP that includes at least one spoofing preamble portion (such as the preamble portion 608), at least one downlink data portion (such as the downlink data portion 610), and at least one uplink data portion (such as the uplink data portion 620). In this example, the AMP device PPDU also includes the excitation signal 606 and the excitation signal 612. That is, in this example the AMP device PPDU includes a first PPDU that includes a first spoofing preamble portion (such as the preamble portion 604) and a first excitation signal portion (such as the excitation signal 606). The PPDU may include a second PPDU (such as the AMP device PPDU) that includes a second spoofing preamble portion (such as the preamble portion 608), a downlink data portion (such as the downlink data portion 610), and a second excitation signal portion (such as the excitation signal 612). The first excitation signal portion and the second excitation signal portion may include power signals (such as CWs) configured to passively power the wireless device.

The wireless device may use the second excitation signal to encode uplink information and perform an uplink transmission during the uplink data portion 620. The AMP device may transmit or otherwise output (and the reader may receive or otherwise obtain) an uplink signal during the TxOP according to field(s) that define the PPDU as an AMP device PPDU. That is, various field(s) or other aspects of the preamble portion 608 (such as the at least one spoofing preamble portion), the downlink data portion 610 (such as the at least one downlink data portion), or both portions may be set to values or use other parameters that define the PPDU as an AMP device PPDU rather than a non-AMP device PPDU. Various details and examples of such field(s) or other aspects that define the PPDU as the AMP device PPDU are described herein.

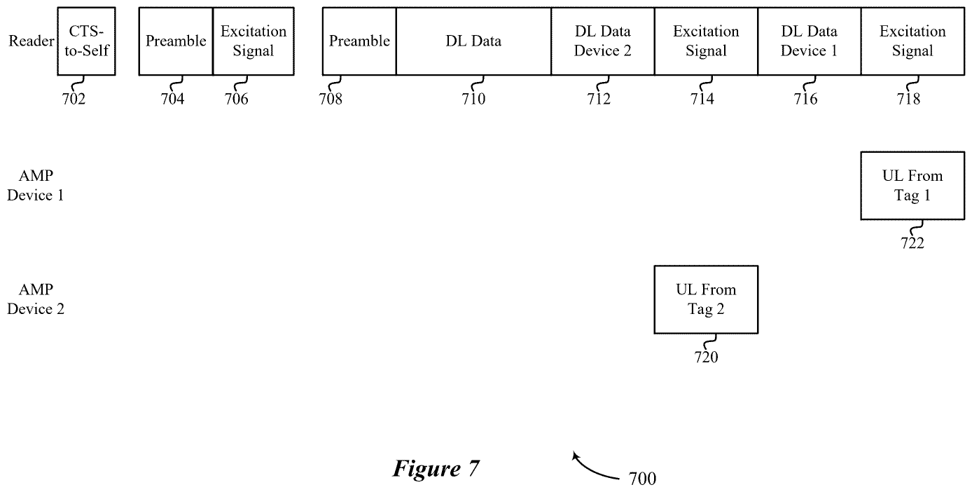

FIG. 7 shows an example of a PPDU configuration 700 that supports PPDU for AMP devices. The PPDU configuration 700 may implement aspects of wireless communication network 100, aspects of PPDU 200, aspects of frequency diagram 300, or aspects of wireless communications system 400. Aspects of the PPDU configuration 700 may be implemented at or implemented by wireless device(s), which may be an example of the corresponding devices described herein. The wireless device(s) may be an example of an AMP device (such as a UE or a STA) or a reader (such as a UE, a STA, an AP, or a network entity) communicating with the AMP device.

The PPDU configuration 700 illustrates an example in which the AMP device PPDU is communicated to an AMP device that uses backscatter-based communications and, therefore, uses excitation signals (such as CW signals) to provide operating energy for the AMP device. However, it is to be understood that in some scenarios the AMP device may be a semi-passive or active device that does not rely on the reader for operating energy and, therefore, the PPDU may not include any excitation signals. Accordingly, the various techniques described herein are not limited to AMP devices using backscatter-based communications but may instead be equally applicable for AMP devices that are capable of generating or storing their own operating energy and, therefore, the AMP device PPDU may not include excitation signal(s) in some implementations.

The PPDU configuration 700 illustrates an example where the AMP PPDU contains multiple segments of uplink and downlink blocks to support multiple data exchanges between the reader and one or multiple AMP devices in a single PPDU. Generally, the PPDU may include a CTS-to-self 702 that signals to other wireless devices that the channel is being reserved for a period of time. The CTS-to-self 702 may reserve the channel for up to 32 ms in case the reader to AMP device communications take more than one TxOP. The CTS-to-self 702 may be preferred in a mixed environment with other 802-11 based devices that are incapable of understanding legacy preambles. The CTS-to-self 702 may be followed by a preamble portion 704 and an excitation signal 706. In this example, the initial excitation signal (such as the excitation signal 706) may be sent in a separate transmission prior to the AMP PPDU to reduce the overhead and accommodate a longer communication duration between the AMP device(s) and the reader. That is, the initial excitation signal (such as the excitation signal 706) may be sent in a separate transmission prior to the AMP PPDU to reduce the overhead and accommodate a longer communication duration between the AMP device and the reader. The preamble portion 704 and the excitation signal 706 may form a first PPDU that is used to provide initial operating power or energy to the AMP device.

The PPDU may include a second PPDU (such as the AMP device PPDU) that includes a preamble portion 708, a downlink data portion 710, a downlink data portion 712, an excitation signal 714, a downlink data portion 716, and an excitation signal 718. The preamble portion 708 may include various signals or fields. The preamble portion 708 may include an L-LTF and an L-STF that defers transmissions from other devices once detected. The preamble portion 708 may include an L-SIG that indicates the channel busy time or the packet duration (such as the TxOP). In some implementations, a version specific SIG may be used to let the unintended receiving devices know about the AMP transmission.

The excitation signals (such as the excitation signal 706, the excitation signal 714, and the excitation signal 718) may be used for uplink data from the AMP device (such as may be used to energize the AMP device) or may be used for providing initial operational energy. That is, the excitation signals may be transmitted by the reader for the AMP device in order to provide energy to the AMP device. The excitation signal 714, the excitation signal 718, or both excitation signals may be used by the AMP device to encode uplink information to perform an uplink transmission during the uplink data portion 720 or the uplink data portion 722, respectively. That is, the AMP device may reflect or refract the excitation signal 714, the excitation signal 718, or both excitation signals back to the reader after encoding the small amount of uplink information or data onto the excitation signal(s) in order to perform uplink transmission(s) corresponding to the uplink data portion 720 or the uplink data portion 722. The excitation signal 714, the excitation signal 718, or both excitation signals may be used whenever the AMP device is to communicate uplink data (such as the uplink data from the AMP device coincides with the excitation signal(s), such as at least partially overlaps in the time domain).

The downlink data portion 710 may be used to provide downlink data to one or more AMP devices (such as common or shared downlink data to multiple AMP devices). The downlink data portion 712 may be used to carry or otherwise convey downlink data to a first AMP device (such as AMP device 2 in this example). The excitation signal 714 may be used to provide energy to the first AMP device. The first AMP device may reflect or refract the excitation signal 714 to convey an uplink data portion 720 that includes encoded data from the first AMP device that may organized into SYNC, SIG, and the MAC payload sections (such as data). The downlink data portion 716 may be used to carry or otherwise convey downlink data to a second AMP device (such as AMP device 1 in this example). The excitation signal 718 may be used to provide energy to the second AMP device. The second AMP device may reflect or refract the excitation signal 718 to convey an uplink data portion 722 that includes encoded data from the second AMP device that may organized into SYNC, SIG, and the MAC payload sections (such as data). Accordingly, the excitation signal(s) may be used whenever the AMP device is to communicate uplink data (such as the uplink from the AMP device (such as the AMP tag) coincides with the excitation signal).

In some aspects, the preamble portion 704, the preamble portion 708, or both preamble portions may include a spoofing preamble portion. That is, the spoofing preamble portion may mimic (at least to some degree) a preamble portion of the preamble in a non-AMP device PPDU (such as 802.11be and 802.11bn PPDU preamble portions). Accordingly, the AMP device (such as a wireless device) may receive or otherwise obtain (and the reader may transmit or otherwise output) a PPDU during a TxOP that includes at least one spoofing preamble portion (such as the preamble portion 708), at least one downlink data portion (such as the downlink data portion 710, the downlink data portion 712, the downlink data portion 716, or each portion), and at least one uplink data portion (such as the uplink data portion 720, the uplink data portion 722, or both portions). In this example, the AMP device PPDU also includes the excitation signal 706, the excitation signal 714, and the excitation signal 718. That is, in this example the PPDU includes a first PPDU that includes a first spoofing preamble portion (such as the preamble portion 704) and a first excitation signal portion (such as the excitation signal 706). The PPDU may include a second PPDU that includes a second spoofing preamble portion (such as the preamble portion 708), a common downlink data portion (such as the downlink data portion 710), a first device-specific downlink data portion (such as the downlink data portion 712), a second excitation signal portion (such as the excitation signal 714), a second device-specific downlink data portion (such as the downlink data portion 716), and a third excitation signal portion (such as the excitation signal 718). The first excitation signal portion, the second excitation signal portion, and the third excitation signal portion may include power signals (such as CWs) configured to passively power the wireless device and one or more other wireless devices (in some implementations). At least one of the second excitation signal portion or the third excitation signal portion may be used by the wireless device to encode uplink information and perform an uplink transmission during the at least one uplink data portion.

The second excitation signal may be used by the wireless device to encode uplink information and perform an uplink transmission during the uplink data portion 720. Similarly, the third excitation signal may be used by the wireless device to encode uplink information and perform an uplink transmission during the uplink data portion 722. The AMP device may transmit or otherwise output (and the reader may receive or otherwise obtain) an uplink signal during the TxOP according to field(s) that define the PPDU as an AMP device PPDU. That is, various field(s) or other aspects of the preamble portion 708 (such as the at least one spoofing preamble portion), one or more of the downlink data portion 710, the downlink data portion 712, and the downlink data portion 716 (such as the at least one downlink data portion), or both portions may be set to values or use other parameters that define the PPDU as an AMP device PPDU rather than a non-AMP device PPDU. Various details and examples of such field(s) or other aspects that define the PPDU as the AMP device PPDU are described herein.

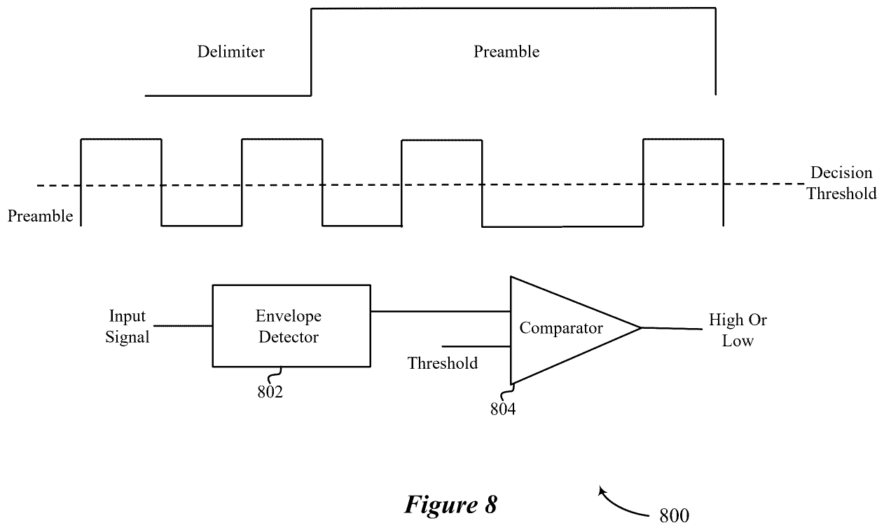

FIG. 8 shows an example of a decision threshold configuration 800 that supports PPDU for AMP devices. The decision threshold configuration 800 may implement aspects of wireless communication network 100, aspects of PPDU 200, aspects of frequency diagram 300, or aspects of wireless communications system 400. Aspects of the decision threshold configuration 800 may be implemented at or implemented by wireless device(s), which may be examples of the corresponding device described herein. The wireless device(s) may be an example of an AMP device (such as a UE or a STA) or a reader (such as a UE, a STA, an AP, or a network entity) communicating with the AMP device.

As discussed above, aspects of the techniques described herein may leverage field(s) within a spoofing preamble portion, at least one downlink data portion, or in both portions, to define or otherwise differentiate an AMP device PPDU from a non-AMP device PPDU. The AMP device (such as a wireless device) may receive or otherwise obtain (and the reader may transmit or otherwise output) a PPDU during a TxOP that includes at least one spoofing preamble portion, at least one downlink data portion, and at least one uplink data portion. In some scenarios, the AMP device PPDU also includes one or more excitation signals. The excitation signal portion(s) may include power signals (such as CW) configured to passively power the wireless device. Additionally, or alternatively, the excitation signal portion(s) may be used by the wireless device to encode uplink information and perform an uplink transmission during at least one uplink data portion. The AMP device may transmit or otherwise output (and the reader may receive or otherwise obtain) an uplink signal during the TxOP according to field(s) that define the PPDU as an AMP device PPDU. Accordingly, various field(s) or other aspects of the at least one spoofing preamble portion, the at least one downlink data portion, or both portions may be set to values or use other parameters that define the PPDU as an AMP device PPDU rather than a non-AMP device PPDU.

As also discussed above, the AMP device may choose a decision threshold for its on-off keying (OOK) receiver. In some implementations, the AMP device may not have a very accurate clock (such as its internal clock may have up to a ten percent error) because of the absence of a crystal on the clock. This may result in the AMP device needing to calibrate its internal clock. As also discussed above, in some aspects the at least one downlink data portion of the AMP device PPDU may include a SYNC, SIG, and data portions. In some implementations, the SYNC field may include a preamble and a delimiter. The delimiter may include an OFF period used to indicate the start of the SYNC field. The delimiter may be used in ultra-high frequency (UHF) RFIDs. The preamble portion may be a predefined bit sequence using a downlink waveform modulated as ON-OFF bits. The SYNC field may be used by the AMP device to arrive at a power threshold to classify the symbol as a “0” (such as low) or as a “1” (such as a high). The SYNC field may be used to acquire or to calibrate the downlink timing of the AMP device. The SYNC field may be used to identify the beginning of the SIG and data fields.

The AMP device may include an OOK receiver that uses a decision threshold to determine whether the incoming signal is high or low. To help the AMP device determine its decision threshold, the SYNC field may include a random bit sequence that is encoded in a Manchester format. The Manchester format may ensure that there are an equal number of high and low levels (such as 1s and 0s). The mean amplitude level may be used to identify or otherwise determine the decision threshold. The OOK receiver of the AMP device may include an envelope detector 802 and a comparator 804. The input signal (such as the preamble portion of the SYNC field of the at least one downlink data portion) may be provided into the envelope detector 802. The envelope detector 802 may measure or otherwise determine the mean amplitude level. The output of the envelope detector 802 may be provided as one input to the comparator 804 with the other input being set to a value corresponding to the decision threshold. The comparator 804 may provide an output indicative of whether the input signal is a high (such as a “1”) or a low (such as a “0”).

Regarding the AMP device downlink clock offset correction, the preamble portion of the SYNC field may be used to calibrate the clock by performing a counting of the number of clock cycles elapsed within the duration of the preamble. As one example, the preamble duration may be 100 microseconds and an ideal AMP device clock may be set to 1 MHz. Ideally, there may be 100 preamble samples. However, due to the ten percent clock inaccuracy at the AMP device, there may be between 0.9 MHz to 1.1 MHz and there may be 90 to 110 samples. The difference in the number of samples from the ideal number may indicate the amount of clock offset on the AMP device from the ideal number.

In some aspects, the field(s) of the at least one downlink data portion of the AMP device PPDU that are configured or otherwise used to define or otherwise identify the PPDU as an AMP device PPDU may be based on the SYNC field (such as the SYNC 512 of FIG. 5) or the SIG field (such as the SIG 514 of FIG. 5) of the at least one downlink data portion. One approach may include using the SYNC field to define, signal, or otherwise identify the PPDU as the AMP device PPDU. This approach may include using different SYNC fields encoding for backscatter PPDUs (such as AMP device PPDUs) and non-backscatter PPDUs (such as non-AMP device PPDUs). That is, the one or more fields of the at least one downlink data portion may include a synchronization field (such as the SYNC field). A first modulation type associated with the synchronization field may define the PPDU as the AMP device PPDU. In contrast, a second modulation type may be associated with a non-AMP device PPDU.

The downlink SYNC field may include an empty delimiter and the preamble may include a Manchester encoded OOK modulated bit sequence used for arriving at the decision threshold. The Manchester encoded OOK sequence also may be used for clock frequency error correction. This aspect of the downlink SYNC field may be common to both backscatter and non-backscatter AMP devices. For backscatter AMP devices (such as to define the PPDU as an AMP device PPDU) the preamble may use pulse interval encoding (PIE) bit 0 and bit 1 waveforms at the end of the SYNC field (such as may be used in UHF RFID tags). In this example, the PIE encoding may include the first modulation type. In some aspects, the at least one downlink data portion of the PPDU may be modulated using the first modulation type (such as the PIE encoding). That is, the remaining fields of the PPDU also may be encoded using PIE encoding. This may define, differentiate or otherwise identify the PPDU as an AMP device PPDU. For non-backscatter AMP devices (such as to define the PPDU as a non-AMP device PPDU) the remaining PPDU fields may use Manchester encoding (such as the second modulation type). The SIG field of the at least one downlink data portion may include the same or similar content as the SIG field for an approach (such as the second approach discussed below) where the same SYNC field is used for both AMP device PPDUs and non-AMP device PPDUs (such as without the type indicator). The SIG field may use Manchester encoding for non-backscatter PPDUs or PIE encoding for backscatter PPDUs.

Another approach may include using the SIG field to define, signal, or otherwise identify the PPDU as the AMP device PPDU. The one or more fields of the at least one downlink data portion may include a synchronization field (such as the SYNC field) that is common to both AMP device PPDUs and non-AMP device PPDUs. That is, the same SYNC fields may be used for both backscatter and non-backscatter device PPDUs. Instead, one or more fields of the SIG field may be used (such as set to a value or other configuration) to define, differentiate, or otherwise identify the PPDU as an AMP device PPDU or as a non-AMP device PPDU. The SIG field type indicator bit may be used to distinguish the PPDUs.

Again, the downlink SYNC field may include an empty delimiter and the preamble may include a Manchester encoded OOK modulated bit sequence used for arriving at the decision threshold. The Manchester encoded OOK sequence also may be used for clock frequency error correction. This aspect of the downlink SYNC field may be common to both backscatter and non-backscatter AMP devices. The SIG field may include various fields or parameters. The SIG field may include a field type indicator that that is set to a value or configuration that defines the PPDU as the AMP device PPDU. Thus, in this approach the SIG field of the at least one downlink data portion may carry or otherwise convey a field type indicator (such as an indicator for the PPDU type) that defines the PPDU as an AMP device PPDU or as a non-AMP device PPDU.

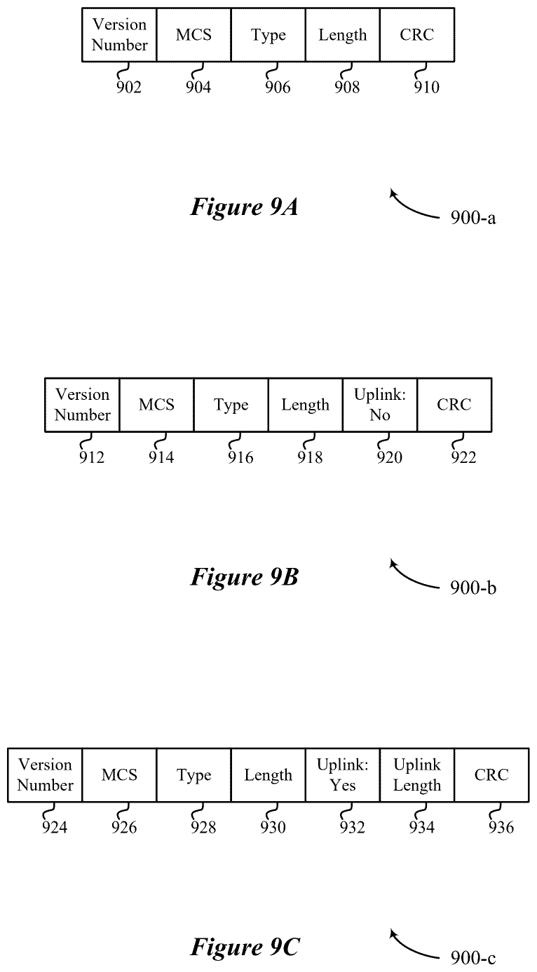

FIGS. 9A-9C show examples of a downlink SIG configuration 900 that supports PPDU for AMP devices. The downlink SIG configuration 900 may implement aspects of wireless communication network 100, aspects of PPDU 200, aspects of frequency diagram 300, or aspects of wireless communications system 400. Aspects of the downlink SIG configuration 900 may be implemented at or implemented by wireless device(s), which may be examples of the corresponding device(s) described herein. The wireless device(s) may be an example of an AMP device (such as a UE or a STA) or a reader (such as a UE, a STA, an AP, or a network entity) communicating with the AMP device.

As discussed above, aspects of the techniques described herein may leverage field(s) within a spoofing preamble portion, at least one downlink data portion, or in both portions, to define or otherwise differentiate an AMP device PPDU from a non-AMP device PPDU. The AMP device (such as a wireless device) may receive or otherwise obtain (and the reader may transmit or otherwise output) a PPDU during a TxOP that includes at least one spoofing preamble portion, at least one downlink data portion, and at least one uplink data portion. In some scenarios, the AMP device PPDU also includes one or more excitation signals. The excitation signal portion(s) may include power signals (such as CW) configured to passively power the wireless device. Additionally, or alternatively, the excitation signal portion(s) may be used by the wireless device to encode uplink information and perform an uplink transmission during at least one uplink data portion. The AMP device may transmit or otherwise output (and the reader may receive or otherwise obtain) an uplink signal during the TxOP according to field(s) that define the PPDU as an AMP device PPDU. Accordingly, various field(s) or other aspects of the at least one spoofing preamble portion, the at least one downlink data portion, or both portions may be set to values or use other parameters that define the PPDU as an AMP device PPDU rather than a non-AMP device PPDU.

The field(s) of the at least one downlink data portion of the AMP device PPDU that are configured or otherwise used to define or otherwise identify the PPDU as an AMP device PPDU may be based on the SYNC field (such as the SYNC 512 of FIG. 5) or the SIG field (such as the SIG 514 of FIG. 5) of the at least one downlink data portion. One approach may include using the SYNC field to define, signal, or otherwise identify the PPDU as the AMP device PPDU. This approach may include using different SYNC fields encoding for backscatter PPDUs (such as AMP device PPDUs) and non-backscatter PPDUs (such as non-AMP device PPDUs).

Another approach may include using the SIG field to define, signal, or otherwise identify the PPDU as the AMP device PPDU. The one or more fields of the at least one downlink data portion may include a synchronization field (such as the SYNC field) that is common to both AMP device PPDUs and non-AMP device PPDUs. That is, the same SYNC fields may be used for both backscatter and non-backscatter device PPDUs. Instead, one or more fields of the SIG field may be used (such as set to a value or other configuration) to define, differentiate, or otherwise identify the PPDU as an AMP device PPDU or as a non-AMP device PPDU. The SIG field type indicator bit may be used to distinguish the PPDUs.

The SIG field may include various fields or parameters. The SIG field may include a field type indicator that that is set to a value or configuration that defines the PPDU as the AMP device PPDU. Thus, in this approach the SIG field of the at least one downlink data portion may carry or otherwise convey a field type indicator (such as an indicator for the PPDU type) that defines the PPDU as an AMP device PPDU or as a non-AMP device PPDU.

The downlink SIG configuration 900 illustrates three examples of a downlink SIG field that may be applied according to the various techniques described herein. The SIG field may identify one or more of a first length of the at least one downlink data portion, an uplink data indication, and a second length of the at least one uplink data portion. For example, and turning first to the downlink SIG configuration 900-a of FIG. 9A, the downlink SIG field may include any or all of the (sub) fields that include a version number field 902, an MCS field 904, a type field 906, a length field 908, and a CRC 910. The version number field 902 may carry or otherwise convey information identifying the version number to indicate the AMP version. The MCS field 904 may carry or otherwise convey information or an indication of the MCS, the data rate, or both being used for the SIG field, for the PPDU, or for both. The type field 906 may carry or otherwise convey information identifying or indicating whether the PPDU type is a backscatter PPDU (such as an AMP device PPDU) or a non-backscatter PPDU (such as a non-AMP device PPDU). The length field 908 may carry or otherwise convey information identifying a length or number of octets indicator in the downlink data. The CRC 910 may include a short CRC in the SIG field. In the case where the downlink SIG configuration 900-a is for a non-backscatter PPDU, the SIG field bits may be encoded using Manchester coding OOK.

Turning next to the downlink SIG configuration 900-b of FIG. 9B, the downlink SIG field may include any or all the (sub) fields that include a version number field 912, an MCS field 914, a type field 916, a length field 918, an uplink field 920, and a CRC 922. The version number field 912 may carry or otherwise convey information identifying the version number to indicate the AMP version. The MCS field 914 may carry or otherwise convey information or an indication of the MCS, the data rate, or both being used for the SIG field, for the PPDU, or for both. The type field 916 may carry or otherwise convey information identifying or indicating whether the PPDU type is a backscatter PPDU (such as an AMP device PPDU) or a non-backscatter PPDU (such as a non-AMP device PPDU). The length field 918 may carry or otherwise convey information identifying a length or number of octets indicator in the downlink data. The uplink field 920 may use one or more bits to indicate if there is an uplink excitation signal following the downlink payload (such as at least one downlink data portion, such as either of the downlink data portions 712 or 716 of FIG. 7). The CRC 922 may include a short CRC in the SIG field. In the case where the downlink SIG configuration 900-b is for a non-backscatter PPDU, the SIG field bits may be encoded using Manchester coding OOK. In the case where the downlink SIG configuration 900-b is for a backscatter PPDU, the SIG field bits may be encoded using Manchester coding OOK. The downlink SIG configuration 900-b may illustrate an example where there is no downlink excitation signal (such as the uplink field 920 is set to “no”) following the downlink payload, and therefore there is no downlink excitation signal.

Turning finally to the downlink SIG configuration 900-c of FIG. 9C, the downlink SIG field may include any or all of the (sub) fields that include a version number field 924, an MCS field 926, a type field 928, a length field 930, an uplink field 932, an uplink length field 934, and a CRC 936. The version number field 924 may carry or otherwise convey information identifying the version number to indicate the AMP version. The MCS field 926 may carry or otherwise convey information or an indication of the MCS, the data rate, or both being used for the SIG field, for the PPDU, or for both. The type field 928 may carry or otherwise convey information identifying or indicating whether the PPDU type is a backscatter PPDU (such as an AMP device PPDU) or a non-backscatter PPDU (such as a non-AMP device PPDU). The length field 930 may carry or otherwise convey information identifying a length or number of octets indicator in the downlink data. The uplink field 932 may use one or more bits to indicate if there is an uplink excitation signal following the downlink payload (such as at least one downlink data portion, such as either of the downlink data portions 712 or 716 of FIG. 7). The uplink length field 934 may, if the uplink excitation signal is present, use one or more bits to indicate the length or duration of the uplink excitation signal. The CRC 936 may include a short CRC in the SIG field. In the case where the downlink SIG configuration 900-c is for a backscatter PPDU, the SIG field bits may be encoded using Manchester coding OOK. The downlink SIG configuration 900-c may illustrate an example where there is a downlink excitation signal (such as the uplink field 932 is set to “yes”) following the downlink payload and therefore the length of the downlink excitation signal is also indicated in the SIG field.

In some aspects, the downlink data field of the at least one downlink data portion may include control data. The control data may use Manchester encoding for non-backscatter AMP devices (such as UEs or STAs). The control data may use PIE or Manchester encoding for backscatter AMP devices (such as UEs or STAs). The control data may include information identifying an AMP device multiple access coordination, an AMP device identifier, or data to write to the AMP device. The control data may indicate a type of packet (such as tag discovery or communicating with a specific tag). The control data may carry or otherwise convey information relating to an uplink modulation format and data rate settings (Miller or FM0, number of resource units (Rus) being translated, or other information). The control data may include a CRC to verify downlink data checksum. In some implementations, up to 100 bits can be present in the downlink payload for backscatter tags.

As also discussed above, the at least one uplink data portion of the AMP PPDU may include a SYNC field, a SIG field, and an uplink data. The reader may use the SYNC field to estimate the clock offset of the AMP device and to find or otherwise determine the start or beginning of the uplink block. The SIG field may carry or otherwise convey information identifying an uplink duration or a number of uplink octets being communicated from the AMP device. The SIG field may include an indicator or other information identifying whether the uplink transmission continues in the next uplink block (such as in a subsequent TxOP). The SIG field may include a short CRC used for error correction. The uplink data may include 96 to 496 bits and include an electronic product code (EPC) of the AMP device (such as for tracking or inventory purposes), sensor data, or other information being communicated from the AMP device to the reader.

In some aspects, the uplink SYNC field (such as the SYNC field in the at least one uplink data portion) may be associated with the AMP device uplink clock also having an error from the ideal clock it has been asked to select by the reader. Therefore, the backscattered bits will also have a timing error. To solve this the AMP device may attach a preamble before the uplink payload. The preamble may include a repeated clock waveform that the reader asked the tag to select for data communications. The reader may have a higher degree of computational capability and can therefore use FFT or time domain signal processing methods to estimate the clock offset of the AMP device and correct for symbol timing.

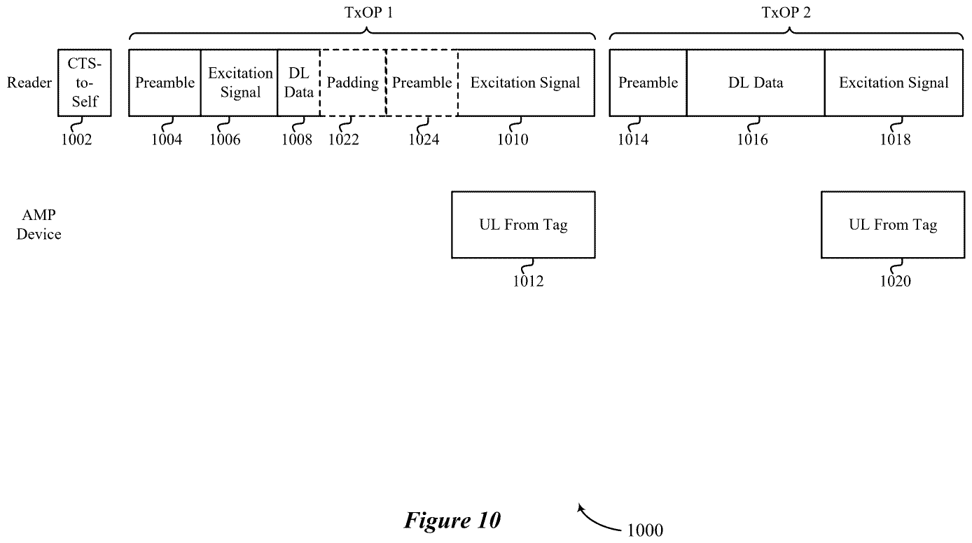

FIG. 10 shows an example of a PPDU configuration 1000 that supports PPDU for AMP devices. The PPDU configuration 1000 may implement aspects of wireless communication network 100, aspects of PPDU 200, aspects of frequency diagram 300, or aspects of wireless communications system 400. Aspects of the PPDU configuration 1000 may be implemented at or implemented by wireless device(s), which may be examples of the corresponding device(s) described herein. The wireless device(s) may be an example of an AMP device (such as a UE or a STA) or a reader (such as a UE, a STA, an AP, or a network entity) communicating with the AMP device.

As discussed above, aspects of the techniques described herein may leverage field(s) within a spoofing preamble portion, at least one downlink data portion, or in both portions, to define or otherwise differentiate an AMP device PPDU from a non-AMP device PPDU. The AMP device (such as a wireless device) may receive or otherwise obtain (and the reader may transmit or otherwise output) a PPDU during a TxOP that includes at least one spoofing preamble portion, at least one downlink data portion, and at least one uplink data portion. In some scenarios, the AMP device PPDU also includes one or more excitation signals. The excitation signal portion(s) may include power signals (such as CW) configured to passively power the wireless device. Additionally, or alternatively, the excitation signal portion(s) may be used by the wireless device to encode uplink information and perform an uplink transmission during at least one uplink data portion. The AMP device may transmit or otherwise output (and the reader may receive or otherwise obtain) an uplink signal during the TxOP according to field(s) that define the PPDU as an AMP device PPDU. Accordingly, various field(s) or other aspects of the at least one spoofing preamble portion, the at least one downlink data portion, or both portions may be set to values or use other parameters that define the PPDU as an AMP device PPDU rather than a non-AMP device PPDU.

As also discussed above, the at least one uplink data portion of the AMP PPDU may include a SYNC field, a SIG field, and an uplink data. The reader may use the SYNC field to estimate the clock offset of the AMP device and to find or otherwise determine the start or beginning of the uplink block. The SIG field may carry or otherwise convey information identifying an uplink duration or a number of uplink octets being communicated from the AMP device. The SIG field may include an indicator or other information identifying whether the uplink transmission continues on the next uplink block (such as in a subsequent TxOP). The SIG field may include a short CRC used for error correction. The uplink data may include 96 to 496 bits and include an electronic product code (EPC) of the AMP device (such as for tracking or inventory purposes), sensor data, or other information being communicated from the AMP device to the reader.

In some aspects, the uplink SIG field or the uplink data field may carry or otherwise convey information identifying whether additional excitation signals are needed. The AMP device may use an excitation signal so that the AMP device can encode its data on top of the excitation signal. In some implementations, the number of bits being sent on the uplink from the AMP device may be variable and depend on the command issued by the reader in the previous downlink. If all the uplink data bits cannot be communicated during one TxOP, the AMP device may indicate in its uplink SIG field or its uplink data field that more excitation signals are needed. In this implementation, the reader will continue sending more excitation signals in the next TxOP. In the context of RFID tags communicating using cellular-based technologies, this issue of having more uplink data to communicate than can fit within one TxOP does not exist as there is no concept of limited TxOP duration. Accordingly, PPDU configuration 1000 of FIG. 10 illustrates an example where the AMP device transmits a first portion of the uplink signal during the TxOP and a second portion of the uplink signal during a subsequent TxOP associated with the data size associated with the uplink signal satisfying a threshold (such as the data size is too large to be communicated during one TxOP).

Accordingly, the AMP device PPDU may begin with the CTS-to-self 1002 that signals to other wireless devices that the channel is being reserved for a period of time (such as the CTS-to-self frame). The CTS-to-self 1002 may reserve the channel for a frame duration of up to 32 ms in case the reader to AMP device communications take more than one TxOP (which are generally limited to 5 ms).

The CTS-to-self 1002 may be followed by a first or initial TxOP that includes a preamble portion 1004, an excitation signal 1006, a downlink data portion 1008, and an excitation signal 1010. In this example, the preamble portion 1004, the excitation signal 1006, the downlink data portion 1008, and the excitation signal 1010 may form a first AMP device PPDU within the CTS-to-self frame. The excitation signal 1010 may be used for uplink data portion 1012 from the AMP device (such as may be used to energize the AMP device). That is, the excitation signal 1010 may be transmitted by the reader for the AMP tag in order to provide energy to the AMP device. The excitation signal 1010 may be used by the AMP device to encode uplink information to perform an uplink transmission during the uplink data portion 1012. The AMP device may reflect or refract the excitation signal 1010 back to the reader after encoding the small amount of uplink information or data onto the excitation signal 1010 in order to perform uplink transmission corresponding to the uplink data portion 1012.

In this example, the number of bits (such as the data size) of the uplink data may exceed the threshold and therefore be unable to be communicated during the first or initial TxOP. Accordingly, the AMP device may configure the uplink SIG field or the uplink data portion of the uplink data portion 1012 to indicate that more excitation signals are needed for the AMP device to continue sending more uplink data. Accordingly, the AMP device may receive or otherwise obtain (and the reader may transmit or otherwise output) a preamble portion 1014, a downlink data portion 1016, and an excitation signal 1018 during a second TxOP (such as a second AMP device PPDU). The excitation signal 1018 may be used for the additional uplink data portion 1020 from the AMP device (such as may be used to energize the AMP device). That is, the excitation signal 1018 may be transmitted by the reader during the second TxOP for the AMP tag in order to provide energy to the AMP device. The excitation signal 1018 may be used by the AMP device to encode the additional uplink information to perform an uplink transmission during the uplink data portion 1020. The AMP device may reflect or refract the excitation signal 1018 back to the reader after encoding the small amount of additional uplink information or data onto the excitation signal 1018 in order to perform uplink transmission corresponding to the uplink data portion 1020.

Accordingly, PPDU configuration 1000 illustrates an example where the TxOP in an 802.11 configured network is limited to approximately five milliseconds. So, if the amount of uplink data exceeds the five milliseconds, the uplink data is split into two transmissions. This may include using the CTS-to-self 1002 to reserve the channel for up to 32 milliseconds so that two TxOPs can be used in succession to send all of the uplink data.

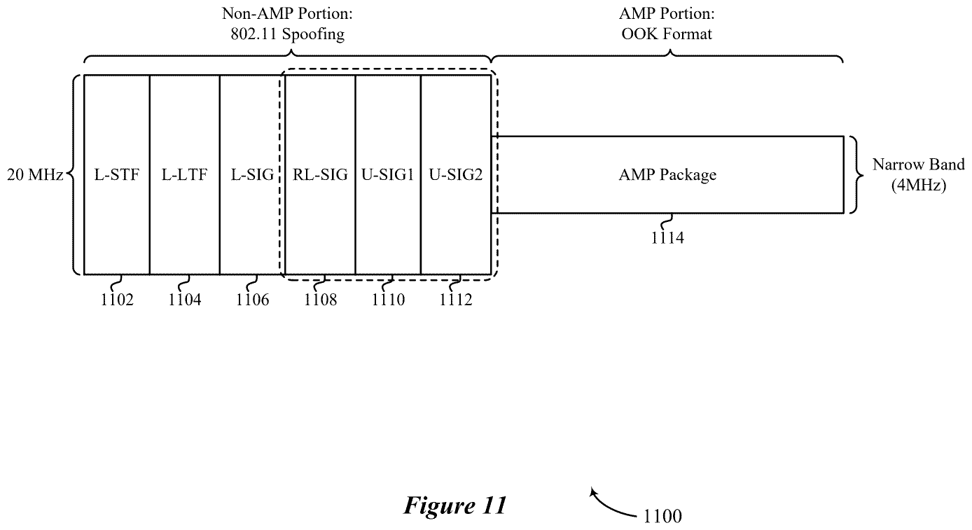

In some examples, the reader may transmit the preamble 1004 via a 40 MHz channel (such as to protect an uplink bi-static backscattered signal that may be frequency-shifted into a second 20 MHz channel, where the uplink from the tag may occur in an upper or lower 20 MHz channel relative to the downlink signal, and the two 20 MHz channels form a 40 MHz channel). In such examples, a bandwidth field of the preamble 1004 may be set to 40 MHz instead of 20 MHz. Additionally, or alternatively, the bandwidth field may be set to 20 MHz and the preamble 1004 may be duplicated in both 20 MHz channels. In other words, the reader may transmit a second preamble 1004 within a same duration as the transmission of the preamble 1004 but over a different 20 MHz channel. The reader may indicate two channels to block in a U-SIG field (such as in a U-SIG-1 or a U-SIG-2 as described further with reference to FIG. 11). For example, the reader may add a 1-bit additional channel field to indicate +1 for an upper 20 MHz channel or −1 for a lower 20 MHz channel. By way of further example, the reader may transmit the preamble 1004 via two non-adjacent 20 MHz channels (such as to protect an uplink bi-static backscattered signal that may be frequency-shifted into a second non-adjacent 20 MHz channel, where the uplink from the tag may occur in an upper or lower 20*K MHz (where K is an integer) channel relative to the downlink signal). The reader may add an additional channel field, such as a 3-bit additional channel field to indicate K={−3, −2, −1, +1, +2, +3} for a lower or upper 20 MHz channel that has a center frequency K times 20 MHz (that is, 20*K MHz) away. The preamble 1004 may include an L-LENGTH field to include or indicate a no-signal duration. Additionally, the reader may transmit entire or partial durations or one or more portions of the remaining of the downlink PPDU including the excitation signal 1006, the downlink data portion 1008, padding (such as within a padding field 1022), another excitation signal 1010, or any combination thereof via a 40 MHz channel (such as to protect an uplink bi-static backscattered signal that may be frequency-shifted into a second 20 MHz channel, where the uplink from the tag may occur in an upper or lower 20 MHz channel relative to the downlink signal, and the two 20 MHz channels form a 40 MHz channel). In the second 20 MHz channel which is intended for the uplink bi-static backscattered signal, only a partial duration of the excitation signal 1010 (such as a partial duration of an excitation field including the excitation signal 1010) may be transmitted and the downlink transmission may end in the second 20 MHz channel before the uplink bi-static backscattered signal is transmitted, with a gap period no greater than a threshold duration (such as a short inter-frame space (SIFS)=16 us).

In some examples, the PPDU configuration 1000 may include the preamble 1004 (such as a downlink spoofing preamble), a downlink signal (such as the downlink data portion 1008, which may include a SYNC field, SIG field, or Data field), a padding field 1022, a second preamble 1024 (such as a second spoofing preamble to protect the uplink transmission), and the excitation signal 1010. In such examples, the bi-static backscatter (such as the bi-static backscatter from an AMP device) may reflect the second preamble 1024 with all 1's in uplink transmission. The reader may include the padding field 1022 to provide sufficient processing time (such as a duration that satisfies a processing time threshold at the AMP device) for the backscatter and may include a second SYNC field within the padding field 1022 for the uplink tag to re-synchronize. A bandwidth field of the preamble 1004 (the first spoofing preamble) may be set to 20 MHz and a bandwidth field may be set to 20 MHz or 40 MHz in the second preamble 1024 (the second spoofing preamble). Additionally, or alternatively, the reader (such as an AMP AP) may transmit the CTS-to-self 1002 prior to the downlink PPDU to reserve a either a 20 MHz channel or a 40 MHz channel (which may support a unified approach for uplink active transmission and uplink mono-static backscattering transmission to reserve a 20 MHz channel and for uplink bi-static backscattering transmission to reserve a 40 MHz channel).

FIG. 11 shows an example of a spoofing preamble configuration 1100 that supports PPDU for AMP devices. The spoofing preamble configuration 1100 may implement aspects of wireless communication network 100, aspects of PPDU 200, aspects of frequency diagram 300, or aspects of wireless communications system 400. Aspects of the spoofing preamble configuration 1100 may be implemented at or implemented by wireless device(s), which may be examples of the corresponding device(s) described herein. The wireless device(s) may be an example of an AMP device (such as a UE or a STA) or a reader (such as a UE, a STA, an AP, or a network entity) communicating with the AMP device.

In some aspects, the 802.11ba downlink PPDU format may be a starting point for an AMP downlink PPDU format design. In terms of spoofing for bystanders (such as unintended OBSS STAs), the 802.11be downlink PPDU may use a spoofing preamble to spoof 802.11 STAs to treat the 802.11ba PPDU as an 802.11a PPDU. In some implementations, a new design may use a spoofing preamble design similar to the 802.11be downlink PPDU format so that 802.11be STAs can save power by early termination. A better preamble spoofing design may be needed for AMP device PPDU formats. In terms of the AMP device portion of the signal (intended for AMP device receivers), the AMP portion may be enhanced to carry richer information (such as different versions of AMP devices).

Aspects of the techniques described herein may follow similar design and further include a detailed spoofing preamble design for the AMP PPDU. Aspects of the AMP device PPDU design may include a spoofing preamble design, an AMP portion design, and uplink/downlink (UL/DL) differentiation.

In the case of a non-AMP portion of a preamble, this may include a spoofing preamble design similar to the 802.11be format which provides additional information in universal signal (U-SIG) field(s) (such as PHY version, BSS color, bandwidth, uplink/downlink (UL/DL), and TxOP). The third-party STAs (such as 802.11be/bn) can make an early determination of the incoming PPDU format and terminate the receive processer. A validate field in the U-SIG field may be used to indicate 802.11 bp PPDU. Alternatively, at least one of the subfields in the U-SIG being set to a validate state may be used to indicate the 802.11 bp PPDU. The 802.11be STA may see (such as detect, identify, parse, or interpret) a validate field as being set to 0, or one of the subfields as being set to a validate state, which may indicate or identify the 802.11 bp PPDU, and the 802.11be STA may terminate its receive processer. In other words, the 802.11be STA may terminate, cease, end, or pause a receive operation for a PPDU in accordance with detecting that the PPDU is an 802.11 bp PPDU (with such a detection being, for example, associated with the validate bit being set to 0, or one of the subfields being set to a validate state). When 802.11be STAs receive an 802.11 bp downlink PPDU, the STA may honor the TxOP duration indicated in U-SIG or it can perform a spatial reuse (SR) if the power level is under the SR threshold and OBSS. This design may increase 4 microsecond (such as due to one more OFDM symbols) as compared to an 802.11ba PPDU spoofing preamble design.

In some aspects, the 2-symbol U-SIG field may begin with five independent fields (such as the PHY version identifier, bandwidth, uplink/downlink (UL/DL), BSS color, and TxOP). The STA may interpret the U-SIG fields associated with the PPDU format. Table 1 illustrates an example of the 2-symbol U-SIG field (such as U-SIG-1 being the second part of the U-SIG to carry the first 26 information bits and U-SIG-2 being the second part of the U-SIG to carry the last 26 information bits) for an EHT MU PPDU. Table 2 illustrates an example of the 2-symbol U-SIG field for an EHT TB PPDU.

TABLE 1
U-SIG Fields in an EHT MU PPDU

| | | | Number |
|---|---|---|---|
| | Bits | Field | of Bits |
| U-SIG-1 | B0-B2 | PHY Version Identifier | 3 |
| | B3-B5 | Bandwidth | 3 |
| | B6 | UL/DL | 1 |
| | B7-B12 | BSS Color | 6 |
| | B13-B19 | TXOP | 7 |
| | B20-B24 | Disregard | 5 |
| | B25 | Validate | 1 |
| U-SIG-2 | B0-B1 | PPDU Type and Compression | 2 |
| | | Mode | |
| | B2 | Validate | 1 |
| | B3-B7 | Punctured Channel Information | 5 |
| | B8 | Validate | 1 |
| | B9-B10 | EHT-SIG MCS | 2 |
| | B11-B15 | Number Of EHT-SIG Symbols | 5 |
| | B16-B19 | CRC | 4 |
| | B20-B25 | Tail | 6 |

TABLE 2
U-SIG Fields in an EHT TB PPDU

| | | | Number |
|---|---|---|---|
| | Bits | Field | of Bits |
| U-SIG-1 | B0-B2 | PHY Version Identifier | 3 |
| | B3-B5 | Bandwidth | 3 |
| | B6 | UL/DL | 1 |
| | B7-B12 | BSS Color | 6 |
| | B13-B19 | TXOP | 7 |
| | B20-B25 | Disregard | 6 |
| U-SIG-2 | B0-B1 | PPDU Type and Compression | 2 |
| | | Mode | |
| | B2 | Validate | 1 |
| | B3-B6 | Spatial Reuse 1 | 4 |
| | B7-B10 | Spatial Reuse 2 | 4 |
| | B11-B15 | Disregard | 5 |
| | B16-B19 | CRC | 4 |
| | B20-B25 | Tail | 6 |

In the U-SIG field, if the uplink/downlink (UL/DL) subfield value is “0” and the PPDU type and compression mode value is “0-2” then the PPDU may be interpreted as an EHT MU PPDU with downlink OFDMA transmission, EHT SU transmission or sounding null data packet (NDP) in the downlink direction, and non-OFDM downlink MU-MIMO transmission, respectively. If the uplink/downlink (UL/DL) value is “1” and the PPDU type and compression mode value is “1” then the PPDU may be interpreted as an EHT MU PPDU with EHT SU transmission or sounding NDP in the uplink direction. If the uplink/downlink (UL/DL) value is “1” and the PPDU type and compression mode value is “0” then the PPDU may be interpreted as an EHT T PPDU.

According to the validate fields and states in 802.11be formats, the validate field values may serve to indicate whether to continue reception of a PPDU at an EHT STA. If an EHT STA encounters a PPDU where at least one validate field in the preamble is not set to a specified value, or at least one field in the EHT preamble equals a value that is identified as a validate state for the STA, the STA may terminate the PPDU processing, defer for the duration of the PPDU (such as a EHT receive procedure) and report the information from the version independent fields within the RXVECTOR. The validate fields may depend on the PHY version (EHT, UHR, and the like) and the PPDU format (MU PPDU, TB PPDU, and the like). The EHT MU PPDU may use B25 of U-SIG-1 and B2 and B8 of U-SIG-2 as validate fields. The EHT TB PPDU may use B2 of U-SIG-2 as a validate field. The values of certain fields may include validate states. For the EHT MU PPDU and the EHT TB PPDU, the PHY version identifier may use values 1-7 as validate states or the bandwidth values of 6-7 may be used as validate state. For the EHT MU PPDU, a PPDU type and compression mode may be used where, if the uplink/downlink (UL/DL) field is set to 0, a value of 3 in the PPDU type and compression mode may be a validate state. If the UL/DL field is set to 1, then values 2 and 3 in the PPDU type and compression mode may be the validate state. In the EHT TB PPDU, the PPDU type and compression mode values of 2-3 may be the validate state. The punctured channel information subfield unused states are the validate state. In an EHT MU PPDU, if the PPDU Type And Compression Mode field is set to 1 regardless of the value of the UL/DL field, or the PPDU Type And Compression Mode field is set to 2 and the UL/DL field is 0, the undefined values in the Punctured Channel Information subfield (such as values 1-31 if the bandwidth field is set to 0 or 1, values 5-31 if the bandwidth field is set to 2, values 13-31 if the bandwidth field is set to 3, values 25-31 if the bandwidth field is set to 4 or 5, and values 0-31 if the bandwidth field is set to 6 or 7) are valid. If the PPDU Type and Compression Mode field is set to 0 and the UL/DL field is 0, if the bandwidth field is set to a value between 2 and 5, any field values other than 1111, 0111, 1011, 1101, 1110, 0011, 1100, and 1001 in B3-B6 are valid. If the PPDU Type and Compression Mode field is set to 0 and the UL/DL field is 0, if the Bandwidth field is set to 0 or 1, any field values other than 1111 in B3-B6 are valid. If the PPDU Type and Compression Mode field is set to 0 and the UL/DL field is 0, if the bandwidth field is set to 6 or 7, any field values in B3-B6 are valid. As discussed above, aspects of the techniques described herein may leverage field(s) within a spoofing preamble portion, at least one downlink data portion, or in both portions, to define or otherwise differentiate an AMP device PPDU from a non-AMP device PPDU. The AMP device (such as a wireless device) may receive or otherwise obtain (and the reader may transmit or otherwise output) a PPDU during a TxOP that includes at least one spoofing preamble portion, at least one downlink data portion, and at least one uplink data portion. In some scenarios, the AMP device PPDU also includes one or more excitation signals. The excitation signal portion(s) may include power signals (such as CW) configured to passively power the wireless device. Additionally, or alternatively, the excitation signal portion(s) may be used by the wireless device to encode uplink information and perform an uplink transmission during at least one uplink data portion. The AMP device may transmit or otherwise output (and the reader may receive or otherwise obtain) an uplink signal during the TxOP according to field(s) that define the PPDU as an AMP device PPDU. Accordingly, various field(s) or other aspects of the at least one spoofing preamble portion, the at least one downlink data portion, or both portions may be set to values or use other parameters that define the PPDU as an AMP device PPDU rather than a non-AMP device PPDU.

The spoofing preamble configuration 1100 of FIG. 11 illustrates an example where the at least one spoofing preamble portion includes one or more SIG fields that are set to values that define the PPDU as the AMP device PPDU. In particular, the spoofing preamble configuration 1100 illustrates an example that uses three (binary phase shift keying (BPSK)-mark symbols, where BPSK-mark1 is the RL-SIG field and the BPSK-mark2 and BPSK-mark3 are the 2-symbol U-SIG field. The at least one spoofing preamble portion includes at least an L-STF 1102, an L-LTF 1104, an L-SIG 1106, a repeat L-SIG field (RL-SIG) 1108, a U-SIG1 1110, and a U-SIG2 1112, that are followed by an AMP package 1114 (the AMP-specific downlink and excitation fields). In some aspects, a length parameter included in the L-SIG or the RL-SIG is set to a value that is a multiple of three to define the PPDU as the AMP device PPDU.

That is, in this example the L_LEN % 3 is equal to 0 (such as the length parameter is set to a value that is a multiple of three). Accordingly, aspects of the techniques described herein provide for a preamble design where a certain field is set to a validate state. The 802.11be STAs may terminate the receive processing and report the values of the version independent fields to the MAC layer. The 802.11bn and beyond STAs will understand that this is AMP device PPDU, terminate the receive processing and report the values of the version independent fields to the MAC layer and change the bandwidth value to 20 MHz (or optionally 80 MHz, associated with bandwidth detection) in the MAC report.

In some aspects, certain fields may be repurposed to carry other information. The U-SIG fields may use a spatial reuse field (4 bits) for downlink SR information. The value(s) in the L-SIG, the RL-SIG, the U-SIG1, the U-SIG2, or any combination of such fields may be set to carry or otherwise convey an indication that the PPDU is an AMP device PPDU associated with the validate state. As one example, this may include setting the PHY version identifier to 0 (such as for EHT) or to 1 (such as for UHR) and setting the bandwidth to 6 or 7 to indicate the validate state (such as to identify the PPDU as an AMP device PPDU). The other 22 bits (B20-B25 of U-SIG-1 and B0-B15 of U-SIG-2) may be repurposed to carry other information. As another example, this may include setting the PHY version identifier to 0 (such as for EHT), setting the UL/DL to 0 (such as to indicate downlink) and setting the PPDU type and compression mode to 3 to indicate the validate state.

In some examples, setting the PHY version identifier to 0, the UL/DL to 0, and setting the PPDU type and compression mode to 3 may identify a PPDU as an AMP PPDU. The remaining 20 bits, including B20-B25 in U-SIG-1 and B2-B15 in U-SIG-2, may carry other information. For example, 1-2 bits may indicate the AMP version as an AMP version-independent field. Another bit may indicate whether the PPDU is for bi-static backscatter communication. For example, B2 of U-SIG-2 may be used as a 1-bit AMP version field. The remaining bits may be reserved bits that may be defined as disregard bits or validate bits. In some examples, all reserved bits may be defined as disregard bits. Further, the value of the disregard bits may be left to implementation to avoid the peak-to-average-power ratio (PAPR) of the two U-SIG symbols from exceeding a threshold (such as being too large) or to reduce the PAPR of the two U-SIG symbols (such as to reduce the PAPR below the threshold). In some examples, the value of the remaining bits (such as the reserved bits) may be set to specific values to avoid the peak-to-average-power ratio (PAPR) of the two U-SIG symbols from exceeding a threshold (such as being too large) or to reduce the PAPR of the two U-SIG symbols (such as to reduce the PAPR below the threshold). For example, the remaining bits may be set according to (such as equal to) the bit values in the U-SIG of an EHT sounding NDP or U-SIG of an UHR ELR PPDU. By way of example, B20-B24 in U-SIG-1 may be disregard bits and set to all 1's and B25 in U-SIG-1 may be a validate bit set to 1 (such as in an EHT MU PPDU). In this way, U-SIG-1 in the AMP PPDU may carry the same coded bits as in U-SIG-1 in an EHT MU PPDU and may achieve the same PAPR performance as U-SIG-1 in an EHT MU PPDU. B2 of U-SIG-2 (in examples in which B2 is not used to carry information) may be a validate bit and set to 1, same as B2 of U-SIG-2 in an EHT MU PPDU. B8 of U-SIG-2, in accordance with B8 not being used to carry any information, may be a validate bit and set to 1, same as B8 of U-SIG-2 in an EHT MU PPDU. B3-B7 of U-SIG-2 (in accordance with not carrying information) may be disregard or validate bits, and may be set to values similar to the 5-bit punctured channel information field in U-SIG of an EHT MU PPDU. B3-B7 of U-SIG-2 may include one or more 0's, similar to the 5-bit punctured channel information field in U-SIG of an EHT MU PPDU in a non-OFDMA transmission. For example, B3-B7 of U-SIG-2 may be set to all 0's or a combination of 1's and 0's. Alternatively, B3-B6 of U-SIG-2 may be set to one of the following patterns: 1111, 0111, 1011, 1101, 1110, 0011, 1100, and 1001, and B7 of U-SIG-2 is a disregard bit and set to 1, similar to the 5-bit punctured channel information field in U-SIG of an EHT MU PPDU in an OFDMA transmission. B9 and B10 of U-SIG-2 (in examples in which B9 and B10 are not used to carry any information) may be set to all 0's, same as the 2-bit EHT-SIG MCS field being set to indicate MCSO in an EHT MU PPDU. B11-B15 of U-SIG-2 (in examples in which B11-B15 are not used to carry any information) may be set to all 0's, same as the 5-bit number of EHT-SIG Symbols field being set to 0 to indicate 1 symbol in an EHT MU PPDU. B9-B15 of U-SIG-2 (in examples in which these bits are not used to carry any information) may be set to all 0's, same as the 2-bit EHT-SIG MCS field being set to 0 and the 5-bit Number of EHT-SIG Symbols field being set to 0 in an EHT MU PPDU in an EHT sounding NDP. Alternatively, B13-B15 of U-SIG-2 may be set to all 1's, same as the 3-bit ELR Validate field in an UHR ELR PPDU. B2-B12 of U-SIG-2 may be set to a value (such as an 11-bit STA ID), same as the 11-bit STA ID field in an UHR ELR PPDU.

The other 19 bits (B20-B25 of U-SIG-1 and B3-B15 of U-SIG-2) may be repurposed to carry other information. For example, the U-SIG may include one or more version-independent fields for all generations, one or more AMP version dependent fields, or a combination thereof. The AMP version independent fields may include an AMP version identifier that may indicate the AMP generation (such as value 0 for 802.11 bp as a first AMP generation). The AMP version independent fields may not include or indicate a spatial reuse (such that the remaining 19 bits of the U-SIG may not include or carry a spatial reuse field). The AMP version dependent fields may indicate one or more AMP modes. The one or more AMP modes may indicate one or more types of transmission and indicate one or more uplink transmitters in the duration spoofed by the preamble (such as the spoofing preamble portion). The one or more types of transmission and uplink transmitters indicated by the one or more AMP modes may include downlink only (such as broadcast transmissions), downlink and uplink backscattering transmission with one or more backscatters (such as monostatic backscatters or bi-static backscatters), downlink and uplink active transmission with one or more active transmitters, or a combination thereof, such as a combination of downlink transmission, uplink backscattering transmission and uplink active transmission. Additionally, or alternatively, the one or more AMP version dependent fields may indicate one or more channels to block, which may be accomplished by duplicating the 20 MHz spoofing preamble in frequency. For example, the one or more AMP version dependent fields may indicate a frequency shift mode (such as the channel used by bi-static backscatters). In some implementations, the one or more AMP version dependent fields may indicate the one or more Wi-Fi channel numbers (defined in IEEE 802.11 specification) to block, the one or more 20 MHz channels with certain frequency shift relative to the current 20 MHz channel to block, a wider channel bandwidth which includes the current 20 MHz channel and the one or more 20 MHz channels used by bi-static backscatters in uplink backscattering transmission to block, or a combination thereof.

In a third example, this may include setting the PHY version identifier to 0 (such as for EHT), setting the UL/DL to 0 (such as to indicate downlink), setting the PPDU type and compression mode to 0-2, and setting the punctured channel information to a validate state. The other 12 bits (B20-B24 of U-SIG-1 and B9-B15 of U-SIG-2) may be repurposed to carry other information. In a fourth example, this may include setting the PHY version identifier to 0 (such as for EHT), setting the uplink/downlink to 1 (such as to indicate downlink) and setting the PPDU type and compression mode to 2 or 3 to indicate the validate state. The other 19 bits (B20-B25 of U-SIG-1 and B3-B15 of U-SIG-2) may be repurposed to carry other information. In a fifth example, this may include setting the PHY version identifier to a value between 2 to 7 to indicate the validate state. The other 22 bits (B20-B25 of U-SIG-1 and B0-B15 of U-SIG-2) may be repurposed to carry other information. In a sixth example, this may include setting the PHY version identifier to 0 (such as for EHT) and setting B2 of U-SIG-2 to 0 (which is not its default value) to indicate the validate state. The other 22 bits (B20-B25 of U-SIG-1 and B0-B15 of U-SIG-2) or 19 bits (B20-B25 of U-SIG-1 and B3-B15 of U-SIG-2) may be repurposed to carry other information. In a seventh example, this may include setting the PHY version identifier to 0 (such as for EHT), setting the UL/DL to 0 (such as to indicate downlink) and setting the PPDU type and compression mode to a value between 0 and 2, and setting at least one of B25 of U-SIG-1 and B8 of U-SIG-2 to 0 to indicate the validate state. The other 17 bits (B20-B24 of U-SIG-1 and B3-B7 and B9-B15 of U-SIG-2) may be repurposed to carry other information. Accordingly, in some aspects the validate state examples discussed above may generally conflict with corresponding signal fields of a preamble portion of an 802.11be or an 802-11bn PPDU to define the PPDU as an AMP device PPDU.

In some aspects, the one or more fields of the at least one spoofing preamble portion may include one or more signal fields (such as U-SIG1 and U-SIG2) with the one or more signal fields including any combination of one or more multi-bit spatial reuse fields, one or more AMP device type fields, one or more quantity of downlink wireless devices or uplink devices fields, one or more indication fields of wireless device fields, or one or more communication direction fields. Further, the one or more fields of the at least one spoofing preamble portion may include one or more signaling fields (such as U-SIG1 and U-SIG2) with the one or more signaling fields including any combination of one or more PPDU format fields (to differentiate between the AMP PPDU and other future PPDU formats, such as an X PPDU, that use the same classification method that rely on not setting a validate field to its default value to indicate a validate state or setting a subfield to a validate state) or one or more PPDU format version fields (to differentiate different versions or generations of a certain PPDU family, such as an AMP PPDU family, including for example first generation AMP PPDU, second generation AMP PPDU, and so on, and such as another X PPDU family, including for example first generation X PPDU, second generation X PPDU, and so on). Moreover, the one or more fields of the at least one spoofing preamble portion may include one or more signaling fields (such as U-SIG1 and U-SIG2) with the one or more signaling fields including any combination of one or more validate fields or one or more disregard fields. That is, the design for the available bits in the U-SIG fields may depend on the option and specific example. There may be 12-42 available bits in U-SIG to convey useful information and there are several possible uses for these bits. One use may include adding one or two SR field(s). It may be just one SR field for the entire 20 MHz, applicable to both downlink and uplink, in some implementations. It may be one downlink SR field and one uplink SR field, both for the entire 20 MHz, in some implementations. The uplink SR field may be a 4-bit field. The downlink SR field may be a 2-bit or a 4-bit field.

The AMP device technologies may be in development and there are several proposals. It is possible that multiple of these proposals will be adopted and there will be different AMP device versions in some wireless networks. For example, one AMP device type may be for active transmitters for the uplink (transmission from the AMP STA to the AMP reader (such as cither an AP or smartphone). In some examples, to protect an uplink active transmission (such as a narrow band transmission without a spoofing preamble portion), an AMP AP may transmit a CTS (such as a CTS 1002, a CTS-to-self) prior to transmitting a downlink PPDU. Additionally, or alternatively, a reader may use an L-LENGTH field in the spoofing preamble portion of a preceding downlink PPDU to cover both the downlink and uplink transmission (to protect the uplink active transmission). The L-LENGTH may include a no-signal duration between the downlink and uplink transmission and the uplink transmission duration. There also may include AMP devices that use backscattering transmissions on the uplink. These available bits can be used to indicate which AMP mode or device type is being used. Also, there may be future generations of AMP devices. The available bits can be used to indicate a future generation of AMP device. This may include an indication of the “downlink to the AMP tag” and “uplink from the AMP tag” fields. As one example, this may include using 1 bit to indicate the existence of at least one such field, and using another 1 bit (or another multiple bits) to indicate the existence of a second (and a third, fourth, and so on) such field. In a second example, this may include using a 2-3 bit field to indicate the number of such fields (such as 0, 1, 2, . . . ). This may include using additional UL/DL field(s) for the second and beyond such fields to identify the UL/DL direction of each such field. As another example, this may include using an UL/DL bitmap, where each bit is used to identify the UL/DL direction of one such field. In a third example, this may include using 1 bit to indicate the existence of at least one “downlink to the AMP tag” field, and using another 1 bit to indicate the existence of at least one “uplink from the tag” field.

In some implementations, the unused available bits can be used to signal any combination of one or more validate fields or one or more disregard fields. Each validate field has a default value. If at least one validate fields is not set to its default value, it is a validate state. In this case, a UHR STA or AMP device may terminate receiver processing, defer for the duration of the PPDU (such as according to the TXOP) and report the information from at least the version independent fields within the RXVECTOR. Each disregard field may have a default value. The disregard fields may be set to certain values to lower the PAPR of the one or more signaling field (such as U-SIG1 and U-SIG2). Any device may bypass the processing of the disregard fields, meaning they would not terminate receiver processing based on the values in the disregard fields.

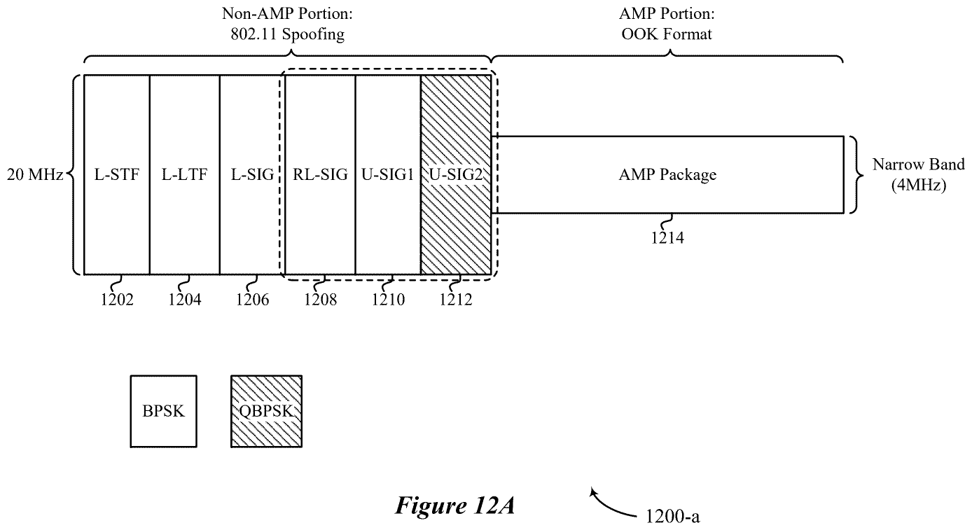

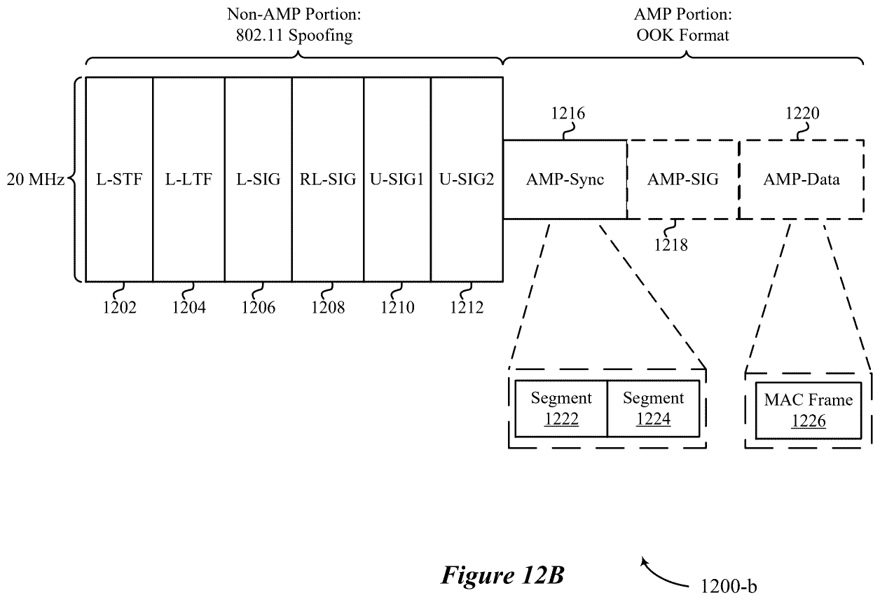

FIG. 12A shows an example of a PPDU configuration 1200-a that supports PPDU for AMP devices, such as a spoofing preamble configuration. The PPDU configuration 1200-a may implement aspects of wireless communication network 100, aspects of PPDU 200, aspects of frequency diagram 300, or aspects of wireless communications system 400. Aspects of the PPDU configuration 1200-a may be implemented at or implemented by wireless device(s), which may be examples of the corresponding device(s) described herein. The wireless device(s) may be an example of an AMP device (such as a UE or a STA) or a reader (such as a UE, a STA, an AP, or a network entity) communicating with the AMP device.

As discussed above, aspects of the techniques described herein may leverage field(s) within a spoofing preamble portion, at least one downlink data portion, or in both portions, to define or otherwise differentiate an AMP device PPDU from a non-AMP device PPDU. The AMP device (such as a wireless device) may receive or otherwise obtain (and the reader may transmit or otherwise output) a PPDU during a TxOP that includes at least one spoofing preamble portion, at least one downlink data portion, and at least one uplink data portion. In some scenarios, the AMP device PPDU also includes one or more excitation signals. The excitation signal portion(s) may include power signals (such as CW) configured to passively power the wireless device. Additionally, or alternatively, the excitation signal portion(s) may be used by the wireless device to encode uplink information and perform an uplink transmission during at least one uplink data portion. The AMP device may transmit or otherwise output (and the reader may receive or otherwise obtain) an uplink signal during the TxOP according to field(s) that define the PPDU as an AMP device PPDU. Accordingly, various field(s) or other aspects of the at least one spoofing preamble portion, the at least one downlink data portion, or both portions may be set to values or use other parameters that define the PPDU as an AMP device PPDU rather than a non-AMP device PPDU.

The PPDU configuration 1200-a of FIG. 12A illustrates an example where the at least one spoofing preamble portion includes one or more SIG fields that are set to values that define the PPDU as the AMP device PPDU. In particular, the PPDU configuration 1200-a illustrates an example that uses two BPSK-mark symbols followed by a quadrature phase shift keying (QBPSK)-mark symbol, where BPSK-mark1 is the RL-SIG field and the BPSK-mark2 and QBPSK-mark3 are the 2-symbol U-SIG field. The at least one spoofing preamble portion may include a L-STF 1202, a L-LTF 1204, a L-SIG 1206, a RL-SIG 1208, a U-SIG1 1210, and a U-SIG2 1212. In some aspects, at least one of the U-SIG1 1210 or the U-SIG2 1212 are modulated using QBPSK modulation (such as U-SIG2 1212, in this example) to define the PPDU as the AMP PPDU. The U-SIG2 1212 may be followed by an AMP package 1214 (such as the AMP-specific downlink and excitation fields).

That is, in this example the L_LEN % 3 (such as the length parameter) is equal to 0 (such as set to a value that is a multiple of three). When the L_LEN % 3=0 and the second symbol after the RL-SIG 1208 is QBPSK modulated this may be a classification for the ER preamble as defined in the 36.12.7 subclause in the 802.11be specification draft 7.0. That is, the AMP device may expect four symbols for the U-SIG fields in an ER preamble, or two symbols for the U-SIG field in an AMP PPDU. The 802.11be STAs may terminate the receive processing, try to decode the four-symbol U-SIG (four symbols after RL-SIG) and report the values of the version independent fields to the MAC layer. Since there are two U-SIG symbols here, the decoding would fail but early termination is still achieved. The 802.11be STAs do not get the information carried in the version independent fields but could still defer associated with the L_LEN and the detected bandwidth of the signal. The 802.11bn and beyond STAs will detect if the U-SIG field has two or four symbols. In the case of two symbols, this may indicate that this is an AMP device PPDU so the STAs may terminate the receive processing and report the values of the version independent fields to the MAC layer. The STAs may check to determine if the third or fourth symbols are wideband OFDM or narrowband symbols associated with the power or power spectral density (PSD) profile of the symbols or signal fields after the second symbol after RL-SIG to decide if the U-SIG field has two or four symbols. Additionally, or alternatively, the STAs may check whether the contents of the first two U-SIG symbols are identical, after de-interleaving according to the four-symbol U-SIG in the ER preamble. The 42 bits (B0-B25 of U-SIG-1 and B0-B15 of U-SIG-2) may be used to carry other information, as described above.

FIG. 12B shows an example of a PPDU configuration 1200-b that supports multi-layer signaling for AMP devices. The PPDU configuration 1200-b may implement aspects of wireless communication network 100, aspects of PPDU 200, aspects of the frequency diagram 300, or aspects of the wireless communications system 400. Aspects of the PPDU configuration 1200-b may be implemented at or implemented by wireless device(s), which may be examples of the corresponding device(s) described herein. The wireless device(s) may be an example of an AMP device (such as a UE or a STA) or a reader (such as a UE, a STA, an AP, or a network entity) communicating with the AMP device. The PPDU configuration 1200-b may illustrate a configuration of an AMP downlink PPDU. An AMP downlink PPDU may refer to a PPDU transmitted from an AP to a STA that includes one or more excitation signals in accordance with an AMP communication format (such as where one or both of the AP or STA are, or are associated with, an AMP device).

Some aspects of the techniques described herein may leverage field(s) within a spoofing preamble portion, at least one downlink data portion, or in both portions, to define or otherwise differentiate an AMP device PPDU from a non-AMP device PPDU. For example, an AMP device (such as a wireless device) may receive or otherwise obtain (and the reader may transmit or otherwise output) the AMP downlink PPDU during a TxOP that includes at least one spoofing preamble portion, at least one downlink data portion, and at least one uplink data portion. The AMP device may transmit or otherwise output (and the reader may receive or otherwise obtain) an uplink signal during the TxOP according to field(s) that define the PPDU as an AMP downlink PPDU. Accordingly, various field(s) or other aspects of the at least one spoofing preamble portion, the at least one downlink data portion, or both portions may be set to values or use other parameters that define the PPDU as an AMP downlink PPDU rather than a non-AMP downlink PPDU. The PPDU configuration 1200-b may include a spoofing preamble portion that includes the L-STF 1202, the L-LTF 1204, the L-SIG 1206, the RL-SIG 1208, the U-SIG1 1210, and the U-SIG2 1212. The U-SIG2 1212 may be followed by an AMP package 1214 (as illustrated in FIG. 12B), which may include the AMP-specific downlink and excitation fields. The AMP package 1214 may include an AMP-Sync field 1216, an AMP-SIG field 1218, an AMP-data field 1220, or any combination thereof.

In some examples, an AP (such as an AP 102) may transmit downlink transmissions to different types of non-backscatter devices. A backscatter device may be a wireless device that relies on backscatter communications on a backwards link by harvesting energy of a wireless signal received via a forward link and reflecting or refracting (such as backscattering) the wireless signal back to a source (such as the AP) after encoding uplink data onto the reflected or refracted signal. A non-backscatter device may be any wireless device that may not reflect or refract the received wireless signal back via a backward link (such as a non-backscatter device may generate and transmit its own uplink signals). For example, a non-backscatter device may include an active transmitter non-AP AMP STA (such as an active transmitter device) that may be capable of receiving (only) AMP downlink PPDUs and supports active transmission of AMP uplink PPDUs. An active transmitter device may be a wireless device that harvests energy and performs active transmission using the harvested energy to generate a waveform in the uplink.

Additionally, or alternatively, a non-backscatter device may include an AMP-enabled non-AP STA (such as an AMP-enabled device, a non-high throughput (HT) STA, an HT, a high efficiency (HE) STA, Extremely high throughput (EHT) STA, Ultra High Reliability (UHR) STA, or other non-AP STA that may be capable of receiving AMP downlink PPDUs). AMP-enabled devices may be wireless devices that receive AMP downlink PPDUs and wake-up one or more radios to begin performing uplink access (such as transmitting non-AMP uplink PPDUs) in response to receiving the AMP downlink PPDU. In some examples, an AMP-enabled device may receive an AMP downlink PPDU and may wake-up a main radio of the AMP-enabled device to begin performing uplink access. Additionally, or alternatively, an AMP-enabled device may wake up one or more auxiliary radios in response to receiving an AMP downlink PPDU. For example, the AMP-enabled device may receive the AMP downlink PPDU using a first auxiliary radio, and in response to receiving the AMP downlink PPDU, the AMP-enabled device may wake-up a second auxiliary radio (such as to perform uplink access).

In some examples, because each type of non-backscatter device may perform different operations in response to receiving an AMP downlink PPDU (such as transmitting AMP uplink PPDUs, waking-up a main radio, or waking up an auxiliary radio), a MAC frame format for each type of non-backscatter device may be different. Accordingly, in some networks, wireless devices may process the entire MAC frame to determine whether the AMP downlink PPDU is intended for them (or another wireless device or other type of device), which may unduly use energy and processing resources of the wireless device. A wireless device may benefit (at least in terms of power savings or energy consumption) by knowing earlier (such as before processing the entire PPDU or MAC frame) if a downlink transmission is intended for itself so that the wireless device may terminate receive processing for unintended AMP downlink PPDUs. Additionally, or alternatively, within a subtype of device, there may be different types of MAC frames, such as wake-up frames, acknowledgement frames, trigger frames, or data frames, and it may be beneficial (at least in terms of power savings or energy consumption) for a wireless device to identify which type of MAC frame may follow an initial part of the downlink transmission.

The techniques described herein may enable early differentiation between different types of non-backscatter devices. For example, a wireless device may receive a first portion of a AMP downlink PPDU (such as the AMP-Sync field 1216, the AMP-SIG field 1218, the AMP-data field 1220, or a combination thereof) that indicates the type of STA to which the AMP downlink PPDU is intended, where the type is one of a first type of non-AP STA (such as an active transmitter device) or a second type of non-AP STA (such as an AMP-enabled device). As described herein, an AMP downlink PPDU may be “intended” for a particular type of STA when the AMP downlink PPDU is configured, formatted, or transmitted to be received and processed by a STA with that corresponding type. An AMP downlink PPDU intended for a particular type of STA may include signaling, data, or frame formats that are designed for or compatible with the operational characteristics and capabilities of the type of STA to which the AMP downlink PPDU is addressed. The wireless device may selectively receive at least a second portion of the AMP downlink PPDU (such as the AMP-data field 1220 or any subsequent fields or frames included in the AMP downlink PPDU) in accordance with whether the type of the wireless device is the type of STA to which the AMP downlink PPDU is intended. For example, if the type of the wireless device matches or corresponds to the type of STA indicated in the first portion, the wireless device may receive at least a second portion of the AMP downlink PPDU and continue processing the AMP downlink PPDU. If the type of the wireless device does not match or correspond to the type of STA indicated in the first portion, the wireless device may refrain from receiving the second portion of the AMP downlink PPDU and may cease processing the AMP downlink PPDU. Additionally, or alternatively, the first portion of the AMP downlink PPDU may indicate a MAC frame type of one or more MAC frames included in the AMP-data field 1220. In some implementations, the frame type of one or more frames included in the AMP downlink PPDU may indicate the type of STA to which the AMP downlink PPDU is intended.

In some examples, a MAC frame header included in a MAC frame of the AMP-data field 1220 may indicate the type of STA to which the AMP downlink PPDU is intended, the frame type of the MAC frame, or both. In such examples, the AMP package 1214 may include the AMP-Sync field 1216 and the AMP-data field 1220 (and may not include the AMP-SIG field 1218). The MAC frame header may include one or more Frame Control fields indicating what type of STA to which the AMP downlink PPDU is intended. The one or more fields may include a Frame Control extension subfield that indicates what type of frame the MAC frame is (such as an acknowledgement frame, an AMP trigger frame, a data frame, a wake-up radio (WUR) frame, or a beacon frame).

Additionally, or alternatively, the AMP-Sync field 1216 may indicate the type of STA to which the AMP downlink PPDU is intended. In such examples, the AMP package 1214 may include the AMP-Sync field 1216 and the AMP-data field 1220 (and may not include the AMP-SIG field 1218). The AMP-Sync field 1216 may include two segments (or portions), segment 1222 and segment 1224, as part of a segment structure for downlink transmission to non-backscatter devices. Segment 1222 may include a chip sequence that may support detection and timing alignment of the AMP-Sync field 1216, and the chip sequence may indicate a data rate of the AMP-data field 1220. For example, the segment 1222 may indicate, via a chip sequence W or W, that the AMP-data field 1220 has a 250 kilobit per second (kbps) data rate or a 1 Megabit per second (Mbps) data rate. The segment 1224 may indicate the type of non-backscatter STA to which the AMP downlink PPDU is intended. For example, the segment 1224 may use a first binary chip sequence, S1, to indicate that the intended STA type is an AMP-enabled device or a second binary chip sequence, S2, to indicate that the intended (or addressed) STA type is an active transmitter device. By way of example, a first length-4 chip sequence S1=[0 1 1 1] may indicate that the intended STA type is an AMP-enabled device and a second length-4 chip sequence S2=[1 1 1 0] may indicate that the intended STA type is an active transmitter device.

In some implementations, the segment 1224 may indicate the MAC frame type of one or more MAC frames in the AMP downlink PPDU (such as if the intended STA type is an active transmitter device). For example, the segment 1224 may include different binary sequences to indicate which type of non-backscatter STA the AMP downlink PPDU is intended for and what types of frames are included in the AMP-data field 1220. In an example, a first length-5 chip sequence S1=[1 0 0 0 1] may indicate that the AMP downlink PPDU may be addressed to a wake-up receiver of an AMP-enabled device, a second length-5 chip sequence S2=[0 1 1 1 1] may indicate an ACK frame in an AMP downlink PPDU addressed to an active transmitter device, and a third length-5 chip sequence S3=[1 1 1 1 0] may indicate a trigger frame in an AMP downlink PPDU addressed to an active transmitter device.

Additionally, or alternatively, the AMP-SIG field 1218 or a service field in the AMP-data field 1220 may indicate the type of non-backscatter STA to which the AMP downlink PPDU is intended. For example, the AMP-SIG field 1218 or the service field in the AMP-data field 1220 may include information that differentiates between the types of STA, information that differentiates between the MAC frame types, or information that indicates whether the AMP downlink PPDU includes data (such as in the AMP-data field 1220) for the wireless device or another wireless device. The second portion of the AMP downlink PPDU may indicate whether the AMP downlink PPDU includes data addressed to the wireless device. The wireless device may selectively receive at least a third portion (such as the AMP-data field 1220) of the AMP downlink PPDU based on whether the AMP downlink PPDU includes data addressed to the wireless device. For example, if the data in the AMP-data field 1220 is intended for the wireless device, the wireless device may continue to receive and process the AMP downlink PPDU. Additionally, or alternatively, the second portion may indicate a STA address (such as an address of the wireless device or some other wireless device), and the wireless device may selectively receive at least the third portion of the AMP downlink PPDU based on the address of the wireless device corresponding to the STA address indicated by the second portion. Conversely, if the address of the wireless device does not correspond to the STA address, the wireless device my refrain from receiving at least the third portion of the AMP downlink PPDU.

In some examples, if the information in the AMP-SIG field 1218 or in the service field in the AMP-data field 1220 indicates that the AMP downlink PPDU includes an acknowledgement frame (such as in response to an uplink message previously sent by the wireless device), the AMP-data field 1220 may include the acknowledgement frame. In some other examples, the information itself may indicate the acknowledgement, and the AMP downlink PPDU may not include the AMP-data field 1220. A size of the AMP-SIG field 1218 or the service field in the AMP-data field 1220 (such as a byte size or length) may be a integer quantity of octets (such as to support byte alignment in receiver processing at the wireless device). In some implementations where the AMP-SIG field 1218 or the service field in the AMP-data field 1220 indicates the type of STA to which the AMP downlink PPDU is intended, the AMP package 1214 may include the AMP-Sync field 1216, the AMP-SIG field 1218, and the AMP-data field 1220.

In some implementations, the size of the AMP-SIG field 1218 or the service field in the AMP-data field 1220 may be an integer number of octets for ease of byte aligned processing. The AMP-SIG field 1218 or the service field in the AMP-data field 1220 may include one or more version independent fields and one or more version dependent fields. Version independent fields may be fields that maintain the same structure and meaning across different generations or versions of AMP PPDUs, while version dependent fields may be fields whose structure, interpretation, or functionality may change based on a specific AMP version being used (such as by the wireless device). For example, the AMP-SIG field 1218 or the service field in the AMP-data field 1220 may include an AMP version field (such as 1 or 2 bits wide) that may differentiate different generations of AMP PPDUs, where the field structure of version dependent fields may be in accordance with the AMP version. Additionally, or alternatively, the AMP-SIG field 1218 may include an AMP-SIG length field that may indicate the length (such as in the unit of octets or based on a set of discrete values) of the AMP-SIG field. The AMP-SIG length field may differentiate different generations of AMP PPDUs, where the length and field structure of the remaining of the AMP-SIG field may be in accordance with the AMP-SIG length. Additionally, the AMP-SIG field 1218 or the service field in the AMP-data field 1220 may include a STA type field (such as a 1 bit wide field) that may differentiate or indicate the type of STA (such as an AMP-enabled device or an active transmitter) to which the AMP downlink PPDU is intended.

The AMP-SIG field 1218 or the service field in the AMP-data field 1220 may include an AMP AP identifier field (such as a 6 bit wide field) that may identify an AMP AP. For example, the AMP AP identifier field may indicate a BSS color or a subset of bits from an identification (such as a quantity of least significant bits of the identification) of the AMP AP. In some examples, the wireless device may terminate receiver processing of the AMP downlink PPDU based on the AMP AP identifier field. For example, the wireless device may terminate processing the AMP downlink PPDU if the wireless device determines that it is not intended to receive transmissions from the identified AMP AP. The AMP-SIG field 1218 or the service field in the AMP-data field 1220 may include a TxOP field (such as a 7 bit wide field) that may account for a total duration of the AMP package 1214 of the AMP downlink PPDU, one or more possible uplink PPDUs (such as if the AMP downlink PPDU schedules one or more uplink PPDUs), and a gap period duration between the AMP downlink PPDU and the one or more uplink PPDUs (such as SIFS=16 us).

In some implementations, the AMP-SIG field 1218 or the service field in the AMP-data field 1220 may include a length field that may indicate a length of the AMP-data field 1220. The length may be in octets or selected from among a quantity of discrete sizes. In some examples, the length of the AMP-data field 1220 may be indicated or derived in from the MAC header of each frame included in the AMP-data field 1220. Additionally, or alternatively, the AMP-SIG field 1218 or the service field in the AMP-data field 1220 may include one or more fields that indicate a quantity of reserved bits, a quantity of error check bits (such as for performing error checks on any of the fields described herein), or any combination thereof. The quantity of error check bits may include a 1-bit parity bit or an N-bit cyclic redundancy check (CRC). Any of the STA type, AMP AP identifier, TxOP, AMP-data field length, quantity of reserved bits, or quantity of error check bit fields may be version independent, version dependent, or a combination thereof (such as the STA type field may be version dependent while the AMP AP identifier field may be version independent).

By way of example, the AMP-SIG field 1218 or the service field in the AMP-data field 1220 may include 8 bits for multiple different fields. A first bit may be for a version independent field that may differentiate different versions of AMP communication, and the field structure of the version dependent fields (or remaining 7 bits) may be based on the AMP version. For example, the AMP-SIG field 1218 or the service field in the AMP-data field 1220 may include a second bit to indicate whether the type of the STA the AMP downlink PPDU is intended for is for an active transmitter device or for an AMP-enabled device. The remaining 6 bits may indicate an AMP AP identifier, such as a subset of bits from the identification of the AMP AP or a BSS color of the AMP AP. By way of another example, the AMP-SIG field 1218 or the service field in the AMP-data field 1220 may include 8 bits for multiple different fields. A first bit may be for a version independent field that may differentiate the length of the AMP-SIG field 1218 or the service field in the AMP-data field 1220, such as using one value (such as value 0) to indicate the size of the AMP-SIG field 1218 is 1 octet, and the field structure of the version dependent fields (or remaining 7 bits) may be based on the AMP-SIG length or the service field length. For example, the AMP-SIG field 1218 or the service field in the AMP-data field 1220 may include a second bit to indicate whether the type of the STA the AMP downlink PPDU is intended for is for an active transmitter device or for an AMP-enabled device. The remaining 6 bits may indicate an AMP AP identifier, such as a subset of bits from the identification of the AMP AP or a BSS color of the AMP AP.

The AMP-SIG field 1218 or the service field in the AMP-data field 1220 may include information based on the type of STA to which the AMP downlink PPDU is intended. For example, the AMP-SIG field 1218 or the service field in the AMP-data field 1220 may include a partial time synchronization function (TSF) that may support the wireless device in maintaining time synchronization and compensation for clock drift. Partial TSF may be particularly beneficial for AMP-enabled devices, as it may provide additional TSF bits without changing existing WUR frame formats. The AMP-SIG field 1218 or the service field in the AMP-data field 1220 may further include a set of parameters negotiated between the wireless device and an AP in advance, such as when AMP frames are individually addressed (and before receipt of the AMP downlink PPDU). The set of parameters may include wake-up schedules of AMP STAs. The AMP-SIG field 1218 or the service field in the AMP-data field 1220 also may include a length field of the AMP downlink PPDU for respective types of AMP frames to provide a relatively early indication of the overall size of the AMP downlink PPDU.

Additionally, or alternatively, the AMP-SIG field 1218 or the service field in the AMP-data field 1220 may differentiate both STA type and MAC frame type. For example, the AMP-SIG field 1218 or the service field in the AMP-data field 1220 may include a STA and frame type field (such as a 2 bit wide field) that may differentiate between at least an AMP-enabled device, an acknowledgement frame to an active transmitter device, or an AMP trigger frame to an active transmitter device. The AMP-SIG field 1218 or the service field in the AMP-data field 1220 may include an AMP AP identifier field that may provide a full AMP AP identification (such as to avoid confusion between multiple AMP APs that may have overlapping or similar identifiers). In some examples, the wireless device may receive the one or more MAC frames in the AMP downlink PPDU when the wireless device corresponds to the type of STA to which the AMP downlink PPDU is intended.

In some implementations, the AMP-SIG field 1218 or the service field in the AMP-data field 1220 may include one or more fields based on the AMP version, STA type (such as active transmitter device only), and frame type (such as acknowledgement frame or AMP trigger frame). For example, the AMP-SIG field 1218 or the service field in the AMP-data field 1220 may include a STA identifier field that may identify the receiving AMP device (such as the wireless device) and the STA identifier field may be based on at least one of the AMP AP identifier, the STA type and the frame type field. For example, if the STA and frame type field indicates an acknowledgement frame, the STA identifier may include a full STA identification (such as 12 or 16 bits) or a partial STA identification (such as a subset of bits of STA's MAC address). If the STA and frame type field indicates an AMP trigger frame, the STA identifier field may include a subset of bits from a cached address of the STA or wireless device (such as 11 least significant bits from the cached address). In some examples, the AMP-SIG field 1218 may include a length field for the AMP-data field 1220 that may indicate different MAC frame types included in the AMP-data field 1220. For example, a first length (such as size=0) of the AMP-data field 1220 may indicate an acknowledgement carried in the AMP-SIG field 1218 but not in the AMP-data field 1220 and a second length (such as size >0) of the AMP-data field 1220 may indicate an AMP trigger frame. If the length of the AMP-data field indicated in the AMP-SIG field 1218 is zero, the AMP downlink PPDU may not include the AMP-data field 1220.

In some examples, the MAC header of a first MAC frame 1226 or a first MAC frame 1226 of one or more MAC frames within the AMP downlink PPDU (such as in the AMP-data field 1220) may indicate the type of STA to which the AMP downlink PPDU is intended. The first MAC frame 1226 may be the first or initial MAC frame included in the AMP-data field 1220 of the AMP downlink PPDU. For example, the first MAC frame 1226 in the AMP-data field 1220 may include information that differentiates between the STA types to which the AMP downlink PPDU is intended, MAC frame types included in the AMP downlink PPDU, or both. In some implementations, the information may indicate whether the AMP downlink PPDU includes data (such as in the AMP-data field 1220) for the wireless device or another wireless device. Additionally, or alternatively, the first MAC frame 1226 may indicate a STA address, and the wireless device may selectively receive subsequent portions (such as at least a third portion) of the AMP downlink PPDU based on the address of the wireless device corresponding to the indicated STA address. A size of the AMP-data field 1220 (such as a byte size or length) may be an integer quantity of octets (for byte alignment in receiver processing at the wireless device). In some implementations where the AMP-data field 1220 indicates the type of STA to which the AMP downlink PPDU is intended, the AMP package 1214 may include the AMP-Sync field 1216, the AMP-SIG field 1218, and the AMP-data field 1220.

In some implementations, the first MAC frame 1226 may include one or more version independent fields, one or more version dependent fields, or a combination thereof. For example, the first MAC frame 1226 may include an AMP version field (such as 1 or 2 bits wide) that may differentiate different generations of AMP PPDU, where the field structure of version dependent fields may be in accordance with the AMP version. Additionally, the first MAC frame 1226 may include a STA type field (such as a 1-bit field) that may differentiate or indicate the type of STA to which the AMP downlink PPDU is intended. The first MAC frame 1226 also may include an AMP AP identifier field (such as a 6-bit field containing a BSS color of the AMP AP) that may identify the AMP AP. The first MAC frame 1226 may include a TxOP field (such as a 7 bit wide field) that may account for a total duration of the AMP package 1214 of the AMP downlink PPDU, one or more possible uplink PPDUs (such as if the AMP downlink PPDU schedules one or more uplink PPDUs), and a gap period duration between the AMP downlink PPDU and the one or more uplink PPDUs (such as SIFS=16 us). In some implementations, the first MAC frame 1226 may include a length field that may indicate a length of the AMP-data field 1220. The length may be in octets or selected from among a quantity of discrete sizes. Additionally, or alternatively, the first MAC frame 1226 may include one or more fields that indicate a quantity of reserved bits, a quantity of error check bits (such as for performing error checks on any of the fields described herein), or any combination thereof. The quantity of error check bits may include a 1-bit parity bit or an N-bit cyclic redundancy check. Any of the STA type, AMP AP identifier, TxOP, AMP-data field length, quantity of reserved bits, or quantity of error check bit fields may be version independent, version dependent, or a combination thereof.

In an example, the first MAC frame 1226 may include 8 bits for multiple different fields. A first bit may be for a version independent field that may differentiate different versions of AMP communication, and the field structure of the version dependent fields or remaining 7 bits may be based on the AMP version. For example, the first MAC frame 1226 may include a second bit to indicate whether the type of the STA to which the AMP downlink PPDU is intended is for an active transmitter device or for an AMP-enabled device. The remaining 6 bits may indicate an AMP AP identifier, such as a subset of bits from the identification number of the AMP AP or a BSS color of the AMP AP. By way of another example, the first MAC frame 1226 or a header of the first MAC frame 1226 may include 8 bits for multiple different fields. A first bit may be for a version independent field that may differentiate the length of the first MAC frame 1226, such as using one value (such as value 0) to indicate the size of the first MAC frame 1226 is 1 octet, and the field structure of the version dependent fields (or remaining 7 bits) may be based on the first MAC frame length. For example, the first MAC frame 1226 may include a second bit to indicate whether the type of the STA the AMP downlink PPDU is intended for is for an active transmitter device or for an AMP-enabled device. The remaining 6 bits may indicate an AMP AP identifier, such as a subset of bits from the identification of the AMP AP or a BSS color of the AMP AP.

The first MAC frame 1226 may include information based on the type of STA to which the AMP downlink PPDU is intended. For example, the first MAC frame 1226 may include a partial time synchronization function (TSF) that may support the wireless device in maintaining time synchronization and compensation for clock drift. Partial TSF may be particularly beneficial for AMP-enabled devices, as it may provide additional TSF bits without changing existing WUR frame formats. The first MAC frame 1226 may further include a set of parameters negotiated between the wireless device and an AP in advance, such as when AMP frames are individually addressed (and before receipt of the AMP downlink PPDU). The set of parameters may include wake-up schedules of AMP STAs. The first MAC frame 1226 also may include a length field of the AMP downlink PPDU for respective types of AMP frames to provide a relatively early indication of the overall size of the AMP downlink PPDU.

The wireless device may determine whether the first portion includes the AMP-SIG field 1218 or the first MAC frame 1226 in accordance with whether a frame check sequence (FCS) associated with the AMP downlink PPDU includes information associated with the initial MAC frame. For example, if the FCS of a MAC frame in the AMP-data field 1220 (such as a main MAC frame) protects or includes information associated with the first portion, the wireless device may consider the first portion part of the MAC layer (such as the initial MAC frame). If the FCS does not protect or include information associated with the first portion, the wireless device may consider the first portion as part of the PHY layer (such as the AMP-SIG field 1218). The FCS protection may enable the wireless device to differentiate between PHY layer signaling and MAC layer signaling within the AMP downlink PPDU.

In some examples, it may be desirable to increase the reliability (such as decoding reliability) of the AMP-SIG field 1218, the service field of the AMP-data field 1220, or the first MAC frame 1226 relative to the remaining MAC frames in the AMP-data field 1220. For example, one or more errors in the AMP-SIG field 1218, the service field of the AMP-data field 1220, or the first MAC frame 1226 may result in the wireless device erroneously stopping the processing of the AMP downlink PPDU (such as if the wireless device erroneously determines that it does not correspond to the type of STA to which the AMP downlink PPDU is intended). In accordance with the techniques described herein, the first MAC frame 1226 may include a 16 bit MAC frame check sequence (FCS) and the AMP-SIG field 1218 or the service field of the AMP-data field 1220 may use Manchester coding to increase the error detection and correction capability of the wireless device of the AMP downlink PPDU. In some implementations, the AMP-SIG field 1218, the service field of the AMP-data field 1220, or the first MAC frame 1226 may use an effective data rate lower than a data rate of the remaining of the AMP-data field 1220 to improve the reliability of the AMP downlink PPDU. For example, the AMP-SIG field 1218 or the first MAC frame 1226 may utilize Mx repetition (such as M=2, 3, 4) or forward error correction codes (such as convolutional codes) to implement an effectively lower data rate compared to the AMP-data field 1220. Additionally, or alternatively, the AMP-SIG field 1218, the service field of the AMP-data field 1220, or the first MAC frame 1226 may use chip-wise repetition to use Mx chip duration compared to the remainder of the AMP-data field 1220 (such as if the AMP-SIG field 1218 uses the same chip duration as the AMP-data field 1220).

In some examples, the AMP-SIG field 1218 or the service field of the AMP-data field 1220 may not use any parity bit or CRC. In some examples, the AMP-SIG field 1218, the service field of the AMP-data field 1220, or the first MAC frame 1226 may use a relatively long CRC. For example, the AMP-SIG field 1218, the service field of the AMP-data field 1220, or the first MAC frame 1226 may include an N-bit CRC, where N=8 or 16. In some implementations, the AMP-SIG field 1218, the service field of the AMP-data field 1220, or the portion of the AMP-data field 1220 that includes the first MAC frame 1226 may use a relatively larger chip duration compared to the AMP-data field 1220. For example, the AMP-SIG field 1218, the service field of the AMP-data field 1220, or the portion of the AMP-data field 1220 that includes the first MAC frame 1226 may use a 4 us or 8 us chip duration if the data rate in the AMP-data field is 250 kbps. By way of further example, the AMP-SIG field 1218, the service field of the AMP-data field 1220 or the portion of the AMP-data field 1220 that includes the first MAC frame 1226 may use a 1 us or 2 us chip duration if the data rate in the AMP-data field 1220 is 1 Mbps. In some examples, the AMP downlink PPDU may indicate the type of STA to which the AMP downlink PPDU is intended using any combination of the techniques described herein. For example, the AMP downlink PPDU may include a MAC frame header, the AMP-Sync field 1216, the AMP-SIG field 1218, the service field in the AMP-data field 1220, and the first MAC frame 1226 that may, individually or in any combination, indicate the type of STA to which the AMP downlink PPDU is intended.

In some examples, the techniques described herein may enable wireless devices (such as STAs) to perform early differentiation (such as before decoding, processing, or receiving a complete AMP downlink PPDU) between types of non-backscatter AMP devices, which may reduce energy consumption and improve processing efficiency. Additionally, processing overhead associated with decoding entire MAC frames may be reduced in accordance with the wireless device receiving early indication information in the AMP-Sync field 1216, the AMP-SIG field 1218, the service field of the AMP-Data field 1220, or the first MAC frame 1226 in the AMP-data field 1220 (as the wireless device may terminate processing early rather than decoding all PPDU contents when the transmission is not intended or addressed to the wireless device). Thus, the multi-layer signaling configuration that includes an AMP downlink PPDU that may differentiate between types of STAs may support reduced power consumption, reduced processing overhead, and increased energy efficiency for AMP devices, among other benefits.

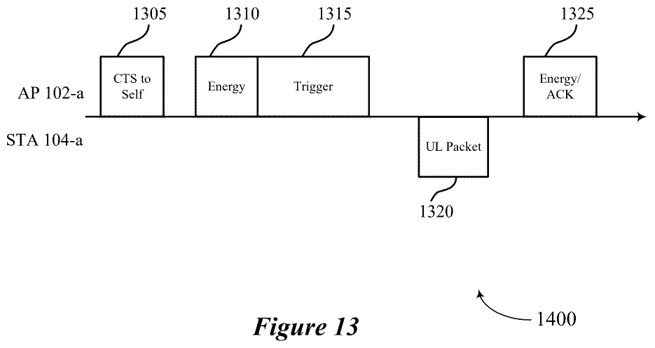

FIG. 13 shows an example of a signaling diagram 1300 that supports multi-layer signaling for AMP devices. The signaling diagram 1300 may implement aspects of the wireless communication network 100, aspects of the PPDU 200, aspects of the frequency diagram 300, or aspects of the wireless communications system 400. Aspects of the signaling diagram 1300 may be implemented at or implemented by one or more wireless devices, which may be examples of the corresponding devices described herein. For example, the AP 102-a may be an example of one or more aspects of an AP 102 as described herein, including with reference to FIG. 1. The STA 104-a may be an example of one or more aspects of a STA 104 as described herein, including with reference to FIG. 1. In some implementations, the STA 104-a may be an AMP device (such as a device that includes a relatively low power receiver and a relatively low power active transmitter that generates an uplink signal) or a backscattering device (such as a device that may modulate existing radio-frequency signals to transmit uplink data). The AP 102-a may initiate signaling in the signaling diagram 1300 with a CTS-to-self 1305 that may signal to other devices, such as the STA 104-a, that the channel is being reserved for a period of time. The CTS-to-self 1305 may be followed by a TxOP that includes a trigger frame 1315 from the AP 102-a, one or more UL transmissions 1320 from the STA 104-a, and a response signal 1325 (such as an acknowledgement signal) from the AP 102-a.

In some other wireless communications systems, UL transmissions by a STA 104 (such as an AMP device) may be triggered by an AP 102. For example, the AP 102 may transmit the trigger frame 1315 that indicates for a STA 104 to communicate with the AP 102. However, in some implementations, the STA 104 may not have sufficient energy (stored or otherwise harvested from the trigger frame 1315) to transmit UL transmissions. The techniques described herein may enable the AP 102-a to increase a likelihood that the STA 104-a stores a threshold quantity of energy to respond to the trigger frame 1315 by transmitting an excitation signal 1310 (also known as an energizing signal) associated with the trigger frame 1315. In some implementations, the AP 102-a may transmit the excitation signal 1310 and the trigger frame 1315 over the same PPDUs or over different PPDUs. For example, the AP 102-a may transmit one or more PPDUs that include the excitation signal 1310 and the trigger frame 1315, and the excitation signal 1310 may include one or more power signals configured to passively power one or more STAs 104 (such as the STA 104-a). The STA 104-a may harvest energy from the excitation signal 1310, which may enable the STA 104-a to respond to the trigger frame 1315 as well as to subsequent communications with the AP 102-a. The AP 102-a may monitor for one or more UL transmissions 1320 from the STA 104-a in accordance with the excitation signal 1310 and the trigger frame 1315.

Although the AP 102-a is described as transmitting the excitation signal 1310, it may be understood that a second wireless device (such as a second AP 102 or any other energizer device that is capable of transmitting excitation signals) may transmit the excitation signal 1310 and the AP 102-a may transmit the trigger frame 1315. That is, the AP 102-a may coordinate with the second wireless device to schedule transmission of excitation signals to the STA 104-a. For example, the STA 104-a may receive a first set of one or more PPDUs that includes the trigger frame 1315 from the AP 102-a and may receive a second set of one or more PPDUs that includes the excitation signal 1310 from the second wireless device.

In some implementations, if the excitation signal 1310 and the trigger frame 1315 are part of the same PPDU, there may be no short interframe space (SIFS) between the excitation signal 1310 and the trigger frame 1315. If the excitation signal 1310 and the trigger frame 1315 are in different PPDUs, one or more SIFS may occur between and end of the excitation signal 1310 and a beginning of the trigger frame 1315. If the STA 104-a is a backscattering device, a carrier source may implement one or more aspects of the second wireless device in providing the excitation signals. That is, the source of the energizing carrier wave (such as the excitation signals) may be the same as the source of the trigger frame 1315. For example, the STA 104-a may harvest energy from the trigger frame 1315 transmission and may transmit one or more UL transmissions 1320 based on the harvested energy.

In some implementations, the AP 102-a may determine the information included in the trigger frame 1315 in association with one or more conditions. For example, the AP 102-a may include information in association with different network configurations (such as whether the AP 102-a and the second wireless device are co-located), whether the STA 104-a accesses the medium via random access or duty-cycled operation, among other examples. Additionally, or alternatively, the trigger frame 1315 may include information that may solicit an UL response from the STA 104-a, assist the STA 104-a in performing one or more UL transmissions 1320, or any combination thereof. For example, the trigger frame 1315 may include fields, subfields, parameters, or any combination thereof, to indicate common network information, UL transmission-specific information, capability-related information, energy harvesting-related information, backscattering-related information, or a combination thereof.

In some implementations, the trigger frame 1315 may include a STA identifier to identify one or more STAs 104 (such as the STA 104-a) in the trigger frame 1315. In some implementations, the AP 102-a may assign STA identifiers to the one or more STAs 104, or a respective STA 104 may assign a STA identifier to itself (such as in a deterministic or random process). The trigger frame 1315 may include an indication of whether the trigger frame 1315 is unicast, multicast, or broadcast in association with whether the trigger frame 1315 triggers one STA 104 (such as the STA 104-a) or multiple STAs 104. If the trigger frame 1315 is multicast, the trigger frame 1315 may include STA identifiers for the triggered STAs 104 or a group identifier for the triggered STAs 104. If the trigger frame 1315 is broadcast, the AP 102-a may transmit the trigger frame 1315 to a broadcast address using a broadcast identifier.

In some implementations, the trigger frame 1315 may include a type of solicited response from the STA 104-a. For example, the trigger frame 1315 may indicate the STA 104-a to transmit an indication if the STA 104-a is present or not (such as via a binary indication), UL data, or a combination thereof. In such implementations, the solicited response may be in association with a device type of the STA 104-a (such as whether the STA 104-a includes an active UL transmitter, is backscatter device, or both). If the STA 104-a includes aspects of both an active UL transmitter and a backscatter device, the AP 102-a may indicate what mode (active UL or backscatter) the STA 104-a may use for the allocated resources in the trigger frame 1315.

Additionally, or alternatively, the trigger frame 1315 may include timing information for synchronization of communications between the AP 102-a and the STA 104-a. In some implementations, the trigger frame 1315 may indicate a trigger interval between two respective trigger frames 1315. For example, the trigger frame 1315 may indicate a trigger interval spanning multiple subsequent triggers or a duration to the next immediate trigger frame. The trigger interval may be common to all STAs 104 or different for different STAs 104. Additionally, or alternatively, the trigger interval may indicate a duty-cycled configuration of the STAs 104. In some implementations, the trigger frame 1315 may indicate a medium-access mechanism for the STA 104-a (such as when triggering multiple STAs 104). For example, the trigger frame 1315 may indicate the STA 104-a to use random access in time, random access in frequency, or CDMA-type access. The AP 102-a also may indicate related parameters for medium access, such as a range from which the STA 104-a may draw a random number to decide a time slot, a frequency band, or a code (such as for CDMA). In some other implementations, the AP 102-a may allocate, in the trigger frame 1315, a time slot, frequency band, or a code to the STA 104-a for its UL access.

In some implementations, the trigger frame 1315 may include information associated with a device that transmits one or more excitation signals subsequent to the trigger frame 1315 (such as the AP 102-a or the second wireless device). For example, the information may indicate a duration of the one or more subsequent excitation signals, a start time of the one or more subsequent excitation signals, a stop time of the one or more subsequent excitation signals, or any combination thereof. In some implementations, a device (such as the AP 102-a) may transmit the excitation signal 1310 subsequent to the trigger frame 1315. In such implementations, the trigger frame 1315 may indicate a duration of the excitation signal 1310, a start time of the excitation signal 1310, a stop time of the excitation signal 1310, or any combination thereof. The trigger frame 1315 may include UL power information for the STA 104-a to use in association with transmitting the one or more UL transmissions 1320. For example, the AP 102-a may indicate constant power or constant power with multiple levels (such as high or low) for the STA 104-a to use for the one or more UL transmissions 1320. In some other implementations, the STA 104-a may select or otherwise determine its own UL transmission power (such as if the AP 102-a does not include the power information indication in the trigger frame 1315).

In some implementations, the trigger frame 1315 may indicate a duration within which the STA 104-a is to complete the one or more UL transmissions 1320. The duration may be in association with the TxOP duration, a duration used by other mechanisms (such as an excitation period), among other examples. In some implementations, the duration may assist the STA 104-a in determining whether to transmit the one or more UL transmissions 1320. For example, if the UL duration is less than a threshold duration, the STA 104-a may not transmit one or more UL transmissions 1320 (which may conserve energy at the STA 104-a). If the STA 104-a does not perform the one or more UL transmissions 1320 in association with the duration not satisfying the threshold, the STA 104-a may transmit an indication to the AP 102-a that the duration does not satisfy the threshold duration in response to the trigger frame 1315. The AP 102-a may adjust the duration in subsequent TxOPs in association with the indication.

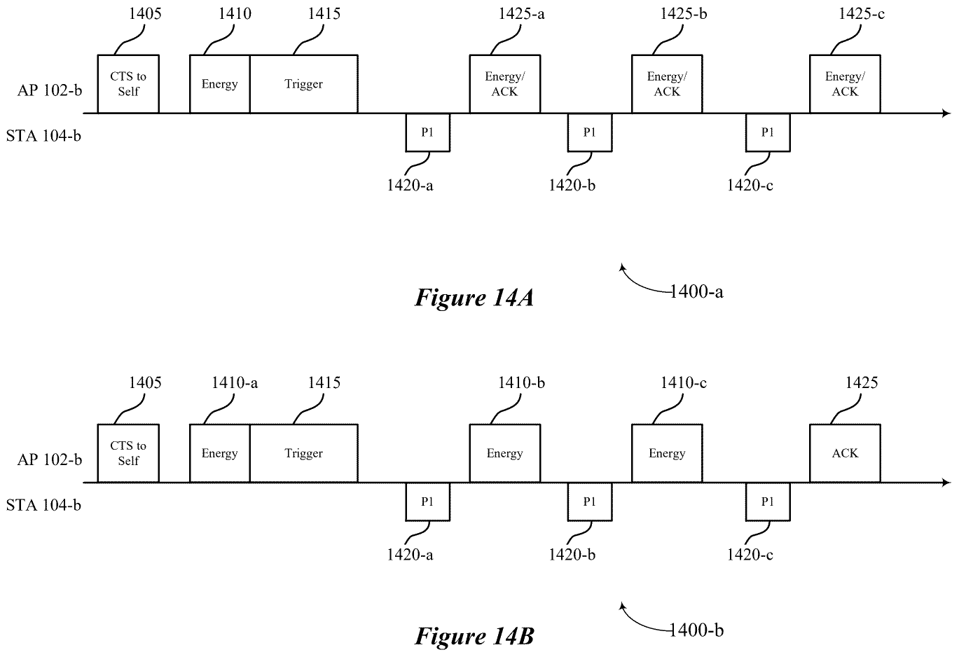

In some other implementations, the trigger frame 1315 may indicate a type of feedback indication the AP 102-a may provide. For example, the trigger frame 1315 may indicate whether the AP 102-a may transmit an ACK in association with receipt of the UL data or transmit an ACK and an excitation signal in association with receipt of the UL data. Additionally, or alternatively, the trigger frame 1315 may indicate whether the AP 102-a acknowledges fragments of the UL data individually or collectively, as described further with reference to FIGS. 14A and 14B. The trigger frame 1315 may indicate an MCS value for the STA 104-a to use for the one or more UL transmissions 1320. In some implementations, the STA 104-a may determine the MCS for the one or more UL transmissions 1320. Additionally, or alternatively, the trigger frame 1315 may include an indication to request capabilities or a status of the STA 104-a. For example, the trigger frame 1315 may request an energy harvesting capability of the STA 104-a or an energy state of the STA 104-a (such as whether the STA 104-a includes sufficient energy for the one or more UL transmissions 1320), among other examples. The trigger frame 1315 may include security-related information. For example, the AP 102-a may include one or more integrity check operations that may discourage unauthorized triggering of STAs 104 (such as a message integrity check (MIC)).

In some implementations (such as if the STA 104-a is a backscattering device), the trigger frame 1315 may include one or more backscatter-related parameters, a resource allocation, timing information, or any combination thereof. For example, the backscatter-related parameters may include a frequency shift for the STA 104-a to use in association with reflecting an incident carrier signal or the backscatter-related parameters may include a modulation type. The AP 102-a may indicate what subchannel the STA 104-a may backscatter (such as using frequency shifting). In some implementations, the AP 102-a may transmit the trigger frame 1315 to multiple STAs 104. In such implementations, the AP 102-a may request each STA 104 to use a frequency shift to mitigate interference between multiple simultaneous UL transmissions. Additionally, or alternatively, the AP 102-a may provide information indicating a time at which the STA 104-a may begin backscattering, a duration of the backscattering (such as the UL duration), or both. In some implementations, the information may be in association with the length of the TxOP, a quantity of STAs 104 receiving the trigger frame 1315, or both.

In some implementations, the STA 104-a may transmit the one or more UL transmissions 1320 in association with receiving the excitation signal 1310 and the trigger frame 1315. The one or more UL transmissions 1320 may include an UL packet. For example, the UL packet may include information, such as a quantity of energy left at the STA 104-a associated with transmitting the one or more UL transmissions 1320, or a request to increase a duration of a following excitation signal 1310, among other examples. In some other implementations, the STA 104-a may transmit an indication (such as a 1-bit indication) that it is present, but the STA 104-a may not include UL data in the one or more UL transmissions 1320. For example, the STA 104-a may transmit the indication if there is no data to transmit or if there is not sufficient energy at the STA 104-a to transmit the data. The AP 102-a may receive the one or more UL transmissions 1320 associated with monitoring for the one or more UL transmissions 1320 and the trigger frame 1315.

The AP 102-a may transmit a response signal 1325 in association with receiving the one or more UL transmissions 1320. In some implementations, the AP 102-a may transmit one or more second PPDUs that include a second excitation signal and a response portion (such as one or more of the one or more second PPDUs may include the response portion, a respective PPDU of the one or more second PPDUs may include the response portion, a portion of a respective PPDU may include the response portion). As described herein, a response portion also may be referred to a response signal. The response portion may be associated with receipt of the one or more UL transmissions 1320. The response portion may be based on the receipt of the one or more UL transmissions 1320. For example, the AP 102-a may transmit the response portion in response to receiving the one or more UL transmissions 1320 (such that the response portion may include feedback information for the one or more UL transmissions 1320). In some other implementations, the STA 104-a may receive a first set of one or more second PPDUs that includes the response signal 1325 from the AP 102-a and may receive a second set of the one or more second PPDUs that includes the second excitation signal from the second wireless device. The response signal 1325 may include a feedback indicator (such as an ACK if the AP 102-a received the UL packet successfully) or other information. For example, the response signal 1325 may include information indicating a time at which the AP 102-a may transmit a next trigger frame. Additionally, or alternatively, the response signal 1325 may include a second excitation signal. In some implementations, inclusion of the second excitation signal may be associated with the quantity of energy indicated in the UL packet. For example, the AP 102-a may transmit the second excitation signal in the response signal 1325 in association with the quantity of energy indicated in the UL packet being below an energy threshold. In some other implementations, the AP 102-a may increase or decrease a duration of the second excitation signal in association with the UL packet. For example, the AP 102-a may increase the duration if the quantity of energy is below the threshold or if the duration of the one or more UL transmissions 1320 is less than a threshold.

In some implementations, the duration of the excitation signal 1310 may be associated with a quantity of power the STA 104-a uses to wake-up to transmit a duration of a PPDU (such as the UL packet). For example, the AP 102-a may transmit one or more PPDUs associated with receipt of the one or more UL transmissions 1320, where the one or more UL transmissions 1320 include an indication of the quantity of power at the STA 104-a. The one or more PPDUs may include a second excitation signal with a duration corresponding to the quantity of power. In some implementations, the STA 104-a may indicate its energy harvesting capability to the AP 102-a (such as before or during data frame exchanges with the AP 102-a). The AP 102-a may determine a duration of the excitation signal 1310 in association with the indicated energy harvesting capability of the STA 104-a.

In some implementations, the STA 104-a may not harvest sufficient energy to transmit the one or more UL transmissions 1320 (such as if the excitation signal 1310 precedes the trigger frame 1315). In such implementations, the AP 102-a may increase a duration of a subsequent excitation signal (such as the duration of the second excitation signal). In some other implementations, the STA 104-a may respond to the trigger frame 1315, but the transmission energy of the one or more UL transmissions 1320 may not satisfy a decoding energy threshold. That is, the transmission energy of the response may not be sufficient for the AP 102-a to decode the transmission. In association with the transmission energy not satisfying the decoding energy threshold, the AP 102-a may increase a duration of a subsequent excitation signal.

In some implementations, data communication (such as the trigger frame 1315 or the response signal 1325) may occur in a different frequency band than the excitation signal 1310. For example, data communication may occur in a 2.4 GHz band and the excitation signal 1310 may occur in a sub-1 GHz band. In some implementations, if the second wireless device transmits the excitation signals, the AP 102-a may include information about the second wireless device in the trigger frame 1315 (such as a duration of the excitation signal 1310). Additionally, or alternatively, the AP 102-a may indicate information to the second wireless device via the trigger frame 1315. For example, the AP 102-a may indicate a duration of the excitation signal 1310 in association with the TxOP length and the UL duration, whether to increase or decrease the power of the excitation signal, when to begin or stop transmitting excitation signals, or any combination thereof.

FIGS. 14A and 14B show examples of signaling diagrams 1400 that support multi-layer signaling for AMP devices. The signaling diagrams 1400 may implement aspects of the wireless communication network 100, aspects of the PPDU 200, aspects of the frequency diagram 300, aspects of the wireless communications system 400, or aspects of the signaling diagram 1300. Aspects of the signaling diagrams 1400 may be implemented at or implemented by one or more wireless devices, which may be examples of the corresponding devices described herein. For example, the AP 102-b may be an example of one or more aspects of an AP 102 as described herein, including with reference to FIG. 1. The STA 104-b may be an example of one or more aspects of a STA 104 as described herein, including with reference to FIG. 1. In some implementations, the STA 104-b may be an AMP device or a backscattering device. The AP 102-b may initiate signaling in the signaling diagrams 1400 with a CTS-to-Self 1405 that may signal to other devices, such as the STA 104-b, that the channel is being reserved for a period of time. The CTS-to-Self 1405 may be followed by a TxOP that includes a trigger frame 1415 from the AP 102-b, one or more UL transmissions 1420 from the STA 104-b, and one or more response signals 1425 (such as acknowledgement signals) from the AP 102-b.

In some other wireless communications systems, uplink transmissions by a STA 104 (such as a STA 104 that is an AMP device) may be triggered by an AP 102. For example, the AP 102 may transmit a trigger frame 1315 that indicates for a STA 104 to communicate with the AP 102. However, in some implementations, the STA 104 may not have sufficient energy (stored or otherwise harvested from transmissions) to contend for the medium. The techniques described herein may enable the AP 102-b to increase a likelihood of the STA 104-b stores a threshold quantity of energy to respond to the trigger frame 1415 by transmitting an excitation signal 1410 (also known as an excitation signal) associated with the trigger frame 1415. In some implementations, the AP 102-a may transmit the excitation signal 1410 and the trigger frame 1415 over the same PPDUs or over different PPDUs. The STA 104-b may harvest energy from the excitation signal 1410, which may enable the STA 104-b to respond to the trigger frame 1415 as well as subsequent communications with the AP 102-b.

In some implementations, the excitation signal 1410 may not provide sufficient energy to the STA 104-b to transmit an entire UL packet. In such implementations, the STA 104-b may fragment the UL packet into multiple sub-packets and transmit the sub-packets in multiple UL transmissions 1420. For example, the AP 102-b may receive two or more UL transmissions 1420 in accordance with the trigger frame 1415, and information in a first respective UL transmission 1420 may be associated with information in a second respective UL transmission 1420. The information in the first UL transmission 1420 may be based on the information in the second respective UL transmission 1420. For example, the information in the first UL transmission 1420 may occur responsive to the information in the second respective UL transmission 1420 (or the information in the second respective UL transmission 1420 may occur response to the information in the first respective UL transmission 1420). In some examples, the information in the first respective UL transmission 1420 and the information in the second respective UL transmission 1420 may be parts of a same data message or UL packet, the information in the first respective UL transmission 1420 and the information in the second respective UL transmission 1420 may be sent from a same STA 104, information in the first respective UL transmission 1420 may indicate energy information that supports or enables transmission of the information in the second respective UL transmission 1420.

Although the AP 102-b is described as transmitting one or more excitation signals 1410, it may be understood that a second wireless device (such as a second AP 102 or any other energizer device that is capable of transmitting excitation signals) may transmit the one or more excitation signals 1410 (such as the excitation signal 1410-a, 1410-b, and 1410-c) and the AP 102-b may transmit the trigger frame 1415 and the one or more response signals 1425. That is, the AP 102-b may coordinate with the second wireless device to schedule transmission of excitation signals to the STA 104-b.

FIG. 14A illustrates an example signaling diagram 1400-a that supports multi-layer signaling for AMP devices, in which the AP 102-b transmits a response signal 1425 for each UL transmission 1420. For example, the AP 102-b may transmit one or more PPDUs subsequent to each UL transmission 1420. In some implementations, each response signal 1425 may include a respective excitation signal and response information in association with receipt of a preceding UL transmission 1420. For example, the response signal 1425-a may include an excitation signal portion and a response portion in association with the UL transmission 1420-a. The STA 104-b may harvest the energy in each respective excitation signal to transmit a subsequent UL transmission 1420. For example, the STA 104-b may transmit the UL transmission 1420-b in association with harvesting energy from the response signal 1425-a.

In some implementations, the AP 102-b may transmit the response information in each response signal 1425 (such as the response signal 1425-a, 1425-b, and 1425-c) in a first frequency band (such as in a 2.4 GHz band) and the second wireless device may transmit the excitation signals in a second frequency band (such as in a sub-1 GHz band). In such implementations, the second wireless device may transmit a continuous excitation signal 1410 throughout the TxOP. Additionally, or alternatively, the AP 102-b may transmit an indication instructing the second wireless device to transmit an excitation signal in association with receipt of a respective UL transmission 1420 (such as after receiving the UL transmission 1420-a).

In some implementations, each UL transmission 1420 may indicate a subsequent UL transmission 1420 in a different PPDU (until the last UL transmission) to the AP 102-b. For example, the UL transmission 1420-a may indicate that the STA 104-b may transmit the UL transmission 1420-b. Additionally, or alternatively, the UL transmission 1420-a may indicate a total quantity of UL transmissions 1420 (such as three in FIG. 14A). In some implementations, each UL transmission 1420 may indicate additional information. For example, an UL transmission 1420 may indicate a quantity of energy left at the STA 104-b after transmitting the UL transmission 1420 (which the AP 102-b may use to adjust the duration of a subsequent excitation signal) or a request to increase the duration of an excitation signal portion of the response signal 1425.

FIG. 14B illustrates an example signaling diagram 1400-b that supports multi-layer signaling for AMP devices, in which the AP 102-b transmits an excitation signal 1410 for each UL transmission 1420 and a response signal 1425 to all of the UL transmissions 1420. For example, the AP 102-b may transmit one or more second excitation signals subsequent to each UL transmission 1420 until a last UL transmission and transmit a response signal 1425 subsequent to the last UL transmission 1420 (such as the UL transmission 1420-c). In some implementations, the response signal 1425 may include a feedback indication associated with all of the UL transmissions 1420 (such as the UL transmission 1420-a, the UL transmission 1420-b, and the UL transmission 1420-c). The STA 104-b may receive the response signal 1425 subsequent to the last UL transmission (the UL transmission 1420-c), and the response signal 1425 may be associated with all of the UL transmissions 1420. The response signal 1425 may be based on transmitting all of the UL transmissions 1420. For example, the STA 104-b may receive the response signal 1425 responsive to transmitting all of the UL transmissions 1420 (such that the response signal 1425 may include feedback information for one or more of the UL transmissions 1420).

In some implementations, each UL transmission 1420 may indicate a subsequent UL transmission 1420 in a different PPDU (until the last UL transmission) to the AP 102-b. For example, the UL transmission 1420-a may indicate that the STA 104-b may transmit the UL transmission 1420-b. Additionally, or alternatively, the UL transmission 1420-a may indicate a total quantity of UL transmissions 1420 (such as three). In some implementations, each UL transmission 1420 may indicate additional information. For example, an UL transmission 1420 may indicate a quantity of energy left at the STA 104-b after transmitting the UL transmission 1420 (which the AP 102-b may use to adjust the duration of a subsequent excitation signal) or a request to increase the duration of an excitation signal 1410.

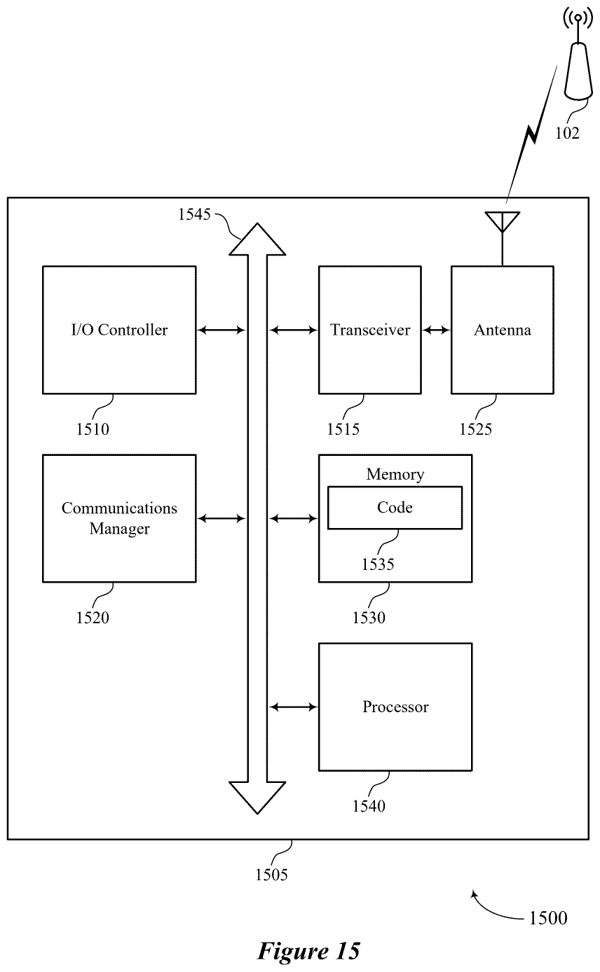

FIG. 15 shows a diagram of an example system 1500 including a device 1505 that supports multi-layer signaling for AMP devices. The device 1505 may include components for bi-directional voice and data communications including components for transmitting and receiving communications, such as a communications manager 1520, an I/O controller, such as an I/O controller 1510, a transceiver 1515, one or more antennas 1525, at least one memory 1530, code 1535, and at least one processor 1540. These components may be in electronic communication or otherwise coupled (such as operatively, communicatively, functionally, electronically, electrically) via one or more buses (such as a bus 1545).

The I/O controller 1510 may manage input and output signals for the device 1505. The I/O controller 1510 also may manage peripherals not integrated into the device 1505. In some implementations, the I/O controller 1510 may represent a physical connection or port to an external peripheral. In some implementations, the I/O controller 1510 may utilize an operating system such as iOS®, ANDROID®, MS-DOS®, MS-WINDOWS®, OS/2®, UNIX®, LINUX®, or another known operating system. In some other implementations, the I/O controller 1510 may represent or interact with a modem, a keyboard, a mouse, a touchscreen, or a similar device. In some implementations, the I/O controller 1510 may be implemented as part of a processor, such as the processor 1540. In some implementations, a user may interact with the device 1505 via the I/O controller 1510 or via hardware components controlled by the I/O controller 1510.

The device 1505 may include one or more chips, SoCs, chipsets, packages, components or devices that individually or collectively constitute or include a processing system. The processing system may interface with other components of the device 1505, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1505 may transmit the information output from the chip. In such an example, the second interface may refer to an interface between the processing system of the chip and a reception component, such that the device 1505 may receive information that is then passed to the processing system. In some such examples, the first interface also may obtain information, such as from the transmission component, and the second interface also may output information, such as to the reception component.

The processing system of the device 1505 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the device 1505 can be configurable or configured for use in a STA or an AP, such as a STA 104 or an AP 102 described with reference to FIG. 1. In some other examples, the device 1505 can be a STA or an AP that includes such a processing system and other components including multiple antennas. The device 1505 is capable of transmitting and receiving wireless communications in the form of, for example, wireless packets. For example, the device 1505 can be configurable or configured to transmit and receive packets in the form of physical layer PPDUs and MPDUs conforming to one or more of the IEEE 802.11 family of wireless communication protocol standards. In some other examples, the device 1505 can be configurable or configured to transmit and receive signals and communications conforming to one or more 3GPP specifications including those for 5G NR or 6G. In some examples, the device 1505 also includes or can be coupled with one or more application processors which may be further coupled with one or more other memories.

In some implementations, the device 1505 may include a single antenna. However, in some other implementations, the device 1505 may have more than one antenna, which may be capable of concurrently transmitting or receiving multiple wireless transmissions. The transceiver 1515 may communicate bi-directionally via the one or more antennas 1525 using wired or wireless links as described herein. The transceiver 1515 may represent a wireless transceiver and may communicate bi-directionally with another wireless transceiver. The transceiver 1515 also may include a modem to modulate the packets and provide the modulated packets to one or more antennas 1525 for transmission, and to demodulate packets received from the one or more antennas 1525. The transceiver 1515, or the transceiver 1515 and one or more antennas 1525, may be an example of a transmitter, a receiver, or any combination thereof or component thereof, as described herein.

The memory 1530 may include RAM and ROM. The memory 1530 may store computer-readable, computer-executable, or processor-executable code, such as code 1535. The code 1535 may include instructions that, when executed by the processor 1540, cause the device 1505 to perform various functions described herein. In some implementations, the memory 1530 may include, among other things, a BIOS which may control basic hardware or software operation such as the interaction with peripheral components or devices.

The processor 1540 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 1540 may be configured to operate a memory array using a memory controller. In some other implementations, a memory controller may be integrated into the processor 1540. The processor 1540 may be configured to execute computer-readable instructions stored in a memory (such as the memory 1530) to cause the device 1505 to perform various functions (such as functions or tasks supporting physical protocol data unit for ambient power devices). The device 1505 or a component of the device 1505 may include a processor 1540 and memory 1530 coupled to the processor 1540, the processor 1540 and memory 1530 configured to perform various functions described herein.

The communications manager 1520 may support wireless communications in accordance with examples as disclosed herein. The communications manager 1520 is capable of, configured to, or operable to support a means for receiving a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU. The communications manager 1520 is capable of, configured to, or operable to support a means for transmitting an uplink signal during the TxOP according to the one or more fields defining the PPDU as the AMP device PPDU.

Additionally, or alternatively, the communications manager 1520 may support wireless communications in accordance with examples as disclosed herein. The communications manager 1520 is capable of, configured to, or operable to support a means for transmitting a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU. The communications manager 1520 is capable of, configured to, or operable to support a means for receiving an uplink signal during the TxOP according to the one or more fields defining the PPDU as the AMP device PPDU.

Additionally, or alternatively, the communications manager 1520 may support wireless communications in accordance with examples as disclosed herein. For example, the communications manager 1520 is capable of, configured to, or operable to support a means for receiving a first excitation signal, receiving an uplink transmission trigger, where the first excitation signal includes one or more power signals configured to passively power the second wireless device associated with the uplink transmission trigger. The communications manager 1520 is capable of, configured to, or operable to support a means for performing one or more uplink transmissions in accordance with the first excitation signal and the uplink transmission trigger.

Additionally, or alternatively, the communications manager 1520 may support wireless communications in accordance with examples as disclosed herein. For example, the communications manager 1520 is capable of, configured to, or operable to support a means for receiving a first portion of an AMP downlink PPDU that includes one or more excitation signals, the first portion indicating a type of STA to which the AMP downlink PPDU is intended, the type of STA being one of a first type of STA that is capable to receive AMP downlink PPDUs and transmit AMP uplink PPDUs or a second type of STA that is capable to receive AMP downlink PPDUs and transmit non-AMP uplink PPDUs. The communications manager 1520 is capable of, configured to, or operable to support a means for selectively receiving at least a second portion of the AMP downlink PPDU in accordance with whether the STA is the type of STA to which the AMP downlink PPDU is intended.

By including or configuring the communications manager 1520 in accordance with examples as described herein, the device 1505 may support techniques for AMP device PPDU and AMP downlink PPDU definition and identification. This may include one or more fields in the spoofing preamble portion, in the downlink data portion, or in both portions being set to values or otherwise use configurations that define the PPDU as an AMP device PPDU rather than a non-AMP device PPDU.

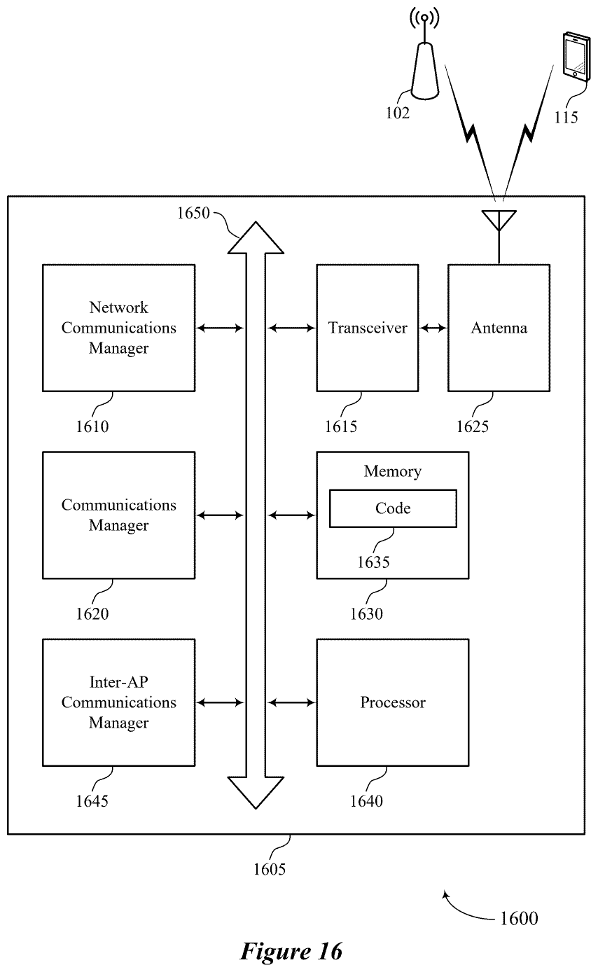

FIG. 16 shows a diagram of an example system 1600 including a device 1605 that supports multi-layer signaling for AMP devices. The device 1605 may include components for bi-directional voice and data communications including components for transmitting and receiving communications, such as a communications manager 1620, a network communications manager 1610, a transceiver 1615, one or more antennas 1625, at least one memory 1630, code 1635, at least one processor 1640, and an inter-station communications manager 1645. These components may be in electronic communication or otherwise coupled (such as operatively, communicatively, functionally, electronically, electrically) via one or more buses (such as a bus 1650). The network communications manager 1610 may manage communications with a core network (such as via one or more wired backhaul links). The network communications manager 1610 may manage the transfer of data communications for client devices, such as one or more STAs 115.

The device 1605 may include one or more chips, SoCs, chipsets, packages, components or devices that individually or collectively constitute or include a processing system. The processing system may interface with other components of the device 1605, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1605 may transmit the information output from the chip. In such an example, the second interface may refer to an interface between the processing system of the chip and a reception component, such that the device 1605 may receive information that is then passed to the processing system. In some such examples, the first interface also may obtain information, such as from the transmission component, and the second interface also may output information, such as to the reception component.

The processing system of the device 1605 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the device 1605 can be configurable or configured for use in an AP, such as an AP 102 described with reference to FIG. 1. In some other examples, the device 1605 can be an AP that includes such a processing system and other components including multiple antennas. The device 1605 is capable of transmitting and receiving wireless communications in the form of, for example, wireless packets. For example, the device 1605 can be configurable or configured to transmit and receive packets in the form of physical layer PPDUs and MPDUs conforming to one or more of the IEEE 802.11 family of wireless communication protocol standards. In some other examples, the device 1605 can be configurable or configured to transmit and receive signals and communications conforming to one or more 3GPP specifications including those for 5G NR or 6G. In some examples, the device 1605 also includes or can be coupled with one or more application processors which may be further coupled with one or more other memories.

In some implementations, the device 1605 may include a single antenna. However, in some other implementations, the device 1605 may have more than one antenna, which may be capable of concurrently transmitting or receiving multiple wireless transmissions. The transceiver 1615 may communicate bi-directionally via the one or more antennas 1625 using wired or wireless links as described herein. The transceiver 1615 may represent a wireless transceiver and may communicate bi-directionally with another wireless transceiver. The transceiver 1615 also may include a modem to modulate the packets and provide the modulated packets to one or more antennas 1625 for transmission, and to demodulate packets received from the one or more antennas 1625. The transceiver 1615, or the transceiver 1615 and one or more antennas 1625, may be an example of a transmitter, a receiver, or any combination thereof or component thereof, as described herein.

The memory 1630 may include RAM and ROM. The memory 1630 may store computer-readable, computer-executable, or processor-executable code, such as code 1635. The code 1635 may include instructions that, when executed by the processor 1640, cause the device 1605 to perform various functions described herein. In some implementations, the memory 1630 may include, among other things, a BIOS which may control basic hardware or software operation such as the interaction with peripheral components or devices.

The processor 1640 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 1640 may be configured to operate a memory array using a memory controller. In some other implementations, a memory controller may be integrated into the processor 1640. The processor 1640 may be configured to execute computer-readable instructions stored in a memory (such as the memory 1630) to cause the device 1605 to perform various functions (such as functions or tasks supporting physical protocol data unit for ambient power devices). The device 1605 or a component of the device 1605 may include a processor 1640 and memory 1630 coupled to the processor 1640, the processor 1640 and memory 1630 configured to perform various functions described herein.

The inter-station communications manager 1645 may manage communications with other APs 102, and may include a controller or scheduler for controlling communications with STAs 115 in cooperation with other APs 102. The inter-station communications manager 1645 may coordinate scheduling for transmissions to APs 102 for various interference mitigation techniques such as beamforming or joint transmission. In some implementations, the inter-station communications manager 1645 may provide an X2 interface within an LTE/LTE-A wireless communication network technology to provide communication between APs 102.

The communications manager 1620 may support wireless communications in accordance with examples as disclosed herein. The communications manager 1620 is capable of, configured to, or operable to support a means for transmitting a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU. The communications manager 1620 is capable of, configured to, or operable to support a means for receiving an uplink signal during the TxOP according to the one or more fields defining the PPDU as the AMP device PPDU.

Additionally, or alternatively, the communications manager 1620 may support wireless communications in accordance with examples as disclosed herein. For example, the communications manager 1620 is capable of, configured to, or operable to support a means for transmitting a first excitation signal, transmitting an uplink transmission trigger, where the first excitation signal includes one or more power signals configured to passively power one or more second wireless devices associated with the uplink transmission trigger. The communications manager 1620 is capable of, configured to, or operable to support a means for monitoring for one or more uplink transmissions from the one or more second wireless devices in accordance with the first excitation signal and the uplink transmission trigger. The communications manager 1620 is capable of, configured to, or operable to support a means for receiving the one or more uplink transmissions associated with monitoring for the one or more uplink transmissions and the uplink transmission trigger.

By including or configuring the communications manager 1620 in accordance with examples as described herein, the device 1605 may support techniques for AMP device PPDU definition and identification. This may include one or more fields in the spoofing preamble portion, in the downlink data portion, or in both portions being set to values or otherwise use configurations that define the PPDU as an AMP device PPDU rather than a non-AMP device PPDU.

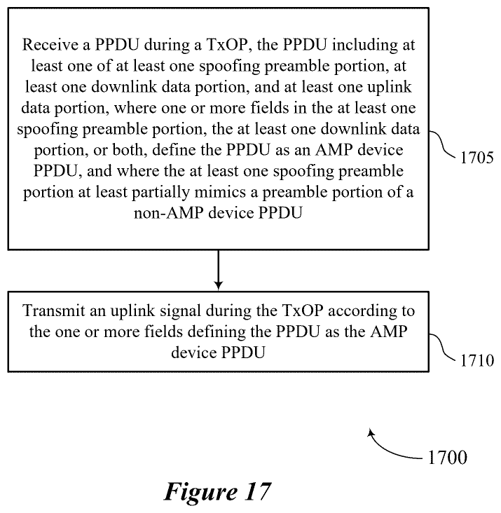

FIG. 17 shows a flowchart illustrating an example process 1700 performable by or at a wireless device that supports multi-layer signaling for AMP devices. The operations of the process 1700 may be implemented by a wireless device or its components as described herein. The process 1700 may be performed by a wireless communication device, such as the device 1505 described with reference to FIG. 15, operating as or within a wireless STA. In some implementations, the process 1700 may be performed by a wireless STA, such as one of the STAs 104 described with reference to FIG. 1.

In some implementations, in 1705, the wireless device may receive a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU. The operations of 1705 may be performed in accordance with examples as disclosed herein.

In some implementations, in 1710, the wireless device may transmit an uplink signal during the TxOP according to the one or more fields defining the PPDU as the AMP device PPDU. The operations of 1710 may be performed in accordance with examples as disclosed herein.

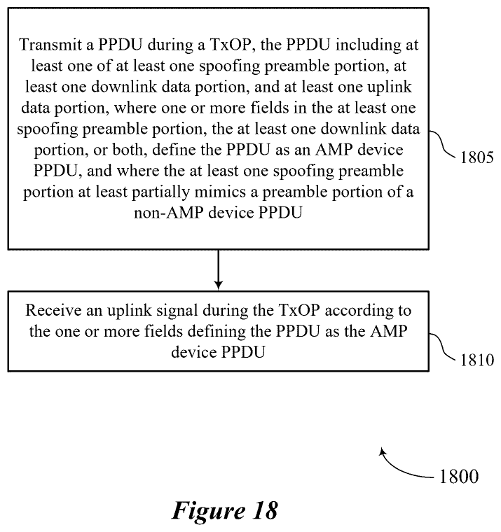

FIG. 18 shows a flowchart illustrating an example process 1800 performable by or at a wireless device that supports multi-layer signaling for AMP devices. The operations of the process 1800 may be implemented by a wireless device or its components as described herein. The process 1800 may be performed by a wireless communication device, such as the device 1505 described with reference to FIG. 15 or the device 1605 described with reference to FIG. 16, operating as or within a wireless AP or a wireless STA. In some implementations, the process 1800 may be performed by a wireless AP or a wireless STA, such as one of the APs 102 or the STAs 104 described with reference to FIG. 1.

In some implementations, in 1805, the wireless device may transmit a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an ambient power (AMP) device PPDU, and where the at least one spoofing preamble portion at least partially mimics a preamble portion of a non-AMP device PPDU. The operations of 1805 may be performed in accordance with examples as disclosed herein.

In some implementations, in 1810, the wireless device may receive an uplink signal during the TxOP according to the one or more fields defining the PPDU as the AMP device PPDU. The operations of 1810 may be performed in accordance with examples as disclosed herein.

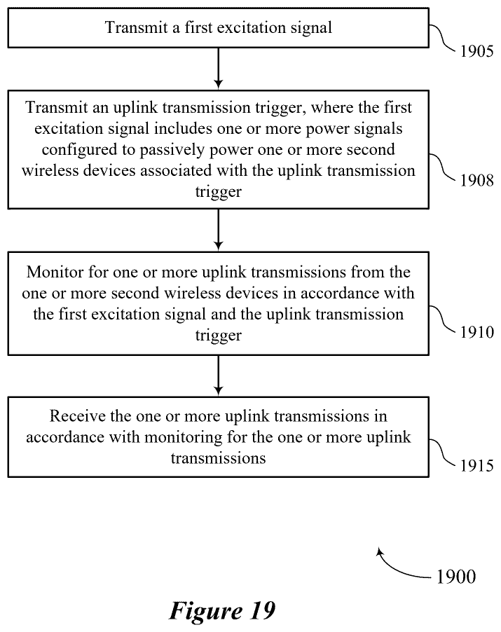

FIG. 19 shows a flowchart illustrating an example process 1900 performable by or at a first wireless device that supports multi-layer signaling for AMP devices. The operations of the process 1900 may be implemented by a first wireless device or its components as described herein. For example, the process 1900 may be performed by a wireless communication device, such as the device 1605 described with reference to FIG. 16, operating as or within a wireless AP. In some implementations, the process 1900 may be performed by a wireless AP, such as one of the APs 102 described with reference to FIG. 1.

In some implementations, in 1905, the first wireless device may transmit a first excitation signal. The operations of 1905 may be performed in accordance with examples as disclosed herein.

In some implementations, in 1908, the first wireless device may transmit an uplink transmission trigger, where the first excitation signal includes one or more power signals configured to passively power one or more second wireless devices associated with the uplink transmission trigger. The operations of 1908 may be performed in accordance with examples as disclosed herein.

In some implementations, in 1910, the first wireless device may monitor for one or more uplink transmissions from the one or more second wireless devices in accordance with the first excitation signal and the uplink transmission trigger. The operations of 1910 may be performed in accordance with examples as disclosed herein.

In some implementations, in 1915, the first wireless device may receive the one or more uplink transmissions in accordance with monitoring for the one or more uplink transmissions. The operations of 1915 may be performed in accordance with examples as disclosed herein.

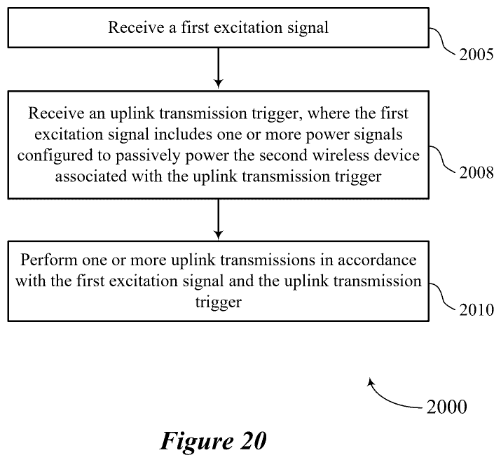

FIG. 20 shows a flowchart illustrating an example process 2000 performable by or at a second wireless device that supports multi-layer signaling for AMP devices. The operations of the process 2000 may be implemented by a second wireless device or its components as described herein. For example, the process 2000 may be performed by a wireless communication device, such as the device 1505 described with reference to FIG. 15, operating as or within a wireless STA. In some implementations, the process 2000 may be performed by a wireless STA, such as one of the STAs 104 described with reference to FIG. 1.

In some implementations, in 2005, the second wireless device may receive a first excitation signal. The operations of 2005 may be performed in accordance with examples as disclosed herein.

In some implementations, in 2008, the second wireless device may receive an uplink transmission trigger, where the first excitation signal includes one or more power signals configured to passively power the second wireless device associated with the uplink transmission trigger. The operations of 2008 may be performed in accordance with examples as disclosed herein.

In some implementations, in 2010, the second wireless device may perform one or more uplink transmissions in accordance with the first excitation signal and the uplink transmission trigger. The operations of 2010 may be performed in accordance with examples as disclosed herein.

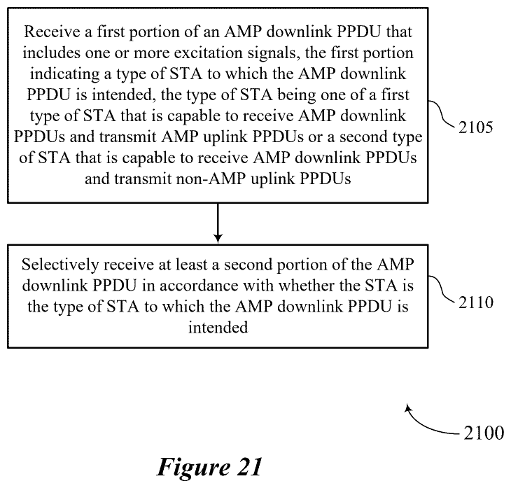

FIG. 21 shows a flowchart illustrating an example process 2100 performable by or at a STA that supports multi-layer signaling for AMP devices. The operations of the process 2100 may be implemented by a STA or its components as described herein. For example, the process 2100 may be performed by a wireless communication device, such as the device 1505 described with reference to FIG. 15, operating as or within a wireless STA. In some examples, the process 2100 may be performed by a wireless STA, such as one of the STAs 104 described with reference to FIG. 1.

In some examples, in 2105, the STA may receive a first portion of an AMP downlink PPDU that includes one or more excitation signals, the first portion indicating a type of STA to which the AMP downlink PPDU is intended, the type of STA being one of a first type of STA that is capable to receive AMP downlink PPDUs and transmit AMP uplink PPDUs or a second type of STA that is capable to receive AMP downlink PPDUs and transmit non-AMP uplink PPDUs. The operations of 2105 may be performed in accordance with examples as disclosed herein.

In some examples, in 2110, the STA may selectively receive at least a second portion of the AMP downlink PPDU in accordance with whether the STA is the type of STA to which the AMP downlink PPDU is intended. The operations of 2110 may be performed in accordance with examples as disclosed herein.

Implementation examples are described in the following numbered clauses:
Aspect 1: A method for wireless communications at a wireless device, including: receiving a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU; and transmitting an uplink signal during the TxOP according to the one or more fields defining the PPDU as the AMP device PPDU.
Aspect 2: The method of aspect 1, where the PPDU further includes a first excitation signal portion between a spoofing preamble portion and a downlink data portion, and a second excitation signal portion after the downlink data portion, the first excitation signal portion and the second excitation signal portion include power signals configured to passively power the wireless device and the second excitation signal portion is used by the wireless device to encode uplink information and perform an uplink transmission during the at least one uplink data portion.
Aspect 3: The method of any of aspects 1-2, where receiving the PPDU includes receiving a first PPDU that includes a first spoofing preamble portion and a first excitation signal portion and receiving a second PPDU that includes a second spoofing preamble portion, a downlink data portion, and a second excitation signal portion, the first excitation signal portion and the second excitation signal portion include power signals configured to passively power the wireless device and the second excitation signal portion is used by the wireless device to encode uplink information and perform an uplink transmission during the at least one uplink data portion.
Aspect 4: The method of any of aspects 1-3, where receiving the PPDU includes receiving a first PPDU that includes a first spoofing preamble portion and a first excitation signal portion and receiving a second PPDU that includes a second spoofing preamble portion, a common downlink data portion, a first device-specific downlink data portion, a second excitation signal portion, a second device-specific downlink data portion, and a third excitation signal portion, the first excitation signal portion, the second excitation signal portion, and the third excitation signal portion include power signals configured to passively power the wireless device and one or more other wireless devices and at least one of the second excitation signal portion or the third excitation signal portion is used by the wireless device to encode uplink information and perform an uplink transmission during the at least one uplink data portion.
Aspect 5: The method of any of aspects 1-4, where the one or more fields of the at least one downlink data portion include a synchronization field that is common to both AMP device PPDUs and non-AMP device PPDUs.
Aspect 6: The method of aspect 5, where the one or more fields of the at least one downlink data portion include a signal field that includes a field type indicator, a value of the field type indicator defines the PPDU as the AMP device PPDU.
Aspect 7: The method of any of aspects 1-6, where the one or more fields of the at least one downlink data portion include a synchronization field, a first modulation type associated with the synchronization field defines the PPDU as the AMP device PPDU, a second modulation type is associated with a non-AMP device PPDU.
Aspect 8: The method of aspect 7, where the at least one downlink data portion of the PPDU is modulated using the first modulation type in accordance with the synchronization field.
Aspect 9: The method of any of aspects 1-8, where the at least one downlink data portion includes a SIG field that identifies one or more of a first length of the at least one downlink data portion, and uplink data indication, and a second length of the at least one uplink data portion.
Aspect 10: The method of any of aspects 1-9, further including: transmitting a first portion of the uplink signal during the TxOP and a second portion of the uplink signal during a subsequent TxOP in accordance with a data size associated with the uplink signal satisfying a threshold.
Aspect 11: The method of any of aspects 1-10, where the at least one spoofing preamble portion includes one or more signal fields that are set to values that define the PPDU as the AMP device PPDU.
Aspect 12: The method of aspect 11, where the at least one spoofing preamble portion includes at least a L-SIG, a RL-SIG, a two-bit U-SIG, and a length parameter included in the L-SIG or the RL-SIG is set to a value that is a multiple of three to define the PPDU as the AMP device PPDU.
Aspect 13: The method of any of aspects 11-12, where the at least one spoofing preamble portion includes at least a L-SIG, a RL-SIG, a two-bit U-SIG, a length parameter included in the L-SIG or the RL-SIG is set to a value that is a multiple of three, and at least one bit of the two-bit U-SIG is modulated using QBPSK modulation to define the PPDU as the AMP device PPDU.
Aspect 14: The method of any of aspects 11-13, where the one or more signal fields are set to a validate state that conflict with a corresponding signal fields of a preamble portion of an 802.11be or an 802.11bn PPDU to define the PPDU as an AMP device PPDU.
Aspect 15: The method of any of aspects 1-14, where the one or more fields of the at least one spoofing preamble portion include one or more signal fields, the one or more signal fields including one or more of one or more multi-bit spatial reuse fields, one or more AMP device type fields, one or more quantity of downlink wireless devices or uplink devices fields, one or more indication fields of wireless device fields, or one or more communication direction fields.
Aspect 16: A method for wireless communications at a wireless device, including: transmitting a PPDU during a TxOP, the PPDU including at least one of at least one spoofing preamble portion, at least one downlink data portion, and at least one uplink data portion, where one or more fields in the at least one spoofing preamble portion, the at least one downlink data portion, or both, define the PPDU as an AMP device PPDU, and where the at least one spoofing preamble portion at least partially mimics a preamble portion of a non-AMP device PPDU; and receiving an uplink signal during the TxOP according to the one or more fields defining the PPDU as the AMP device PPDU.
Aspect 17: The method of aspect 16, where the PPDU further includes a first excitation signal portion between a spoofing preamble portion and a downlink data portion, and a second excitation signal portion after the downlink data portion, the first excitation signal portion and the second excitation signal portion include power signals configured to passively power the wireless device and the second excitation signal portion is used by the wireless device to encode uplink information and perform an uplink transmission during the at least one uplink data portion.
Aspect 18: The method of any of aspects 16-17, where transmitting the PPDU includes transmitting a first PPDU that includes a first spoofing preamble portion and a first excitation signal portion and transmitting a second PPDU that includes a second spoofing preamble portion, a downlink data portion, and a second excitation signal portion, the first excitation signal portion and the second excitation signal portion include power signals configured to passively power the wireless device and the second excitation signal portion is used by the wireless device to encode uplink information and perform an uplink transmission during the at least one uplink data portion.
Aspect 19: The method of any of aspects 16-18, where transmitting the PPDU includes transmitting a first PPDU that includes a first spoofing preamble portion and a first excitation signal portion and transmitting a second PPDU that includes a second spoofing preamble portion, a common downlink data portion, a first device-specific downlink data portion, a second excitation signal portion, a second device-specific downlink data portion, and a third excitation signal portion the first excitation signal portion, the second excitation signal portion, and the third excitation signal portion include power signals configured to passively power the wireless device and one or more other wireless devices and at least one of the second excitation signal portion or the third excitation signal portion is used by the wireless device to encode uplink information and perform an uplink transmission during the at least one uplink data portion.
Aspect 20: The method of any of aspects 16-19, where the one or more fields of the at least one downlink data portion include a synchronization field that is common to both AMP device PPDUs and non-AMP device PPDUs.
Aspect 21: The method of aspect 20, where the one or more fields of the at least one downlink data portion include a signal field that includes a field type indicator, a value of the field type indicator defines the PPDU as the AMP device PPDU.
Aspect 22: The method of any of aspects 16-21, where the one or more fields of the at least one downlink data portion include a synchronization field, a first modulation type associated with the synchronization field defines the PPDU as the AMP device PPDU, a second modulation type is associated with a non-AMP device PPDU.
Aspect 23: The method of aspect 22, where the at least one downlink data portion of the PPDU is modulated using the first modulation type in accordance with the synchronization field.
Aspect 24: The method of any of aspects 16-23, where the at least one downlink data portion includes a SIG that identifies one or more of a first length of the at least one downlink data portion, and uplink data indication, and a second length of the at least one uplink data portion.
Aspect 25: The method of any of aspects 16-24, further including: receiving a first portion of the uplink signal during the TxOP and a second portion of the uplink signal during a subsequent TxOP in accordance with a data size associated with the uplink signal satisfying a threshold.
Aspect 26: The method of any of aspects 16-25, where the at least one spoofing preamble portion includes one or more signal fields that are set to values that define the PPDU as the AMP device PPDU.
Aspect 27: The method of aspect 26, where the at least one spoofing preamble portion includes at least a L-SIG, a RL-SIG, a two-bit U-SIG, and a length parameter included in the L-SIG or the RL-SIG is set to a value that is a multiple of three to define the PPDU as the AMP device PPDU.
Aspect 28: The method of any of aspects 26-27, where the at least one spoofing preamble portion includes at least a L-SIG, a RL-SIG, a two-bit U-SIG, a length parameter included in the L-SIG or the RL-SIG is set to a value that is a multiple of three, and at least one bit of the two-bit U-SIG is modulated using QBPSK modulation to define the PPDU as the AMP device PPDU.
Aspect 29: The method of any of aspects 26-28, where the one or more signal fields are set to a validate state that conflict with a corresponding signal fields of a preamble portion of an 802.11be or an 802.11bn PPDU to define the PPDU as an AMP device PPDU.
Aspect 30: The method of any of aspects 16-29, where the one or more fields of the at least one spoofing preamble portion include one or more signal fields, the one or more signal fields including one or more of one or more multi-bit spatial reuse fields, one or more AMP device type fields, one or more quantity of downlink wireless devices or uplink devices fields, one or more indication fields of wireless device fields, or one or more communication direction fields.
Aspect 31: A method for wireless communications at a first wireless device, including: transmitting a first excitation signal; transmitting an uplink transmission trigger, where the first excitation signal includes one or more power signals configured to passively power one or more second wireless devices associated with the uplink transmission trigger; monitoring for one or more uplink transmissions from the one or more second wireless devices in accordance with the first excitation signal and the uplink transmission trigger; and receiving the one or more uplink transmissions associated with monitoring for the one or more uplink transmissions and the uplink transmission trigger.
Aspect 32: The method of aspect 31, where the first excitation signal and the uplink transmission trigger are transmitted via one or more first PPDUs, and further including: transmitting one or more second PPDUs, the one or more second PPDUs including a second excitation signal portion and a response portion, where the response portion is associated with a receipt of the one or more uplink transmissions (such that the response portion may be an acknowledgment of the one or more uplink transmissions or such that the response portion may indicate a time at which a next uplink transmission trigger is to be transmitted after receipt of the one or more uplink transmissions, among other examples).
Aspect 33: The method of any of aspects 31-32, where receiving the one or more uplink transmissions further includes: receiving two or more uplink transmissions in accordance with the uplink transmission trigger, where information in a first respective uplink transmission of the two or more uplink transmissions is associated with information in a second respective uplink transmission of the two or more uplink transmissions.
Aspect 34: The method of aspect 33, further including: transmitting one or more PPDUs subsequent to each uplink transmission of the two or more uplink transmissions, where a respective PPDU of the one or more PPDUs includes a respective excitation signal portion and a respective response portion, where the respective response portion is associated with a receipt of a preceding uplink transmission of the two or more uplink transmissions (such that the respective response portion may be an acknowledgment of the preceding uplink transmission or such that the respective response portion may indicate a time at which a next uplink transmission trigger is to be transmitted after receipt of the preceding uplink transmission, among other examples).
Aspect 35: The method of any of aspects 33-34, further including: transmitting one or more second excitation signals subsequent to each uplink transmission of the two or more uplink transmissions until a last uplink transmission of the two or more uplink transmissions; and transmitting a response signal subsequent to the last uplink transmission, where the response signal is associated with all of the two or more uplink transmissions (such that the response signal may be an acknowledgment of all of the two or more uplink transmissions or such that the response signal may indicate a time at which a next uplink transmission trigger is to be transmitted after receipt of all of the two or more uplink transmissions, among other examples).
Aspect 36: The method of any of aspects 33-35, where a first uplink transmission of the two or more uplink transmissions indicates a subsequent uplink transmission of the two or more uplink transmissions or a quantity of the two or more uplink transmissions.
Aspect 37: The method of any of aspects 31-36, where the uplink transmission trigger includes a trigger frame and one or more fields of the uplink transmission trigger indicate one or more trigger parameters, the one or more trigger parameters including one or more of an indication of the one or more second wireless devices, an indication that the trigger frame is a unicast frame, an indication that the trigger frame is a multicast frame, an indication that the trigger frame is a broadcast frame, an indication of a type of solicited response to the trigger frame, an indication of a trigger interval between successive trigger frames, one or more message integrity checks associated with the trigger frame, or any combination thereof.
Aspect 38: The method of any of aspects 31-37, where the first excitation signal is transmitted after the uplink transmission trigger, and where one or more fields of the uplink transmission trigger indicate one or more energy harvesting parameters, the one or more energy harvesting parameters including one or more of a timing associated with the one or more power signals, a duration associated with the one or more power signals, a transmit power associated with the one or more power signals, or any combination thereof.
Aspect 39: The method of any of aspects 31-38, where one or more fields of the uplink transmission trigger indicate one or more parameters associated with the one or more uplink transmissions, the one or more parameters associated with the one or more uplink transmissions including one or more of synchronization information associated with performing the one or more uplink transmissions, a medium access mechanism associated with the one or more uplink transmissions, an uplink power parameter associated with the one or more uplink transmissions, timing information for each of the one or more uplink transmissions, an acknowledgment feedback type associated with each of the one or more uplink transmissions, a modulation and coding scheme associated with each of the one or more uplink transmissions, a backscattering frequency shift associated with each of the one or more uplink transmissions, resource allocation associated with each of the one or more uplink transmissions, or any combination thereof.
Aspect 40: The method of any of aspects 31-39, further including: transmitting one or more PPDUs associated with receipt of the one or more uplink transmissions, where the one or more uplink transmissions include an indication of a quantity of power at the one or more second wireless devices, and where the one or more PPDUs include a second excitation signal portion with a duration corresponding to the quantity of power.
Aspect 41: The method of any of aspects 31-40, where one or more fields of the uplink transmission trigger include a request for an energy harvesting capability associated with the one or more second wireless devices or an energy harvesting status associated with the one or more second wireless devices.
Aspect 42: The method of any of aspects 31-41, further including: receiving an indication of an energy harvesting capability of the one or more second wireless devices, where transmission and a duration of the first excitation signal is associated with the indication.
Aspect 43: The method of any of aspects 31-42, further including: receiving an indication of an energy harvesting capability of the one or more second wireless devices; and transmitting one or more PPDUs associated with receipt of the indication, where the one or more PPDUs include a second excitation signal portion and a duration of the second excitation signal portion is associated with the indication.
Aspect 44: The method of any of aspects 31-43, further including: transmitting one or more second PPDUs associated with receipt of the one or more uplink transmissions, where a transmission energy of the one or more uplink transmissions is less than a threshold, and where the one or more second PPDUs include a second excitation signal portion with a duration corresponding to the transmission energy.
Aspect 45: The method of any of aspects 31-43, where the first excitation signal and the uplink transmission trigger are transmitted in different PPDUs.
Aspect 46: The method of any of aspects 31-43, where the first excitation signal and the uplink transmission trigger are transmitted in a same PPDU.
Aspect 47: A method for wireless communications at a second wireless device, including: receiving a first excitation signal; receiving an uplink transmission trigger, where the first excitation signal includes one or more power signals configured to passively power the second wireless device associated with the uplink transmission trigger; and performing one or more uplink transmissions in accordance with the first excitation signal and the uplink transmission trigger.
Aspect 48: The method of aspect 47, where receiving the first excitation signal and the uplink transmission trigger includes: receiving a first set of one or more PPDUs that includes the uplink transmission trigger from a first wireless device; and receiving a second set of one or more PPDUs that includes the first excitation signal from a third wireless device.
Aspect 49: The method of any of aspects 47-48, where the first excitation signal and the uplink transmission trigger are received via one or more first PPDUs, and further including: receiving one or more second PPDUs, the one or more second PPDUs including a second excitation signal portion and a response portion, where the response portion is associated with the one or more uplink transmissions (such that the response portion may be an acknowledgment of the one or more uplink transmissions or such that the response portion may indicate a time at which a next uplink transmission trigger is to be transmitted after the one or more uplink transmissions, among other examples).
Aspect 50: The method of aspect 49, where receiving the one or more second PPDUs includes: receiving a first set of the one or more second PPDUs that include the response portion from a first wireless device; and receiving a second set of the one or more second PPDUs that include the second excitation signal portion from a third wireless device.
Aspect 51: The method of any of aspects 47-50, where performing the one or more uplink transmissions further includes: transmitting two or more uplink transmissions in accordance with the uplink transmission trigger, where information in a first respective uplink transmission of the two or more uplink transmissions is associated with information in a second respective uplink transmission of the two or more uplink transmissions.
Aspect 52: The method of aspect 51, further including: receiving one or more PPDUs subsequent to each uplink transmission of the two or more uplink transmissions, where a respective PPDU of the one or more PPDUs includes a respective excitation signal portion and a respective response portion, where the respective response portion is associated with a preceding uplink transmission of the two or more uplink transmissions (such that the respective response portion may be an acknowledgment of the preceding uplink transmission or such that the respective response portion may indicate a time at which a next uplink transmission trigger is to be transmitted after transmission of the preceding uplink transmission, among other examples).
Aspect 53: The method of any of aspects 51-52, further including: receiving one or more second excitation signals subsequent to each uplink transmission of the two or more uplink transmissions until a last uplink transmission of the two or more uplink transmissions; and receiving a response signal subsequent to the last uplink transmission, where the response signal is associated with all of the two or more uplink transmissions (such that the response signal may be an acknowledgment of all of the two or more uplink transmissions or such that the response signal may indicate a time at which a next uplink transmission trigger is to be transmitted after transmission of all of the two or more uplink transmissions, among other examples).
Aspect 54: The method of any of aspects 51-52, where a first uplink transmission of the two or more uplink transmissions indicates a subsequent uplink transmission of the two or more uplink transmissions or a quantity of the two or more uplink transmissions.
Aspect 55: The method of any of aspects 47-54, where the uplink transmission trigger includes a trigger frame and one or more fields of the uplink transmission trigger indicate one or more trigger parameters, the one or more trigger parameters including one or more of an indication of the second wireless device, an indication that the trigger frame is a unicast frame, an indication that the trigger frame is a multicast frame, an indication that the trigger frame is a broadcast frame, an indication of a type of solicited response to the trigger frame, an indication of a trigger interval between successive trigger frames, one or more message integrity checks associated with the trigger frame, or any combination thereof.
Aspect 56: The method of any of aspects 47-55, where the first excitation signal is received after the uplink transmission trigger, and where one or more fields of the uplink transmission trigger indicate one or more energy harvesting parameters, the one or more energy harvesting parameters including one or more of a timing associated with the one or more power signals, a duration associated with the one or more power signals, a transmit power associated with the one or more power signals, or any combination thereof.
Aspect 57: The method of any of aspects 47-56, where one or more fields of the uplink transmission trigger indicate one or more parameters associated with the one or more uplink transmissions, the one or more parameters associated with the one or more uplink transmissions including one or more of synchronization information associated with performing the one or more uplink transmissions, a medium access mechanism associated with the one or more uplink transmissions, an uplink power parameter associated with the one or more uplink transmissions, timing information for each of the one or more uplink transmissions, an acknowledgment feedback type associated with each of the one or more uplink transmissions, a modulation and coding scheme associated with each of the one or more uplink transmissions, a backscattering frequency shift associated with each of the one or more uplink transmissions, a resource allocation associated with each of the one or more uplink transmissions, or any combination thereof.
Aspect 58: The method of any of aspects 47-57, further including: receiving one or more PPDUs associated with the one or more uplink transmissions, where the one or more uplink transmissions include an indication of a quantity of power at the second wireless device, the one or more PPDUs including a second excitation signal portion with a duration corresponding to the quantity of power.
Aspect 59: The method of any of aspects 47-58, where one or more fields of the uplink transmission trigger include a request for an energy harvesting capability associated with the second wireless device or an energy harvesting status associated with the second wireless device.
Aspect 60: The method of any of aspects 47-59, further including: transmitting an indication of an energy harvesting capability of the second wireless device, where receipt and a duration of the first excitation signal is associated with the indication.
Aspect 61: The method of any of aspects 47-60, further including: transmitting an indication of an energy harvesting capability of the second wireless device; and receiving one or more PPDUs associated with transmission of the indication, where the one or more PPDUs include a second excitation signal portion and a duration of the second excitation signal portion is associated with the indication.
Aspect 62: The method of any of aspects 47-61, further including: receiving one or more second PPDUs associated with receipt of the one or more uplink transmissions, where a transmission energy of the one or more uplink transmissions is less than a threshold, the one or more second PPDUs including a second excitation signal portion with a duration corresponding to the transmission energy.
Aspect 63: The method of any of aspects 47-62, where the first excitation signal and the uplink transmission trigger are received in different PPDUs.
Aspect 64: The method of any of aspects 47-62, where the first excitation signal and the uplink transmission trigger are received in a same PPDU.
Aspect 65: A wireless device for wireless communications, including a processing system that includes processor circuitry and memory circuitry that stores code, the processing system configured to cause the wireless device to perform a method of any of aspects 1-15.
Aspect 66: A wireless device for wireless communications, including at least one means for performing a method of any of aspects 1-15.
Aspect 67: A non-transitory computer-readable medium storing code for wireless communications, the code including instructions executable by one or more processors to perform a method of any of aspects 1-15.
Aspect 68: A wireless device for wireless communications, including a processing system that includes processor circuitry and memory circuitry that stores code, the processing system configured to cause the wireless device to perform a method of any of aspects 16-30.
Aspect 69: A wireless device for wireless communications, including at least one means for performing a method of any of aspects 16-30.
Aspect 70: A non-transitory computer-readable medium storing code for wireless communications, the code including instructions executable by one or more processors to perform a method of any of aspects 16-30.
Aspect 71: A first wireless device for wireless communications, including a processing system that includes processor circuitry and memory circuitry that stores code, the processing system configured to cause the wireless device to perform a method of any of aspects 31-46.
Aspect 72: A first wireless device for wireless communications, including at least one means for performing a method of any of aspects 31-46.
Aspect 73: A non-transitory computer-readable medium storing code for wireless communications, the code including instructions executable by one or more processors to perform a method of any of aspects 31-46.
Aspect 74: A second wireless device for wireless communications, including a processing system that includes processor circuitry and memory circuitry that stores code, the processing system configured to cause the wireless device to perform a method of any of aspects 47-64.
Aspect 75: A second wireless device for wireless communications, including at least one means for performing a method of any of aspects 47-64.
Aspect 76: A non-transitory computer-readable medium storing code for wireless communications, the code including instructions executable by one or more processors to perform a method of any of aspects 47-64.
Aspect 77: A method for wireless communication at a STA, including: receiving a first portion of an AMP downlink PPDU that includes one or more excitation signals, the first portion indicating a type of STA to which the AMP downlink PPDU is intended, the type of STA being one of: a first type of STA that is capable to receive AMP downlink PPDUs and transmit AMP uplink PPDUs, or a second type of STA that is capable to receive AMP downlink PPDUs and transmit non-AMP uplink PPDUs; and selectively receiving at least a second portion of the AMP downlink PPDU in accordance with whether the STA is the type of STA to which the AMP downlink PPDU is intended.
Aspect 78: The method of aspect 77, where selectively receiving at least the second portion of the AMP downlink PPDU includes: refraining from receiving the second portion of the AMP downlink PPDU in accordance with the STA not being the type of STA to which the AMP downlink PPDU is intended; or receiving at least the second portion of the AMP downlink PPDU in accordance with the STA being the type of STA to which the AMP downlink PPDU is intended.
Aspect 79: The method of any of aspects 77-78, where the first portion indicates a frame type of one or more MAC frames included in the AMP downlink PPDU, and the frame type indicates the type of STA to which the AMP downlink PPDU is intended.
Aspect 80: The method of aspect 79, where selectively receiving at least the second portion of the AMP downlink PPDU includes: receiving the one or more MAC frames in the AMP downlink PPDU in accordance with the STA being the type of STA to which the AMP downlink PPDU is intended.
Aspect 81: The method of any of aspects 79-80, where the frame type indicates that the one or more MAC frames include one or more of an acknowledgement frame, an AMP trigger frame, a data frame, a WUR frame, or a beacon frame.
Aspect 82: The method of any of aspects 77-81, where the second portion further indicates whether the AMP downlink PPDU includes data addressed to the STA, the method further including: selectively receiving at least a third portion of the AMP downlink PPDU in accordance with whether the AMP downlink PPDU includes data addressed to the STA.
Aspect 83: The method of any of aspects 77-82, where the second portion indicates a STA address, the method further including: selectively receiving at least a third portion of the AMP downlink PPDU in accordance with whether an address of the STA corresponds to the STA address indicated by the second portion.
Aspect 84: The method of any of aspects 77-83, where the first portion includes an AMP synchronization field that indicates the type of STA to which the AMP downlink PPDU is intended.
Aspect 85: The method of any of aspects 77-83, where the AMP downlink PPDU includes an AMP synchronization field, an AMP signaling field, and an AMP data field in accordance with an AMP communication format of the AMP downlink PPDU, and where receiving the first portion includes: receiving at least the AMP signaling field, where the AMP signaling field is after the AMP synchronization field and before the AMP data field in the AMP downlink PPDU, and where the AMP signaling field includes information indicating the type of STA to which the AMP downlink PPDU is intended.
Aspect 86: The method of aspect 85, where the information includes a first set of fields indicating a version associated with the AMP communication format and a second set of fields indicating whether the AMP downlink PPDU is for reception by the first type of STA or the second type of STA and an identifier of an AMP AP associated with the AMP downlink PPDU, a first presence of the first set of fields is independent of the version associated with the AMP communication format and a second presence of the second set of fields is independent or dependent on the version associated with the AMP communication format.
Aspect 87: The method of any of aspects 77-83, where receiving the first portion includes: receiving a MAC frame, the MAC frame including information indicating the type of STA to which the AMP downlink PPDU is intended.
Aspect 88: The method of aspect 87, where the MAC frame is an initial MAC frame included in the AMP downlink PPDU.
Aspect 89: The method of any of aspects 77-88, where a byte size of the first portion is an integer quantity of octets in accordance with a receiver processing scheme supported by the STA.
Aspect 90: The method of any of aspects 77-89, further including: determining whether the first portion includes an AMP signal field or an initial MAC frame according to whether a frame check sequence associated with the AMP downlink PPDU includes information associated with the initial MAC frame, where receipt of the first portion indicating the type of STA to which the AMP downlink PPDU is intended is in accordance with the first portion including the AMP signal field or the initial MAC frame.
Aspect 91: The method of any of aspects 77-90, where the first portion includes information in accordance with the type of STA to which the AMP downlink PPDU is intended, the information including a partial time synchronization function, one or more parameters associated with the STA, a length field of the AMP downlink PPDU, or a combination thereof.
Aspect 92: The method of any of aspects 77-91, where the AMP downlink PPDU includes an AMP synchronization field and an AMP data field, and the first portion includes at least the AMP synchronization field.
Aspect 93: The method of aspect 92, where the AMP downlink PPDU further includes an AMP signaling field, and the first portion further includes the AMP signaling field.
Aspect 94: The method of any of aspects 92-93, where the AMP synchronization field includes a first segment that indicates a data rate associated with the AMP data field and a second segment that indicates the type of STA to which the AMP downlink PPDU is intended.
Aspect 95: The method of aspect 94, where the second segment indicates that the AMP downlink PPDU is intended for the first type of STA using a first binary chip sequence or indicates that the AMP downlink PPDU is intended for the second type of STA using a second binary chip sequence.
Aspect 96: A STA for wireless communication, including a processing system that includes processor circuitry and memory circuitry that stores code, the processing system configured to cause the STA to perform a method of any of aspects 77-95.
Aspect 97: A STA for wireless communication, including at least one means for performing a method of any of aspects 77-95.
Aspect 98: A non-transitory computer-readable medium storing code for wireless communication, the code including instructions executable by one or more processors to perform a method of any of aspects 77-95.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A station (STA), comprising:
a processing system that includes processor circuitry and memory circuitry that stores code, the processing system configured to cause the STA to:
receive a first portion of an ambient power (AMP) downlink physical layer protocol data unit (PPDU) that comprises one or more excitation signals, the first portion indicating a type of STA to which the AMP downlink PPDU is intended, the type of STA being one of:
a first type of STA that is capable to receive AMP downlink PPDUs and transmit AMP uplink PPDUs, or
a second type of STA that is capable to receive AMP downlink PPDUs and transmit non-AMP uplink PPDUs; and
selectively receive at least a second portion of the AMP downlink PPDU in accordance with whether the STA is the type of STA to which the AMP downlink PPDU is intended.

2. The STA of claim 1, wherein, to selectively receive at least the second portion of the AMP downlink PPDU, the processing system is configured to cause the STA to:
refrain from receiving the second portion of the AMP downlink PPDU in accordance with the STA not being the type of STA to which the AMP downlink PPDU is intended; or
receive at least the second portion of the AMP downlink PPDU in accordance with the STA being the type of STA to which the AMP downlink PPDU is intended.

3. The STA of claim 1, wherein:
the first portion indicates a frame type of one or more medium access control (MAC) frames included in the AMP downlink PPDU, and
the frame type indicates the type of STA to which the AMP downlink PPDU is intended.

4. The STA of claim 3, wherein, to selectively receive at least the second portion of the AMP downlink PPDU, the processing system is configured to cause the STA to:
receive the one or more MAC frames in the AMP downlink PPDU in accordance with the STA being the type of STA to which the AMP downlink PPDU is intended.

5. The STA of claim 3, wherein the frame type indicates that the one or more MAC frames comprise one or more of an acknowledgement frame, an AMP trigger frame, a data frame, a wake-up radio (WUR) frame, or a beacon frame.

6. The STA of claim 1, wherein the second portion further indicates whether the AMP downlink PPDU comprises data addressed to the STA, and the processing system is further configured to cause the STA to:
selectively receive at least a third portion of the AMP downlink PPDU in accordance with whether the AMP downlink PPDU comprises data addressed to the STA.

7. The STA of claim 1, wherein the second portion indicates a STA address, and the processing system is further configured to cause the STA to:
selectively receive at least a third portion of the AMP downlink PPDU in accordance with whether an address of the STA corresponds to the STA address indicated by the second portion.

8. The STA of claim 1, wherein the first portion comprises an AMP synchronization field that indicates the type of STA to which the AMP downlink PPDU is intended.

9. The STA of claim 1, wherein the first portion comprises an AMP synchronization field, an AMP signaling field, and an AMP data field in accordance with an AMP communication format of the AMP downlink PPDU, and wherein, to receive the first portion, the processing system is configured to cause the STA to:
receive at least the AMP signal field, wherein the AMP signal field is after the AMP synchronization field and before the AMP data field in the AMP downlink PPDU, and wherein the AMP signal field comprises information indicating the type of STA to which the AMP downlink PPDU is intended.

10. The STA of claim 9, wherein:
the information comprises a first set of fields indicating a version associated with the AMP communication format and a second set of fields indicating whether the AMP downlink PPDU is for reception by the first type of STA or the second type of STA and an identifier of an AMP AP associated with the AMP downlink PPDU, and
a first presence of the first set of fields is independent of the version associated with the AMP communication format and a second presence of the second set of fields is independent or dependent on the version associated with the AMP communication format.

11. The STA of claim 1, wherein, to receive the first portion, the processing system is configured to cause the STA to:
receive a medium access control (MAC) frame, the MAC frame comprising information indicating the type of STA to which the AMP downlink PPDU is intended.

12. The STA of claim 11, wherein the MAC frame is an initial MAC frame included in the AMP downlink PPDU.

13. The STA of claim 1, wherein the processing system is further configured to cause the STA to:
determine whether the first portion comprises an AMP signal field or an initial medium access control (MAC) frame according to whether a frame check sequence associated with the AMP downlink PPDU comprises information associated with the initial MAC frame, wherein receipt of the first portion indicating the type of STA to which the AMP downlink PPDU is intended is in accordance with the first portion comprising the AMP signal field or the initial MAC frame.

14. The STA of claim 1, wherein the first portion comprises information in accordance with the type of STA to which the AMP downlink PPDU is intended, the information comprising a partial time synchronization function, one or more parameters associated with the STA, a length field of the AMP downlink PPDU, or a combination thereof.

15. The STA of claim 1, wherein a byte size of the first portion is an integer quantity of octets in accordance with a receiver processing scheme supported by the STA.

16. The STA of claim 1, wherein:
the AMP downlink PPDU comprises an AMP synchronization field and an AMP data field, and
the first portion comprises at least the AMP synchronization field.

17. The STA of claim 16, wherein:
the AMP downlink PPDU further comprises an AMP signal field, and
the first portion further comprises the AMP signal field.

18. A method for wireless communication at a station (STA), comprising:
receiving a first portion of an ambient power (AMP) downlink physical layer protocol data unit (PPDU) that comprises one or more excitation signals, the first portion indicating a type of STA to which the AMP downlink PPDU is intended, the type of STA being one of:
a first type of STA that is capable to receive AMP downlink PPDUs and transmit AMP uplink PPDUs, or
a second type of STA that is capable to receive AMP downlink PPDUs and transmit non-AMP uplink PPDUs; and
selectively receiving at least a second portion of the AMP downlink PPDU in accordance with whether the STA is the type of STA to which the AMP downlink PPDU is intended.

19. The method of claim 18, wherein the AMP downlink PPDU comprises an AMP synchronization field and an AMP data field, and wherein the first portion comprises at least the AMP synchronization field, and wherein the AMP synchronization field comprises a first segment that indicates a data rate associated with the AMP data field and a second segment that indicates the type of STA to which the AMP downlink PPDU is intended.

20. The method of claim 19, wherein the second segment indicates that the AMP downlink PPDU is intended for the first type of STA using a first binary chip sequence or indicates that the AMP downlink PPDU is intended for the second type of STA using a second binary chip sequence.
